(19) United States
(12) Patent Application Publication
(10) Pub. No.: US 2009/0225569 A1
(43) Pub. Date: Sep. 10, 2009

(54) MULTILEVEL POWER CONVERSION

(76) Inventor: Todd Andrew Begalke, Roseville, MN (US)

Correspondence Address: Todd Begalke, 2937 Fairview Avenue N, Roseville, MN, 55113, US

(21) Appl. No.: 12/369,898

(22) Filed: Feb. 12, 2009

Related U.S. Application Data
(60) Provisional application No. 61/028,191, filed on Feb. 13, 2008.

(51) Int. Cl. H02M 3/335

(52) U.S. Cl. 363/17

(57) ABSTRACT

A power converter comprises at least one high-frequency link having a primary winding and at least one secondary winding. At least one primary circuit is connected to each primary winding and is operable to apply the voltage of at least one capacitive element to the primary winding. At least one secondary circuit is connected to one or more secondary windings of the high-frequency links and is operable to apply the voltage of one or more of the secondary windings to at least one inductive element. The power converter is operable to apply multilevel voltages to the inductive elements.

### CROSS REFERENCE TO RELATED PATENT

Not Applicable

### FEDERALLY SPONSORED RESEARCH

Not Applicable

### SEQUENCE LISTING OR PROGRAM

Not Applicable

### FIELD OF THE INVENTION

The invention relates generally to power converters, and more specifically in various embodiments to multilevel conversion of dc or ac sources to dc or ac sources utilizing a high-frequency link such as a transformer.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Power converters are increasingly used in applications that utilize electric machines, fuel cells, batteries, ultracapacitors, and photovoltaics. Power converters are also emerging as an important solution for improving power distribution systems. In these and many other applications it is desirable for the power converter to utilize a high-frequency link to provide isolation or due to a moderate to large voltage difference between each side of the converter. Direct conversion is usually preferable to converters that use conversion stages due to typically less converter components and higher efficiency. Finally, for direct high-frequency link converters it is highly desirable if all switch transitions in the converter occur at zero voltage or zero current, also commonly known as soft switching. Soft switching is advantageous since it decreases the converter's size (due to soft switching enabling an increase in the converters switching frequency), increases the converter's efficiency, reduces the converter's EMI, and decreases the stress on the converter's components.

Prior art converters of particular relevance to the present invention are multilevel direct high-frequency link converters that include a capacitive element(s) connected to an ac or dc source side of the converter (herein referred to as the primary side of the converter), and an inductive element(s) connected to the other side of the converter (herein referred to as the secondary side of the converter).

Multilevel conversion herein refers to the ability of the converter to apply at least two non-zero and non-concentric around zero voltage levels to the inductive elements on the secondary side of the converter (thus, in some cases the multilevel converter may only be capable of applying two voltage levels to the inductive elements). The at least two non-zero and non-concentric around zero voltage levels are with respect to at least one return connection of the inductive elements. If multiple ac sources are connected to the primary side, the levels should be achievable for the entire normal voltage range of the ac sources. The converter in many cases will also be able to apply additional voltage levels that are concentric around zero voltage and or zero voltage itself. The multilevel conversion results in similar multiple current levels applied to the primary side capacitive elements, but for simplicity the multilevel conversion is only defined herein for the voltage levels applied to the inductive elements on the secondary side. Utilizing multilevel conversion for a direct converter has similar benefits to soft switching. Multilevel conversion can decrease the converter's size, increase the converter's efficiency, reduce the converter's EMI, and decrease the stress on the converter's components.

There is currently no multilevel direct high-frequency link converter that operates with an ac source(s) connected to the primary side of the converter. Connecting the ac source(s) to the primary side is advantageous if the source connected to the secondary side: has the inductive elements for the secondary side integrated into the source (electric machines as an example), has a large voltage range, or needs (or is preferred) to operate at close to constant current.

The majority of prior art multilevel direct high-frequency link converters that operate with a dc source(s) connected to the primary side generate the multilevel voltages with switches connected to multiple capacitive elements on the primary side of the converter. While in most cases this type of multilevel conversion works well, there can be problems with uneven loading of the capacitive element(s). The few prior art multilevel converters of this type that are able to achieve soft switching rely on extra resonant components or other extra soft switching components. These extra components increase the complexity, number of components, and loss in the converter. In addition, the soft switching of these converters results in significant increases in the Volt Ampere (VA) ratings of the converter components.

An alternative type of multilevel direct high-frequency link converter for dc to dc conversion is presented in U.S. Pat. No. 6,611,444. This converter utilizes multiple high-frequency links or multiple windings of a single high-frequency link to generate the multilevel voltages. The converter in U.S. Pat. No. 6,611,444 does not have problems with uneven loading and has the additional advantage of allowing the use of irregular voltage levels, which in the majority of prior art converters is not possible due to the problem of uneven loading. However, this converter relies on magnetizing current in the high-frequency link to achieve soft switching. This results in an increase in the VA ratings of the converter components.

A problem with all prior art multilevel direct high-frequency link converters (both hard switching and soft switching) is that they are either, not capable of power transfer from the secondary side to the primary side (the converter in U.S. Pat. No. 6,611,444 as an example), or if the converter is capable, the VA ratings for converter components are large, the efficiency of the converter is poor, and a large quantity of energy must be absorbed by a clamp circuit located in the secondary side. The large quantity of energy absorbed by the clamp circuit results in larger clamp circuit components, further reduces the efficiency of the converter, and typically requires the use of an active clamp circuit (as opposed to a simpler passive clamp circuit). The ability to transfer power from the secondary side to the primary side is important for converters that utilize: bi-directional power transfer, a generation source on the secondary side, or primary side ac sources that require adjustable power factor (i.e. momentary power transfer to the primary side).

### SUMMARY

Various embodiments of the invention comprise a multilevel power converter including at least one primary circuit connected to at least one capacitive element and the primary winding of at least one high-frequency link. Each high-frequency link also has at least one secondary winding. At least one secondary circuit is also connected to at least one secondary winding. Each secondary circuit is additionally connected to at least one inductive element.

The converter is commutated to apply multilevel type voltage pulses to the inductive elements and current pulses to the capacitive elements. Additionally, the converter can be commutated to short-circuit at least one secondary winding under at least one load condition to increase the current in the secondary winding with respect to its positive voltage (as an example when the primary winding(s) voltage is positive, the short-circuit causes an increase in the secondary winding current) prior to the voltage applied to the primary winding(s) changing polarity.

### BRIEF DESCRIPTION OF THE FIGURES

FIG. 1 is a basic circuit diagram of a converter, consistent with an example embodiment of the invention.

FIG. 2 is a basic circuit diagram of a converter, consistent with an example embodiment of the invention.

FIG. 3 is a basic circuit diagram of a converter, consistent with an example embodiment of the invention.

FIG. 4 is a circuit diagram of a dc primary circuit, consistent with an example embodiment of the invention.

FIG. 5 is a circuit diagram of a dc primary circuit, consistent with an example embodiment of the invention.

FIG. 6 is a circuit diagram of a dc secondary circuit for one inductive element, consistent with an example embodiment of the invention.

FIG. 7 is an example collection of voltage and current waveforms for the primary circuit in FIG. 4, the secondary circuit in FIG. 6, and power transfer from the secondary circuit, consistent with an example embodiment of the invention.

FIGS. 8A-I′ are example circuit diagrams illustrating a commutation method for the primary circuit in FIG. 4, the secondary circuit in FIG. 6, and power transfer from the secondary circuit, consistent with an example embodiment of the invention.

FIG. 9 is an example collection of voltage and current waveforms for the primary circuit in FIG. 4, the secondary circuit in FIG. 6, and power transfer to the secondary circuit, consistent with an example embodiment of the invention.

FIGS. 10A-H′ are example circuit diagrams illustrating a commutation method for the primary circuit in FIG. 4, the secondary circuit in FIG. 6, and power transfer to the secondary circuit, consistent with an example embodiment of the invention.

FIG. 11 is an example collection of voltage and current waveforms for the primary circuit in FIG. 4, the secondary circuit in FIG. 6, and power transfer to the secondary circuit, consistent with an example embodiment of the invention.

FIG. 12 is a circuit diagram of a dc primary circuit, consistent with an example embodiment of the invention.

FIG. 13 is a circuit diagram of a dc secondary circuit for one inductive element, consistent with an example embodiment of the invention.

FIG. 14 is an example collection of voltage and current waveforms for the primary circuit in FIG. 12, the secondary circuit in FIG. 13, and power transfer from the secondary circuit, consistent with an example embodiment of the invention.

FIGS. 15A-I′ are example circuit diagrams illustrating a commutation method for the primary circuit in FIG. 12, the secondary circuit in FIG. 13, and power transfer from the secondary circuit, consistent with an example embodiment of the invention.

FIG. 16 is an example collection of voltage and current waveforms for the primary circuit in FIG. 12, the secondary circuit in FIG. 13, and power transfer to the secondary circuit, consistent with an example embodiment of the invention.

FIGS. 17A-I′ are example circuit diagrams illustrating a commutation method for the primary circuit in FIG. 12, the secondary circuit in FIG. 13, and power transfer to the secondary circuit, consistent with an example embodiment of the invention.

FIG. 18 is an example collection of voltage and current waveforms for the primary circuit in FIG. 12, the secondary circuit in FIG. 13, and power transfer to the secondary circuit, consistent with an example embodiment of the invention.

FIG. 19 is a circuit diagram of a dc primary circuit, consistent with an example embodiment of the invention.

FIG. 20 is a circuit diagram of a dc secondary circuit for one inductive element, consistent with an example embodiment of the invention.

FIG. 21 is an example collection of voltage and current waveforms for the primary circuit in FIG. 19, the secondary circuit in FIG. 20, and power transfer from the secondary circuit, consistent with an example embodiment of the invention.

FIGS. 22A-H′ are example circuit diagrams illustrating a commutation method for the primary circuit in FIG. 19, the secondary circuit in FIG. 20, and power transfer from the secondary circuit, consistent with an example embodiment of the invention.

FIG. 23 is an example collection of voltage and current waveforms for the primary circuit in FIG. 19, the secondary circuit in FIG. 20, and power transfer to the secondary circuit, consistent with an example embodiment of the invention.

FIGS. 24A-H′ are example circuit diagrams illustrating a commutation method for the primary circuit in FIG. 19, the secondary circuit in FIG. 20, and power transfer to the secondary circuit, consistent with an example embodiment of the invention.

FIG. 25 is a circuit diagram of a one phase primary circuit, consistent with an example embodiment of the invention.

FIG. 26 is a circuit diagram of a three phase primary circuit, consistent with an example embodiment of the invention.

FIG. 27 is a circuit diagram of a dc secondary circuit for one inductive element, consistent with an example embodiment of the invention.

FIG. 28 is an example collection of voltage and current waveforms for the primary circuit in FIG. 26, the secondary circuit in FIG. 27, and power transfer from the secondary circuit, consistent with an example embodiment of the invention.

FIGS. 29A-K′ are example circuit diagrams illustrating a commutation method for the primary circuit in FIG. 26, the secondary circuit in FIG. 27, and power transfer from the secondary circuit, consistent with an example embodiment of the invention.

FIG. 30 is an example collection of voltage and current waveforms for the primary circuit in FIG. 26, the secondary circuit in FIG. 27, and power transfer to the secondary circuit, consistent with an example embodiment of the invention.

FIGS. 31A-K′ are example circuit diagrams illustrating a commutation method for the primary circuit in FIG. 26, the secondary circuit in FIG. 27, and power transfer to the secondary circuit, consistent with an example embodiment of the invention.

FIG. 32 is a circuit diagram of a dc secondary circuit for one inductive element, consistent with an example embodiment of the invention.

FIG. 33 is an example collection of voltage and current waveforms for the primary circuit in FIG. 4, the secondary circuit in FIG. 32, and power transfer from the secondary circuit, consistent with an example embodiment of the invention.

FIGS. 34A-H′ are example circuit diagrams illustrating a commutation method for the primary circuit in FIG. 4, the secondary circuit in FIG. 32, and power transfer from the secondary circuit, consistent with an example embodiment of the invention.

FIG. 35 is an example collection of voltage and current waveforms for the primary circuit in FIG. 4, the secondary circuit in FIG. 32, and power transfer to the secondary circuit, consistent with an example embodiment of the invention.

FIGS. 36A-H′ are example circuit diagrams illustrating a commutation method for the primary circuit in FIG. 4, the secondary circuit in FIG. 32, and power transfer to the secondary circuit, consistent with an example embodiment of the invention.

FIG. 37 is a circuit diagram of an ac secondary circuit for one inductive element, consistent with an example embodiment of the invention.

FIG. 38 is a circuit diagram of an ac secondary circuit for one inductive element, consistent with an example embodiment of the invention.

FIG. 39 is a circuit diagram of an ac secondary circuit for three inductive elements, consistent with an example embodiment of the invention.

FIG. 40 is a circuit diagram of a dc primary circuit, consistent with an example embodiment of the invention.

FIG. 41 is an example collection of voltage and current waveforms for the primary circuit in FIG. 40 and the secondary circuit in FIG. 39, consistent with an example embodiment of the invention.

FIGS. 42A-J′ are example circuit diagrams illustrating a commutation method for the primary circuit in FIG. 40 and the secondary circuit in FIG. 39, consistent with an example embodiment of the invention.

FIG. 43 is a circuit diagram of an ac secondary circuit for three inductive elements, consistent with an example embodiment of the invention.

FIG. 44 is an example collection of voltage and current waveforms for the primary circuit in FIG. 26 and the secondary circuit in FIG. 43, consistent with an example embodiment of the invention.

FIGS. 45A-M′ are example circuit diagrams illustrating a commutation method for the primary circuit in FIG. 26 and the secondary circuit in FIG. 43, consistent with an example embodiment of the invention.

FIG. 46 is a circuit diagram of an inductive storage circuit, consistent with an example embodiment of the invention.

FIG. 47 is a circuit diagram of a clamp circuit, consistent with an example embodiment of the invention.

FIG. 48 is a circuit diagram of a clamp circuit, consistent with an example embodiment of the invention.

FIG. 49 is a circuit diagram of a clamp circuit, consistent with an example embodiment of the invention.

FIG. 50 is a circuit diagram of a multiple port converter, consistent with an example embodiment of the invention.

FIG. 51 is a circuit diagram of a cascade multilevel converter, consistent with an example embodiment of the invention.

FIG. 52 is a circuit diagram of a cascade multilevel converter, consistent with an example embodiment of the invention.

FIG. 53 is a circuit diagram of a converter, consistent with an example embodiment of the invention.

FIG. 54 is a circuit diagram of a converter, consistent with an example embodiment of the invention.

FIG. 55 is a circuit diagram of a dc secondary circuit for one inductive element, consistent with an example embodiment of the invention.

FIG. 56 is a circuit diagram of a dc secondary circuit for one inductive element, consistent with an example embodiment of the invention.

FIG. 57 is a circuit diagram of a dc secondary circuit for one inductive element, consistent with an example embodiment of the invention.

FIG. 58 is a circuit diagram of a dc primary circuit, consistent with an example embodiment of the invention.

FIG. 59 is a circuit diagram of a dc primary circuit, consistent with an example embodiment of the invention.

FIG. 60 is a circuit diagram of a dc primary circuit, consistent with an example embodiment of the invention.

FIG. 61 is a circuit diagram of a dc primary circuit, consistent with an example embodiment of the invention.

FIG. 62 is a circuit diagram of a one phase primary circuit, consistent with an example embodiment of the invention.

FIG. 63 is a circuit diagram of a one phase primary circuit, consistent with an example embodiment of the invention.

FIG. 64 is a circuit diagram of a dc primary circuit, consistent with an example embodiment of the invention.

FIG. 65 is a circuit diagram of a dc primary circuit, consistent with an example embodiment of the invention.

FIG. 66 is a circuit diagram of a three phase primary circuit, consistent with an example embodiment of the invention.

FIG. 67 is a circuit diagram of a dc primary circuit, consistent with an example embodiment of the invention.

FIG. 68 is a circuit diagram of a dc primary circuit, consistent with an example embodiment of the invention.

FIG. 69 is a circuit diagram of a dc primary circuit, consistent with an example embodiment of the invention.

FIG. 70 is a circuit diagram of a dc primary circuit, consistent with an example embodiment of the invention.

FIG. 71 is a circuit diagram of a dc primary circuit, consistent with an example embodiment of the invention.

FIG. 72 is a circuit diagram of a dc primary circuit, consistent with an example embodiment of the invention.

FIG. 73 is a circuit diagram of a three phase primary circuit, consistent with an example embodiment of the invention.

FIG. 74 is a circuit diagram of a dc primary circuit, consistent with an example embodiment of the invention.

FIG. 75 is a circuit diagram of a dc secondary circuit for one inductive element, consistent with an example embodiment of the invention.

FIG. 76 is a circuit diagram of an ac secondary circuit for one inductive element, consistent with an example embodiment of the invention.

FIG. 77 is a circuit diagram of an ac secondary circuit for three inductive elements, consistent with an example embodiment of the invention.

FIG. 78 is a circuit diagram of a one phase primary circuit, consistent with an example embodiment of the invention.

FIG. 79 is a circuit diagram of a three phase primary circuit, consistent with an example embodiment of the invention.

FIG. 80 is a circuit diagram of a one phase primary circuit, consistent with an example embodiment of the invention.

FIG. 81 is a circuit diagram of a three phase primary circuit, consistent with an example embodiment of the invention.

FIG. 82 is a circuit diagram of a dc secondary circuit for one inductive element, consistent with an example embodiment of the invention.

FIG. 83 is a circuit diagram of a dc secondary circuit for one inductive element, consistent with an example embodiment of the invention.

FIG. 84 is a circuit diagram of a dc secondary circuit for one inductive element, consistent with an example embodiment of the invention.

FIG. 85 is a circuit diagram of a dc secondary circuit for one inductive element, consistent with an example embodiment of the invention.

FIG. 86 is a circuit diagram of a dc secondary circuit for one inductive element, consistent with an example embodiment of the invention.

FIG. 87 is a circuit diagram of a dc secondary circuit for one inductive element, consistent with an example embodiment of the invention.

FIG. 88 is a circuit diagram of a dc secondary circuit for one inductive element, consistent with an example embodiment of the invention.

FIG. 89 is a circuit diagram of a dc secondary circuit for one inductive element, consistent with an example embodiment of the invention.

FIG. 90 is a circuit diagram of a dc secondary circuit for one inductive element, consistent with an example embodiment of the invention.

FIG. 91 is a circuit diagram of an ac secondary circuit for two inductive elements, consistent with an example embodiment of the invention.

FIG. 92 is a circuit diagram of an ac secondary circuit for two inductive elements, consistent with an example embodiment of the invention.

FIG. 93 is a circuit diagram of an ac secondary circuit for three inductive elements, consistent with an example embodiment of the invention.

FIG. 94 is a circuit diagram of a dc secondary circuit for one inductive element, consistent with an example embodiment of the invention.

FIG. 95 is a circuit diagram of a dc secondary circuit for one inductive element, consistent with an example embodiment of the invention.

FIG. 96 is a circuit diagram of a dc secondary circuit for one inductive element, consistent with an example embodiment of the invention.

FIG. 97 is a circuit diagram of a dc secondary circuit for one inductive element, consistent with an example embodiment of the invention.

FIG. 98 is a circuit diagram of a dc secondary circuit for one inductive element, consistent with an example embodiment of the invention.

FIG. 99 is a circuit diagram of a dc secondary circuit for one inductive element, consistent with an example embodiment of the invention.

FIG. 100 is a circuit diagram of a dc secondary circuit for one inductive element, consistent with an example embodiment of the invention.

FIG. 101 is a circuit diagram of a dc secondary circuit for one inductive element, consistent with an example embodiment of the invention.

FIG. 102 is a circuit diagram of an ac secondary circuit for one inductive element, consistent with an example embodiment of the invention.

FIG. 103 is a circuit diagram of an ac secondary circuit for three inductive elements, consistent with an example embodiment of the invention.

FIG. 104 is a circuit diagram of an ac secondary circuit for one inductive element, consistent with an example embodiment of the invention.

FIG. 105 is a circuit diagram of an ac secondary circuit for one inductive element, consistent with an example embodiment of the invention.

FIG. 106 is a circuit diagram of an ac secondary circuit for three inductive elements, consistent with an example embodiment of the invention.

FIG. 107 is a circuit diagram of an ac secondary circuit for one inductive element, consistent with an example embodiment of the invention.

FIG. 108 is a circuit diagram of an ac secondary circuit for one inductive element, consistent with an example embodiment of the invention.

FIG. 109 is a circuit diagram of an ac secondary circuit for one inductive element, consistent with an example embodiment of the invention.

FIG. 110 is a circuit diagram of a dc secondary circuit for a split inductive element, consistent with an example embodiment of the invention.

FIG. 111 is a circuit diagram of a dc secondary circuit for a split inductive element, consistent with an example embodiment of the invention.

FIG. 112 is a circuit diagram of a dc secondary circuit for a split inductive element, consistent with an example embodiment of the invention.

FIG. 113 is a circuit diagram of a dc secondary circuit for a split inductive element, consistent with an example embodiment of the invention.

FIG. 114 is a circuit diagram of a dc secondary circuit for a split inductive element, consistent with an example embodiment of the invention.

FIG. 115 is a circuit diagram of a dc secondary circuit for a split inductive element, consistent with an example embodiment of the invention.

FIG. 116 is a circuit diagram of a dc secondary circuit for a split inductive element, consistent with an example embodiment of the invention.

FIG. 117 is a circuit diagram of a dc secondary circuit for a split inductive element, consistent with an example embodiment of the invention.

FIG. 118 is a circuit diagram of a dc secondary circuit for a split inductive element, consistent with an example embodiment of the invention.

FIG. 119 is a circuit diagram of a modified version of the circuit in FIG. 13, consistent with an example embodiment of the invention.

FIG. 120 is a circuit diagram of a modified version of the circuit in FIG. 32, consistent with an example embodiment of the invention.

FIG. 121 is a circuit diagram of a modified version of the circuit in FIG. 76, consistent with an example embodiment of the invention.

FIG. 122 is a circuit diagram of a modified version of the circuit in FIG. 86, consistent with an example embodiment of the invention.

FIG. 123 is a circuit diagram of a modified version of the circuit in FIG. 99, consistent with an example embodiment of the invention.

FIG. 124 is a circuit diagram of a modified version of the circuit in FIG. 6, consistent with an example embodiment of the invention.

FIG. 125 is a circuit diagram of a modified version of the circuit in FIG. 20, consistent with an example embodiment of the invention.

FIG. 126 is a circuit diagram of a modified version of the circuit in FIG. 43, consistent with an example embodiment of the invention.

FIG. 127 is a circuit diagram of a modified version of the circuit in FIG. 75, consistent with an example embodiment of the invention.

FIG. 128 is a circuit diagram of a modified version of the circuit in FIG. 98, consistent with an example embodiment of the invention.

FIG. 129 is a circuit diagram illustrating the integration of multiple secondary circuits, consistent with an example embodiment of the invention.

FIG. 130 is a circuit diagram of a multiple port converter utilizing multiple isolated secondary windings, consistent with an example embodiment of the invention.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

The present invention provides in various embodiments improved multilevel direct high-frequency link power converters for unidirectional or bi-directional conversion of dc or ac sources to dc or ac sources. These converters in various embodiments can achieve soft switching under all load conditions without additional components or large magnetizing current, and considerably reduce the quantity of energy absorbed by a clamp circuit in the secondary side (particularly when power transfers from the secondary side to primary side).

Some of the converters described herein include a primary side comprising at least one primary circuit that is connected to at least one capacitive element and the primary winding of at least one high-frequency link. The example converters also include a secondary side comprising at least one secondary circuit that is connected to at least one inductive element and at least one secondary winding of a high-frequency link. The converter's primary side is connected to an ac and or dc source, and similarly the secondary side is also connected to an ac and or dc source. In general an ac source refers to a sinusoidal source, and in the case of multiple ac sources refers to multiple sinusoidal sources with approximately the same amplitudes and frequencies that are out of phase with each other by a set phase margin. For the example embodiments, however, the ac sources can be any type of sources that require both positive and negative voltage (or only one voltage polarity, although this may be excessive since the circuit will still be able to handle both voltage polarities), and the multiple ac sources can be completely independent of each other.

In the example embodiments the generation of the multilevel voltages is done with multiple primary side capacitive elements, multiple high-frequency links, multiple independently controlled secondary windings, or a combination of these.

The example commutation methods are able to achieve the benefits described above. In the example commutation methods for some embodiments, when the power transfer direction is from a secondary circuit, that secondary circuit short-circuits its secondary winding(s) prior to the primary winding voltage(s) changing polarity. When the primary winding voltage(s) is positive, the short-circuit causes an increase in the secondary winding current(s) (when the primary winding voltage(s) is negative, the current(s) decreases). The short-circuit provides the initial energy required for soft switching the primary circuit's switches during the polarity change of the primary winding(s). The short-circuit also decreases the difference in current between the secondary winding(s) and the inductive element(s) after the polarity change of the primary winding(s), which substantially decreases the amount of energy absorbed by the secondary circuit's clamp circuit.

In some embodiments, when the power transfer direction is from a primary circuit and below a minimum power limit (i.e. the converter is operating under low load conditions), short-circuiting the secondary winding(s) is also utilized. When the primary winding voltage(s) is positive, the short-circuit again increases the secondary winding current(s) (when primary winding voltage(s) is negative, the current(s) decreases). The increase in secondary winding current(s) provides the extra energy required for soft switching the primary circuit's switches during the polarity change of the primary winding(s).

By changing the short-circuit time in the commutation examples, the quantity of energy absorbed by the clamp circuit can be considerably decreased under all load conditions, and soft switching is possible under all load conditions with no extra components or large magnetizing current. Thus, the invention can enable extremely high-performance conversion by utilizing the advantages of both soft switching and multilevel conversion.

The example commutation methods are especially advantageous for primary side ac source(s) since the voltage(s) across the capacitive element(s) continuously changes. Since the converter does not rely on extra passive components that have fixed values to assist in soft switching, the short-circuit time in the invention can be adjusted to account for the voltage changes in the capacitive element(s). If multiple ac sources are connected to the primary side, the example commutation methods also allow for proper loading of the ac sources' multiple capacitive elements.

The example commutation methods are also especially advantageous for multilevel converters that utilize multiple primary side capacitive elements and or multiple high-frequency links to generate the multilevel voltages. Typically when power transfers from the primary side in these types of converters, the transitions are from a level of minimum power transfer to maximum power transfer prior to the voltage polarity change of the primary winding(s), and vice-versa when power transfers from the secondary side. This is the reverse order of what is preferred for soft switching the converter, and for prior art converters results in an increase in the ratings of the converter's components. Unlike prior art converters, the short-circuit in the example commutation methods of the invention is able to compensate for the reverse order.

The example embodiments of the invention include a cascade converter that combines multiple primary side capacitive elements, multiple high-frequency links, and multiple independently controlled secondary windings. The cascade converter is especially advantageous for high power applications since it is possible to break the converter into modular components with lower power and VA ratings. Unlike prior art cascade converters extensively described in the literature (see for example U.S. Pat. No. 5,642,275), the cascade converter in the invention is a direct converter (i.e. easier to modularize, less complexity, fewer components, and less loss).

Unlike the prior art, some embodiments of the invention's commutation methods and secondary circuits allow for the inclusion of an inductive storage circuit. This inductive storage circuit is advantageous for ac to ac conversion since, unlike typical direct ac to ac converters, the input power can vary from the output power for small time periods. The inductive storage circuit also decreases the size of the capacitive elements in the converter for any type of conversion. This decrease in capacitance size, coupled with the reduction in capacitance size from soft switching and multilevel conversion, can enable a change from electrolytic type capacitors (commonly used as the capacitive element in converters) to capacitor technologies that operate at higher temperatures. The ability to use capacitors that operate at higher temperatures is especially advantageous with the emergence of silicon carbide semiconductors that are capable of operating at substantially higher temperatures than silicon semiconductors.

Unlike the prior art, some embodiments of the invention's commutation methods, primary circuits, and secondary circuits enable the possibility of a multiple port converter. A multiple port converter is created by: utilizing a combination of multiple isolated capacitive elements, multiple high-frequency links, and multiple primary circuits; connecting multiple secondary circuits to the same secondary winding(s); integrating multiple secondary circuits; utilizing a high-frequency link(s) with multiple secondary windings that are connected to multiple secondary circuits; or a combination of any of these. The multiple port converter is advantageous for applications that require the coupling of three or more sources. The multiple port converter is also advantageous for cell type sources (fuel cells, batteries, solar cells, etc.). By utilizing multiple ports, the cells can be split into multiple modules instead of one large module. The use of multiple modules enables: balancing of storage cells (battery cells as an example); improved peak power tracking of generation source cells (solar cells as an example); better matching of cell conditions and parameters (temperature of cells, production run of cells, etc.); more flexibility in packaging the cells; and continued operation of other ports when a cell in one port is damaged or the port is taken off line.

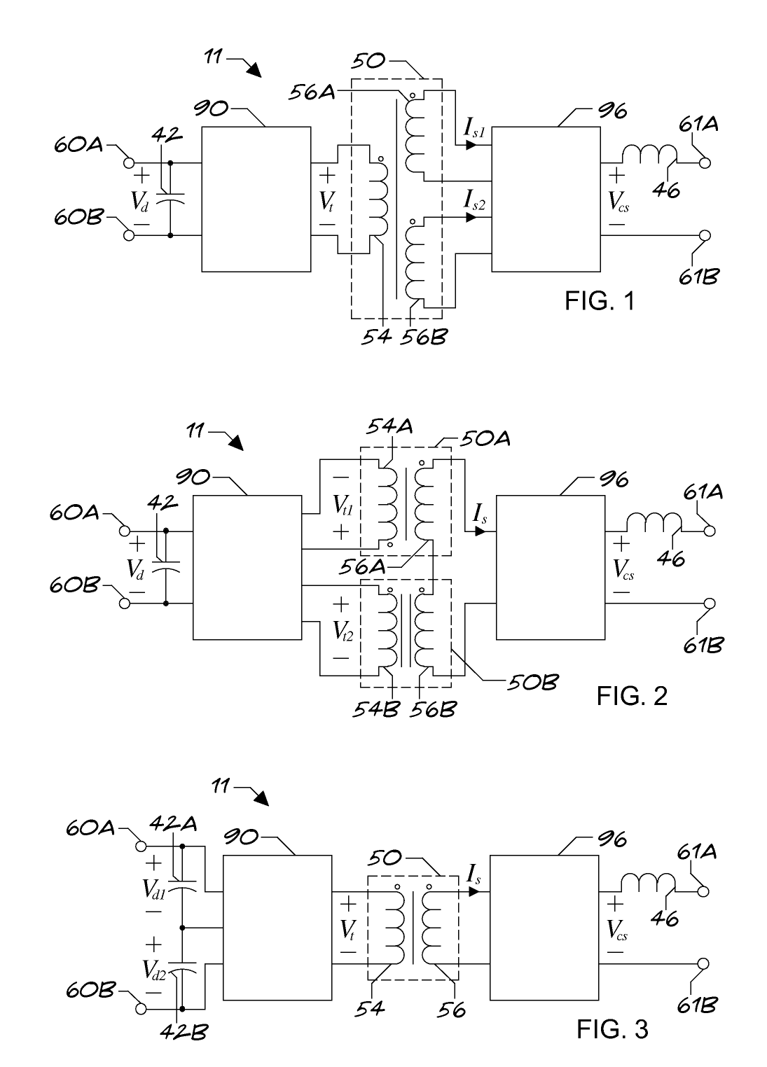

FIG. 1, FIG. 2, and FIG. 3 illustrate three example embodiments of a converter. The converter 11 in various embodiments comprises at least one primary circuit 90 connected to at least one capacitive element (42 or 42 followed by a suffix) and a primary winding (54 or 54 followed by a suffix) of at least one high-frequency link (50 or 50 followed by a suffix) such as a transformer. Each high-frequency link (50 or 50 followed by a suffix) also has at least one secondary winding (56 or 56 followed by a suffix). At least one secondary circuit 96 is connected to at least one secondary winding (56 or 56 followed by a suffix) and at least one inductive element (46 or 46 followed by a suffix). The basis figures in FIG. 1, FIG. 2, and FIG. 3 serve as basic example diagrams and additional connections between the primary circuit 90, the capacitive elements (42 or 42 followed by a suffix), and the primary windings (54 or 54 followed by a suffix) are appropriate. Similarly, additional connections between the secondary circuits 96, the inductive elements (46 or 46 followed by a suffix), and the secondary windings (56 or 56 followed by a suffix) are appropriate.

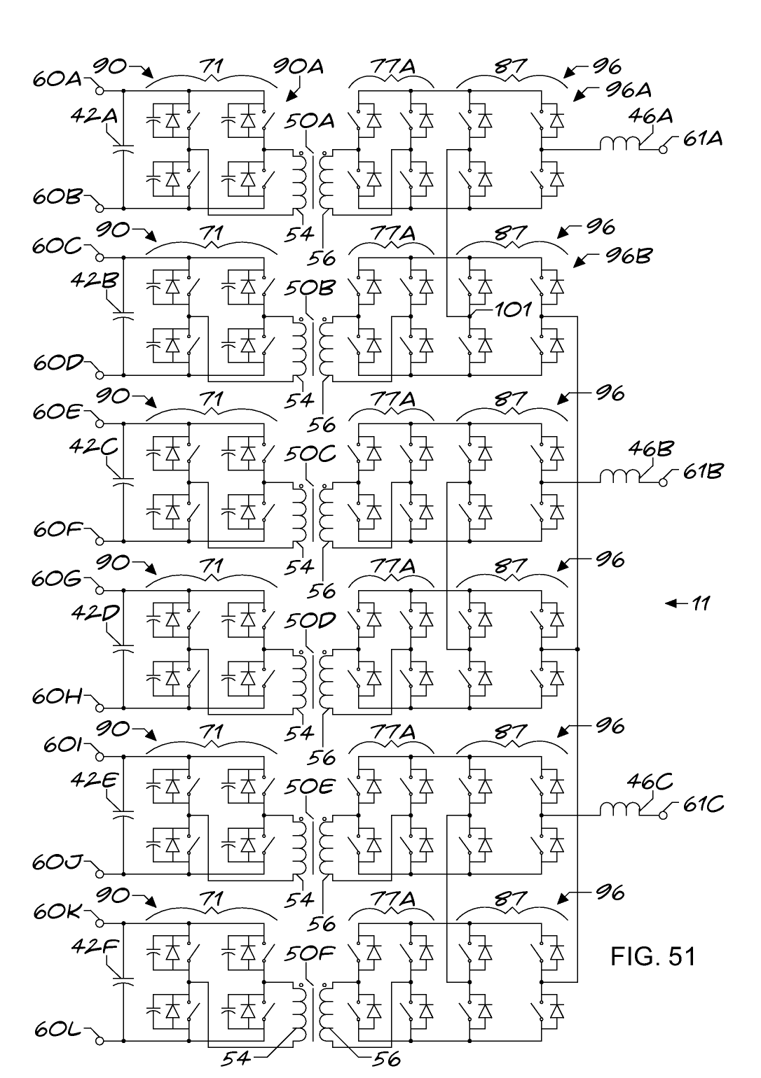

The three example embodiments in FIG. 1, FIG. 2, and FIG. 3 are illustrated for dc to dc three level conversion. The example embodiment illustrated in FIG. 1 generates the three levels with two secondary windings 56A and 56B of one high-frequency link 50. The secondary windings 56A and 56B in FIG. 1 can also be part of two high-frequency links, but this is typically less advantageous (an example exception to this is illustrated in FIG. 51). The example embodiment illustrated in FIG. 2 generates the three levels with two high-frequency links 50A and 50B. The multiple high-frequency links 50A and 50B pertain not only to separate high-frequency links, but any element that can operate similar to multiple high-frequency links (i.e. they can share a common magnetic core). The example embodiment illustrated in FIG. 3 generates the three levels with two capacitive elements 42A and 42B connected to the primary circuit 90.

A capacitive element (42 or 42 followed by a suffix) as described herein is an element, such as a capacitor, for which the current in the element is proportional to the rate at which the voltage across the element varies with time. Additional filter components can also be connected to the capacitive elements at connections 60A and 60B (or 60 followed by a different suffix). A generation source (positive source), load (negative source), or bi-directional source (positive or negative source) is connected to the connections 60A and 60B (or 60 followed by a different suffix) or to the filter components connected to these connections. The capacitive elements (42 or 42 followed by a suffix) can also be an inherent part of the sources, such as in chemical batteries. If the capacitive elements are inherent, the capacitive elements (42 or 42 followed by a suffix) are not a component of the converter. In the commutation circuit diagrams illustrated herein, the combination of the capacitive element and the source is modeled as an ideal dc voltage source since it approximates the capacitive element over a small time period.

An inductive element (46 or 46 followed by a suffix) as described herein is an element, such as an inductor, for which the voltage across the element is proportional to the rate at which the current in the element varies with time. Additional filter components can also be connected to the inductive elements at connections 61A and 61B (or 61 followed by a different suffix). A generation source (positive source), load (negative source), or bi-directional source (positive or negative source) is connected to the connections 61A and 61B (or 61 followed by a different suffix) or to the filter components connected to these connections. The inductive elements can also be an inherent part of the sources, such as in electric machines. If the inductive elements are inherent, the connections 61A and 61B (or 61 followed by a different suffix) are connected together, and the inductive elements (46 or 46 followed by a suffix) are not a component of the converter. In the commutation circuit diagrams illustrated herein, the combination of the inductive element and the source is modeled as an ideal dc current source since it approximates the inductive element over a small time period.

In all figures a blocking element represented with a switch and a diode in parallel (14, 16, 17, and 18 each followed by a suffix), referred to herein as a switch, represents a device or a combination of devices that is controlled by a control signal to either block current and support a voltage potential across it in one direction, or allow current in both directions. In all figures a blocking element represented with only a diode (36, 37, and 38 each followed by a suffix) represents a device that blocks current and supports a voltage potential across it in one direction. In all figures a bi-directional blocking element represented with two series connected switches with parallel diodes pointing in opposite directions (4, 5, 6, 7, 8, and 9 each followed by a suffix, such as bi-directional switch 6A-6A′ in FIG. 6), referred to herein as a bi-directional switch, represents a device or a combination of devices that is controlled by a control signal or control signals to: block current and support a voltage potential across it in both directions; block current and support a voltage potential across it in either single direction; or allow current in both directions. In all figures a bi-directional blocking element represented with a series connected diode and switch (26 and 27 each followed by a suffix, such as bi-directional element 26N-26N′ in FIG. 122) represents a device or a combination of devices that is controlled by a control signal to either block current and support a voltage potential across it in both directions, or block current and support a voltage potential across it in one direction. In the descriptions of the commutation methods, the blocking elements and bi-directional blocking elements are treated as separate switches and diodes to illustrate the blocking state of the elements, but this should not be construed as the only way to implement these elements (i.e. “turning on switch 6A in FIG. 6” refers to changing the blocking state of bi-directional switch 6A-6A′ and not necessarily to an actual switch device). The blocking elements and bi-directional blocking elements can be implemented with common semiconductor devices such as diodes, mosfets, igbts, rb-igbts, thyristors, gtos, power bjts, etc.

For the example embodiments, the primary circuit 90 produces high-frequency bi-polar voltage pulses across the primary windings (54 or 54 followed by a suffix) of the high-frequency links (50 or 50 followed by a suffix). The secondary circuit 96 converts the resulting pulses across the secondary windings (56 or 56 followed by a suffix) for application to the inductive elements (46 or 46 followed by a suffix) connected to it. To accomplish direct conversion with minimal energy absorbed by a clamp circuit 99 in the secondary circuit 96 (or the secondary circuit 96 itself), and with all switch transitions occurring at zero voltage or zero current (i.e. soft switching), the following two rules in general are followed in commutating the primary circuits 90 and secondary circuits 96:
1) Each primary circuit's switches (14 followed by a suffix) and bi-directional switches (4 or 5 followed by a suffix) are commutated so that the primary winding voltage (Vₜ, Vₜ₁, Vₜ₂, etc.) decreases with respect to the positive current direction in the primary winding (54 or 54 followed by a suffix) (i.e. in FIG. 2 if Iₛ is positive, Vₜ₁ and Vₜ₂ decrease, and if Iₛ is negative, Vₜ₁ and Vₜ₂ increase).
2) Each secondary circuit's switches (16, 17, and 18 each followed by a suffix) and bi-directional blocking elements (6, 7, 8, 9, 26, and 27 each followed by a suffix) are commutated so that the secondary winding current (Iₛ, Iₛ₁, Iₛ₂, etc.) increases with respect to the positive voltage of the secondary winding (56 or 56 followed by a suffix) (i.e. in FIG. 1 if Vₜ is positive, Iₛ₁ and Iₛ₂ increase, and if Vₜ is negative, Iₛ₁ and Iₛ₂ decrease), or decreases by a small enough value that the clamp circuit 99 in the secondary circuit 96 (or the secondary circuit 96 itself) can absorb the energy.
   In prior art converters following these two rules is not possible under low load conditions, varying primary side voltage conditions, or when power transfers from the secondary circuit 96, but the present invention enables adherence to these rules with commutation methods that short-circuits at least one secondary winding (56 or 56 followed by a suffix) when voltage is still applied to at least one primary winding (54 or 54 followed by a suffix). The example commutation methods discussed herein control the duration of the voltage applied to the primary windings (54 or 54 followed by a suffix), control the duration of the current applied to the secondary windings (56 or 56 followed by a suffix), or a combination of these methods.
   Example Embodiment with Two Independently Controlled Secondary Windings

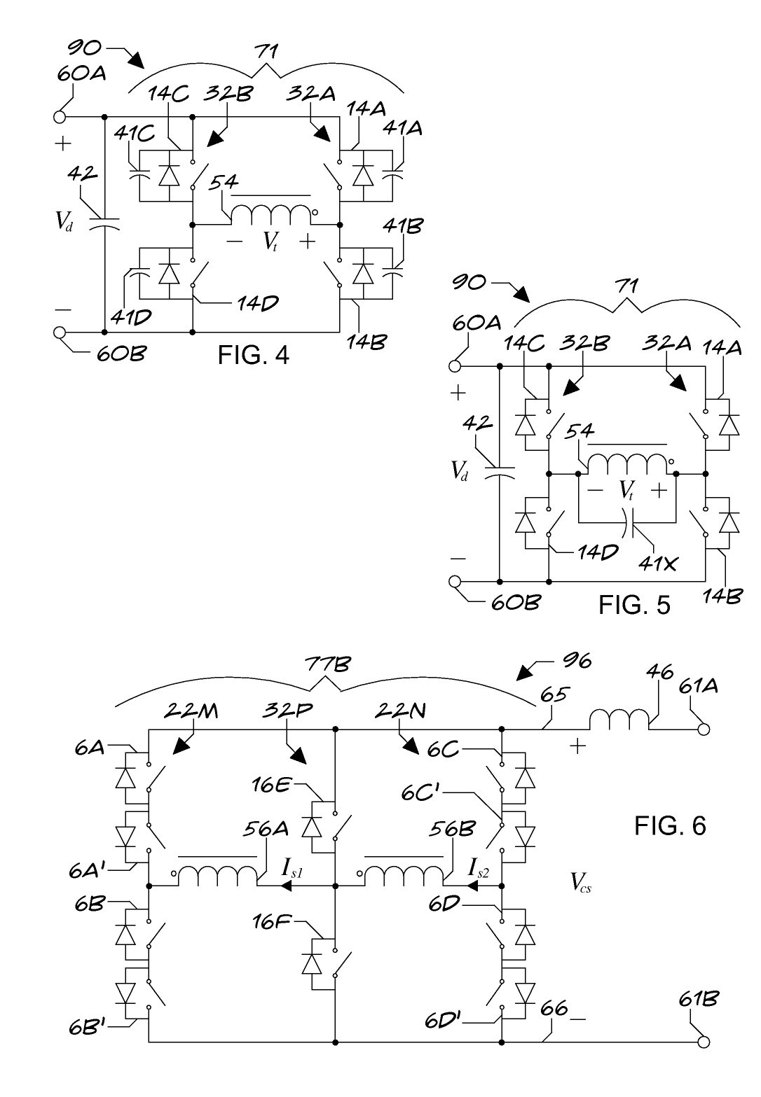

FIG. 4 illustrates an example primary circuit 90 appropriate for the example embodiment in FIG. 1. For the full-bridge circuit 71 in FIG. 4 the primary winding 54 is connected between two phase legs 32A and 32B that are connected to the capacitive element 42. All phase legs described herein comprise two blocking elements connected in series and oriented to block current in the same direction (switches 14A and 14B comprise phase leg 32A as an example). The primary circuit 90 in FIG. 4 includes snubber capacitances 41A, 41B, 41C, and 41D across the switches 14A, 14B, 14C, and 14D respectively. Alternatively, a snubber capacitance 41X can be included across the primary winding 54 as in FIG. 5. The switches 14A, 14B, 14C, and 14D in both FIG. 4 and FIG. 5 operate the same. Snubber capacitance across both the switches 14A, 14B, 14C, and 14D and the primary winding 54 can also be utilized. The snubber capacitances facilitate the soft switching, and may either be external capacitive snubber elements, inherent (i.e. parasitic) capacitance to the switches 14A, 14B, 14C, and 14D (for FIG. 4) or the primary winding 54 (for FIG. 5), or a combination of both external and inherent snubber capacitance.

FIG. 6 illustrates an example secondary circuit 96 appropriate for the example embodiment in FIG. 1. This secondary circuit 96 comprises a mixed leg circuit 77B connected to an inductive element 46. The mixed leg circuit 77B comprises a secondary winding 56A connected between a bi-directional phase leg 22M and a phase leg 32P, and a secondary winding 56B connected between the phase leg 32P and a bi-directional phase leg 22N. The bi-directional phase leg comprises two bi-directional blocking elements connected in series with connections made to both ends of the bi-directional phase leg and at the interconnection of the bi-directional blocking elements (bi-directional switches 6A-6A′ and 6B-6B′ comprise bi-directional phase leg 22M as an example). The voltages across the secondary windings 56A and 56B are the primary winding voltage multiplied by the turns ratios between the primary winding 54 and the secondary windings 56A and 56B (i.e. nₜ₁Vₜ and nₜ₂Vₜ for secondary windings 56A and 56B respectively). Inversely, the primary winding current is the sum of the secondary winding currents each multiplied by the appropriate turns ratio (i.e. nₜ₁Iₛ₁+nₜ₂Iₛ₂) plus an additional magnetizing current.

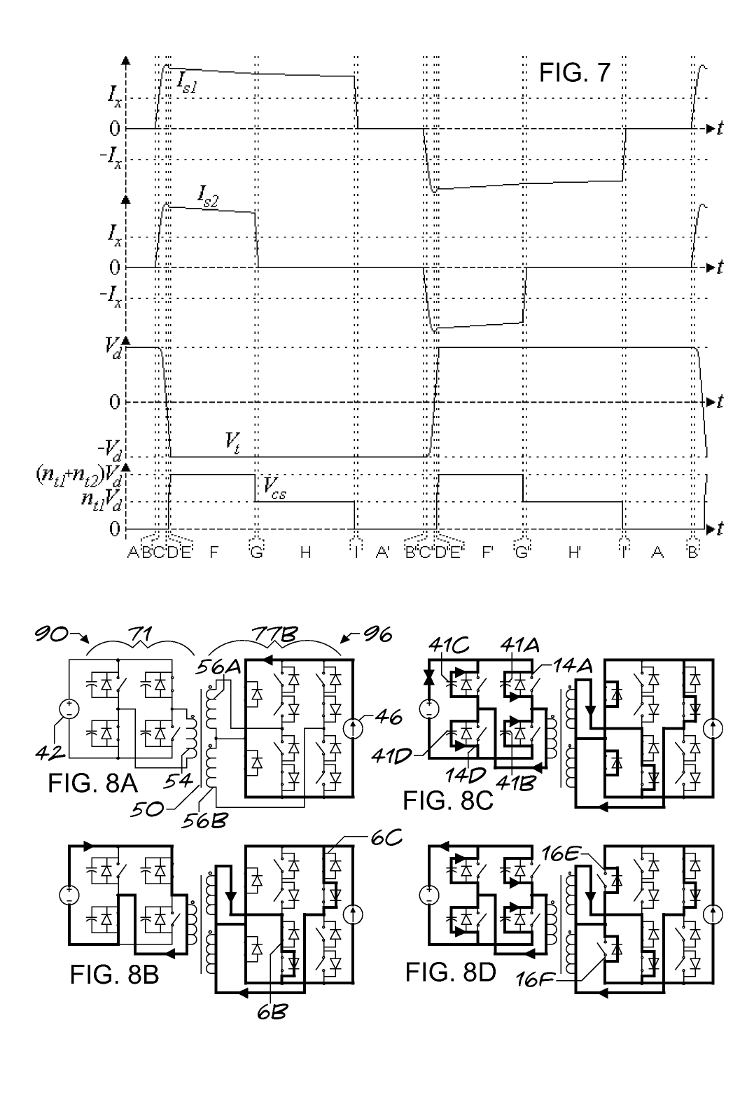

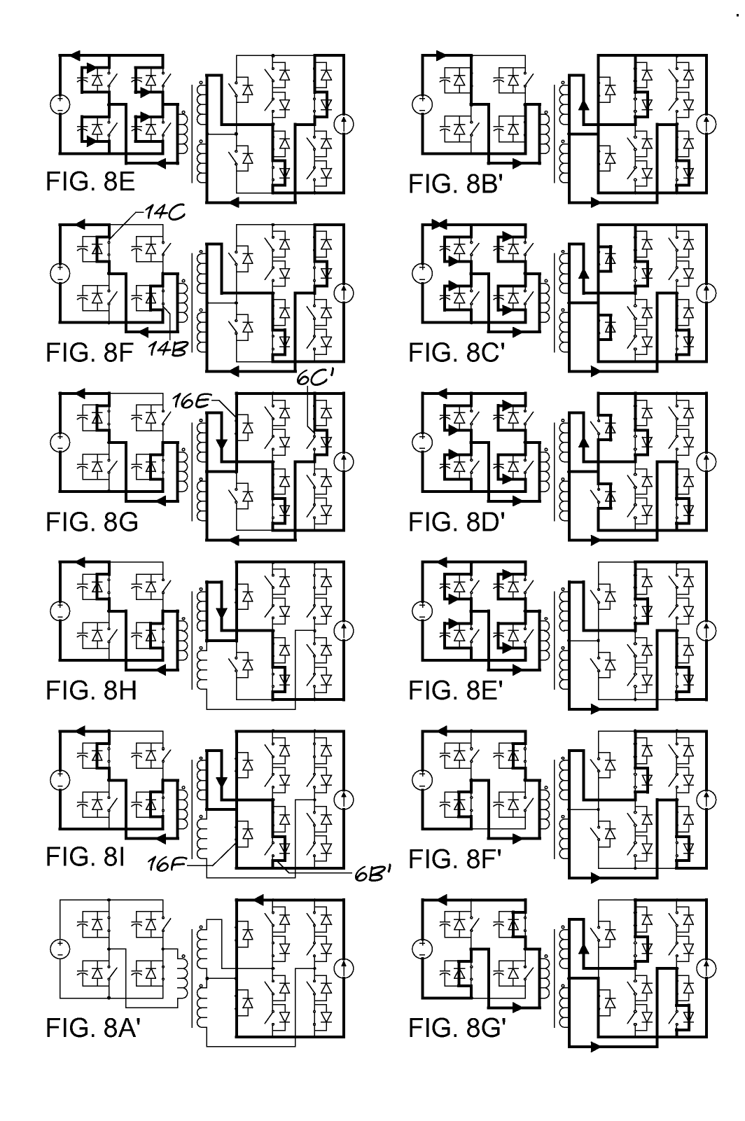

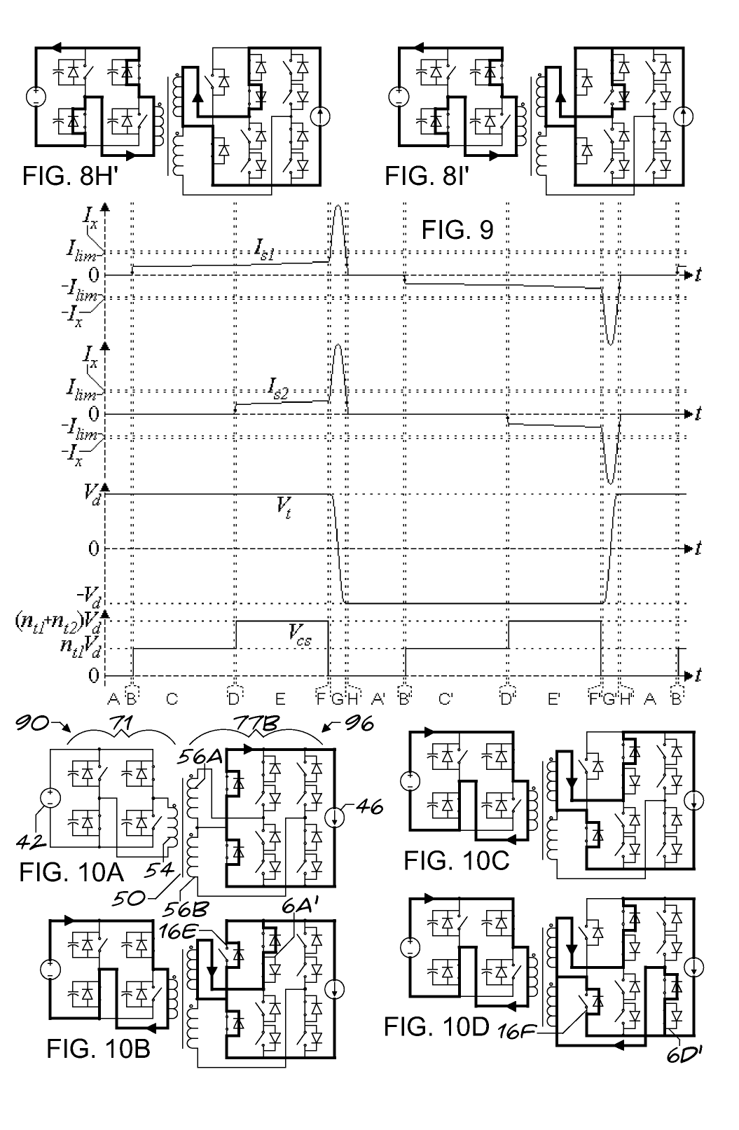

Combining the primary circuit 90 in FIG. 4 and the secondary circuit 96 in FIG. 6 is one example of the converter 11 illustrated in FIG. 1. The example commutation method for this converter 11 controls the duration current is applied to the secondary windings 56A and 56B. Examples of this commutation method are illustrated in FIG. 7 through FIG. 11. An example of commutating this converter 11 for power transfer from the secondary circuit 96 is illustrated with the voltage and current waveforms in FIG. 7 and the commutation circuit diagrams in FIGS. 8A-I′. In these and all of the commutation circuit diagrams, thicker lines illustrate the current paths. For any example commutation methods disclosed herein there are numerous trivial variations that will be apparent to those skilled in the art, and any such variations are still within the spirit of the invention.

It should be noted that the waveforms provided herein are idealized wherein practical implementations of the invention described herein may generate waveforms that depart somewhat from those shown. The example waveforms and commutation methods are also illustrated with no magnetizing current for the high-frequency link (50 or 50 followed by a suffix). In practical implementation the magnetizing current will aid the zero-voltage transitions of the primary circuit's switches (14 followed by a suffix) and bi-directional switches (4 or 5 followed by a suffix), and can create additional flexibility to the turning on of the primary circuit's switches (14 followed by a suffix) and bi-directional switches (4 or 5 followed by a suffix). It should also be noted that to make the example commutation methods easier to understand, some of the time periods in the waveforms provided herein have been made proportionally different than they would appear in practical implementation.

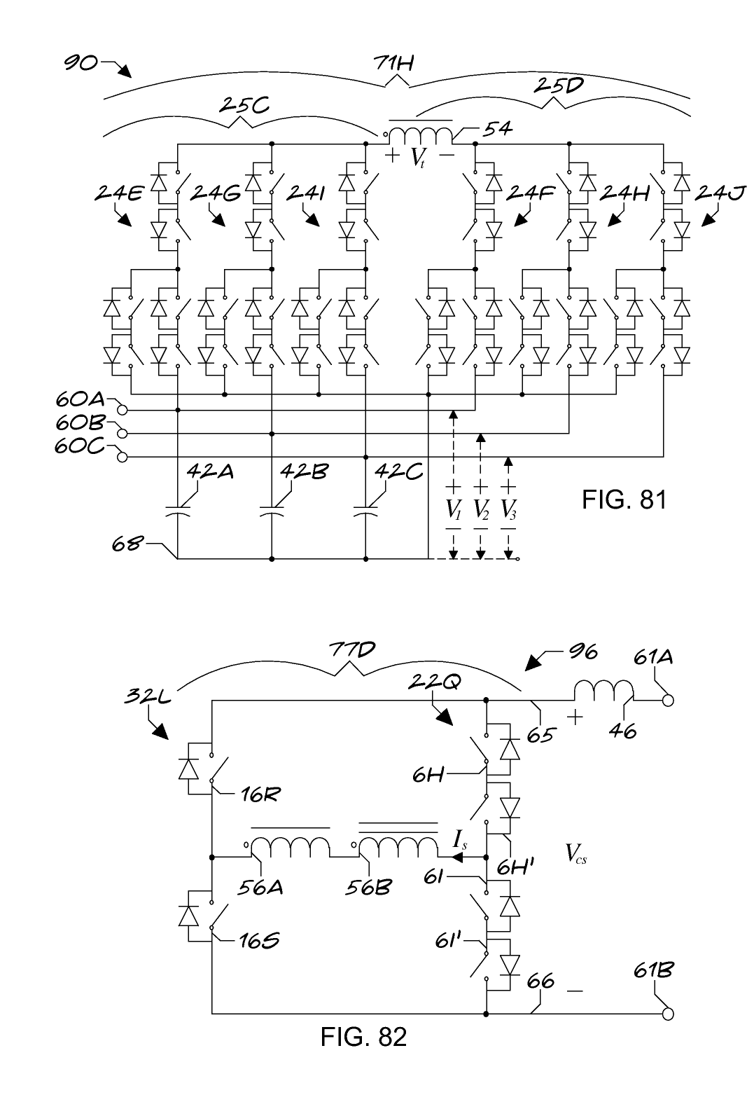

After time period A in FIG. 7 (the switch state in FIG. 8A) switches 6B and 6C are turned on at zero current to short-circuit the secondary windings 56A and 56B. This results in an increase in the secondary winding currents, Iₛ₁ and Iₛ₂, to Iₓ (FIG. 8B). When the secondary winding currents, Iₛ₁ and Iₛ₂, equal Iₓ, switches 14A and 14D are turned off at zero voltage. This causes the resonant charging and discharging of the primary snubber capacitors 41A, 41B, 41C, and 41D with the magnetizing current and stored leakage inductance energy of the high-frequency link 50 (FIG. 8C). When the secondary winding currents, Iₛ₁ and Iₛ₂, are near their maximum, the switches 16E and 16F are turned off at zero voltage, and it starts time period D. The secondary winding currents, Iₛ₁ and Iₛ₂, decrease until both are equal to the current in the inductive element 46 (FIG. 8D). When the secondary winding currents, Iₛ₁ and Iₛ₂, equal the current in the inductive element 46, the snubber capacitors 41A, 41B, 41C, and 41D continue to charge and discharge at an approximately constant current (FIG. 8E). When the snubber capacitors' voltages reach the dc voltage rails, the current starts to conduct in the diode direction of switches 14B and 14C (FIG. 8F). During time period F switches 14B and 14C are turned on at zero voltage. After time period F switch 6C′ is turned off at zero voltage, and switch 16E is then turned on at zero current (switch 16E on then switch 6C′ off also valid). This results in the secondary winding current, Iₛ₂, decreasing until it reaches zero (FIG. 8G). When the secondary winding current, Iₛ₂, falls to zero, it begins time period H in which no current conducts in the secondary winding 56B (FIG. 8H). After time period H switch 6B′ is turned off at zero voltage, and switch 16F is then turned on at zero current (switch 16F on then switch 6B′ off also valid). This results in the secondary winding current, Iₛ₁, decreasing until it reaches zero (FIG. 81). When the secondary winding current, Iₛ₁, falls to zero, it begins time period A′ in which no current conducts in the secondary winding 56A (FIG. 8A′). During time period A′ switches 6A′ and 6D′ are turned on at zero voltage, and switches 6B and 6C are turned off at zero voltage. FIGS. 8A′-I′ show the remainder of the commutation cycle, which is similar to FIGS. 8A-I, but the polarity of the primary winding voltage, Vₜ, and the secondary winding currents, Iₛ₁ and Iₛ₂, are all opposite. After time period I′ the cycle is reset starting with time period A.

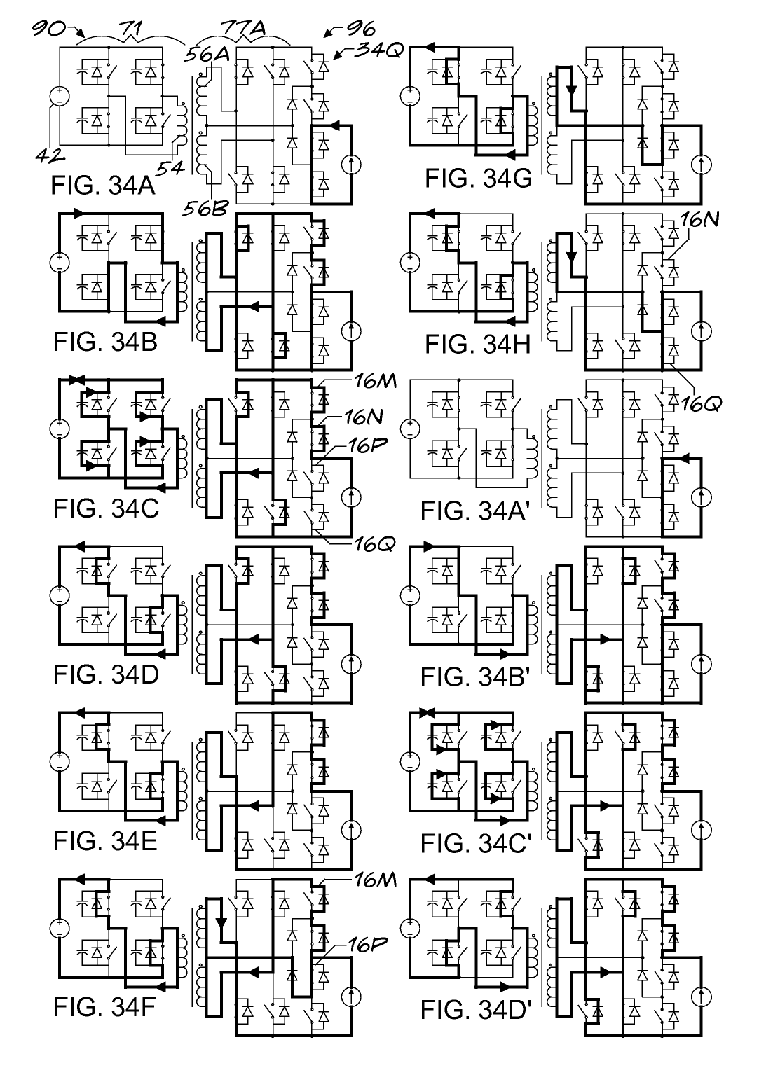

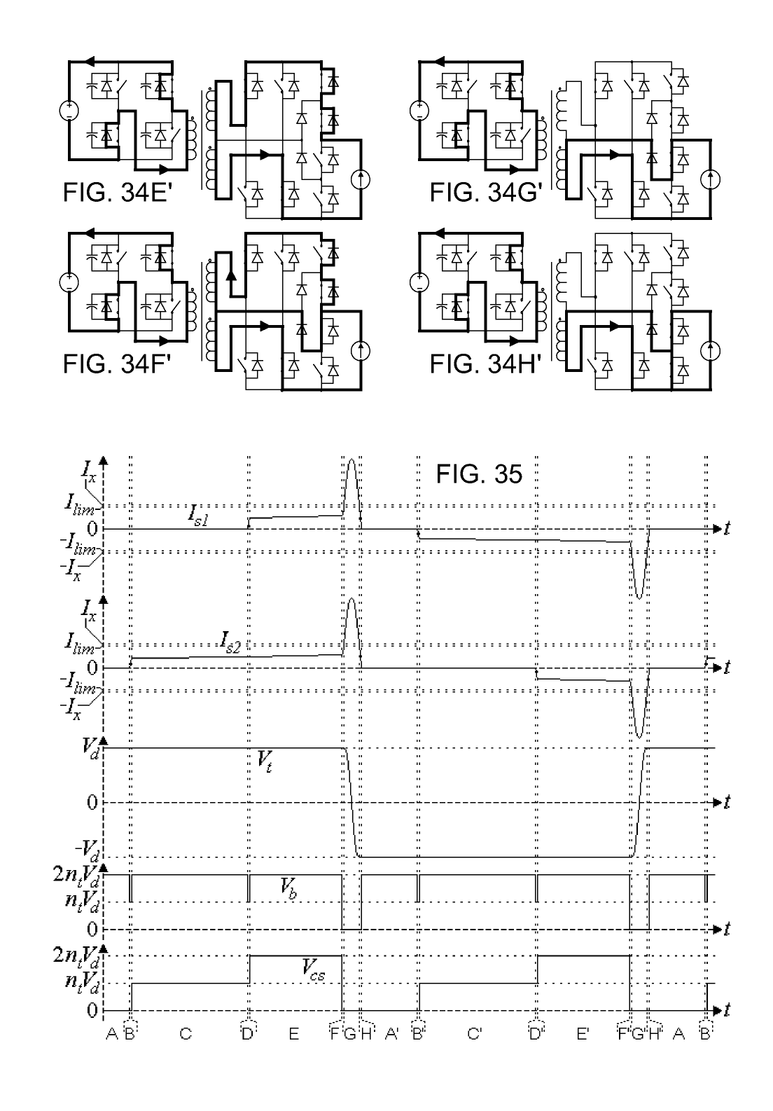

If the secondary winding currents, Iₛ₁ and Iₛ₂, at the end of time period B (i.e. Iₓ in FIG. 7) are greater than the magnitude of current in the inductive element 46, then the switches 16E and 16F can be turned off immediately after time period B. Depending on how much greater the secondary winding currents, Iₛ₁ and Iₛ₂, at the end of time period B are than the magnitude of current in the inductive element 46, the snubber capacitors' voltages may also reach the dc voltage rails prior to the secondary winding currents, Iₛ₁ and Iₛ₂, becoming equal to the current in the inductive element 46. FIG. 33 and FIGS. 34A-H′ illustrate an example of this for a different secondary circuit. In either scenario the secondary winding currents, Iₛ₁ and Iₛ₂, with respect to the positive voltage of the windings (i.e. sgn(Vₜ)*Iₛ₁ and sgn(Vₜ)*Iₛ₂, where sgn(Vₜ) equals 1 if Vₜ is positive, and −1 if Vₜ is negative) are less than the negative current of the inductive element 46 when switches 16E and 16F are turned off. Since under these conditions current is conducting in the diode direction of switches 16E and 16F (see FIG. 8D or FIG. 8D′ as examples), the secondary circuit's clamp circuit 99 (or the secondary circuit 96 itself) absorbs a minimal amount of energy. If the secondary winding currents, Iₛ₁ and Iₛ₂, with respect to the positive voltage of the windings are greater than the negative current of the inductive element 46 when switches 16E and 16F are turned off, the difference in current between the secondary windings 56A and 56B and the inductive element 46 is absorbed by the clamp circuit 99 (or the secondary circuit 96 itself). However, the short-circuit time (time periods B and B′ in FIG. 7) is still beneficial in that it decreases the differences in current, and thus the energy absorbed by the clamp circuit 99 (or the secondary circuit 96 itself).

The above example commutation method is illustrated with the idealization that there is no inherent (i.e. parasitic) capacitance across the bi-directional switches 6A-6A′, 6B-6B′, 16C-6C′, and 6D-6D′ and switches 16E and 16F. If the switches and bi-directional switches include a significant inherent capacitance, the commutation method can be modified to utilize this capacitance to further reduce the energy absorbed by the clamp circuit 99 (or the secondary circuit 96 itself). As one example, the switches 16E and 16F can be turned off at a preset time after the switch 6B and 6C are turned on and prior to the currents in the secondary windings 56A and 56B becoming greater than the current in the inductive element 46. This allows the inherent capacitance across the switches 16E and 16F to charge at the same time as the secondary winding currents, Iₛ₁ and Iₛ₂, are increasing to become equal to the current in the inductive element 46. At low load conditions a significant inherent capacitance also makes it advantageous to short circuit the secondary winding 56 just before to just after the primary circuit's switches are turned off. As an example switches 6B and 6C are turned on at approximately the same time as switches 14A and 14D are turned off.

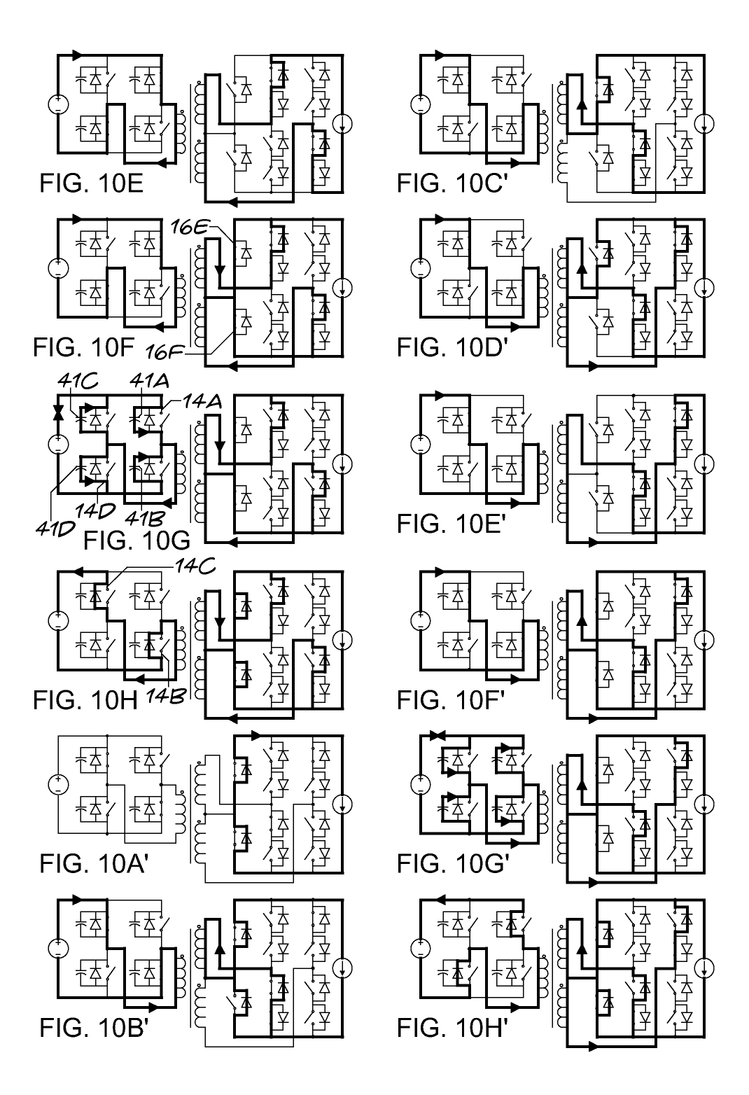

The commutation method utilizing the short-circuiting of the secondary windings 56A and 56B is also applicable for power transfer to the secondary circuit 96 under low load conditions. An example of commutating the same converter 11 for power transfer to the secondary circuit 96 is illustrated with the voltage and current waveforms in FIG. 9 and the commutation circuit diagrams in FIGS. 10A-H′.

After time period A in FIG. 9 (the switch state in FIG. 10A) switch 16E is turned off at zero voltage and switch 6A′ is then turned on at zero current (switch 6A′ on then switch 16E off also valid). This results in the secondary winding current, Iₛ₁, increasing until it is equal to the current in the inductive element 46 (FIG. 10B). When the secondary winding current, Iₛ₁, equals the current in the inductive element 46, it begins time period C (FIG. 10C). After time period C is over, switch 16F is turned off at zero voltage and switch 6D′ is then turned on at zero current (switch 6D′ on then switch 16F off also valid). This results in the secondary winding current, Iₛ₂, increasing until it is equal to the current in the inductive element 46 (FIG. 10D). When the secondary winding current, Iₛ₂, equals the current in the inductive element 46, it begins time period E (FIG. 10E). After time period E is over, switches 16E and 16F are turned on at zero current to short-circuit the secondary windings 56A and 56B. This results in an increase in the secondary winding current, Iₛ₁ and Iₛ₂, to Iₓ (FIG. 10F). The secondary winding currents, Iₛ₁ and Iₛ₂, at the end of time period F (i.e. Iₓ in FIG. 9) should be greater than Iₗᵢₘ, which is the minimum current required to achieve the zero voltage switch transition of the primary switches 14B and 14C in time period G. When the secondary winding currents, Iₛ₁ and Iₛ₂, equal Iₓ, switches 14A and 14D are turned off at zero voltage. This causes the resonant charging and discharging of the primary snubber capacitors 41A, 41B, 41C, and 41D with the magnetizing current and stored leakage inductance energy of the high-frequency link 50 (FIG. 10G). When the snubber capacitors' voltages reach the dc voltage rails, the current starts to conduct in the diode direction of switches 14B and 14C (FIG. 10H). During time periods G or H switches 6A and 6D are turned off at zero voltage. During time period H switches 14B and 14C are turned on at zero voltage. At the end of time period H the secondary winding currents, Iₛ₁ and Iₛ₂, fall to zero, and it begins time period A′ in which no current conducts in the secondary windings 56A and 56B (FIG. 10A′). During time period A′ switches 6B and 6C are turned on at zero voltage, and switches 6A′ and 6D′ are turned off at zero voltage. FIGS. 10A′-H′ show the remainder of the commutation cycle, which is similar to FIGS. 10A-H, but the polarity of the primary winding voltage, Vₜ, and the secondary winding currents, Iₛ₁ and Iₛ₂, are all opposite. After time period H′ the cycle is reset starting with time period A.

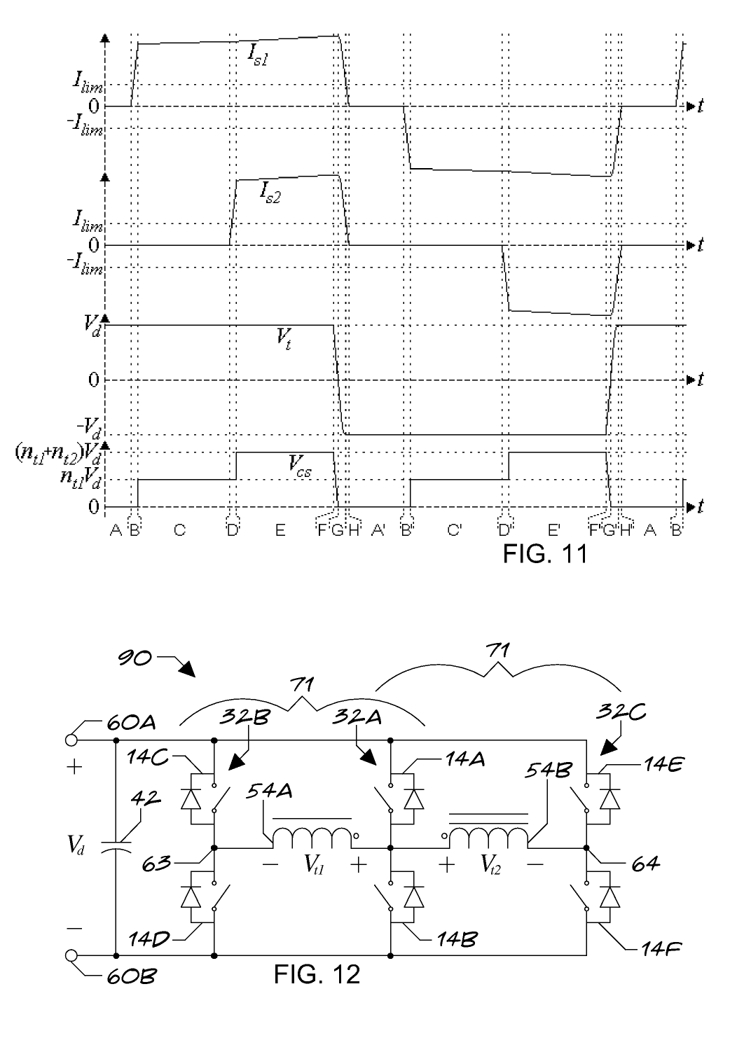

If the secondary winding currents, Iₛ₁ and Iₛ₂, at the end of time periods E and E′ in FIG. 9 are sufficient to achieve the zero voltage switch transition in time periods G and G′, then the time periods F and F′ in FIG. 9 and the switch states in FIG. 10F and FIG. 10F′ can be eliminated. An example of the voltage and current waveforms for this type of transition are illustrated in FIG. 11. In this type of transition the switches 16E and 16F are not turned on until after the primary winding voltage, Vₜ, is negative (also switches 16E and 16F not turned on until Vₜ is positive). As an in-between option of FIG. 9 and FIG. 11, the switches 16E and 16F can also be turned on as the primary winding voltage, Vₜ, decreases to zero (also switches 16E and 16F turned on as Vₜ increases to zero).

For the converter 11 illustrated in FIG. 7 through FIG. 11, the short-circuit time is the time between when the switches 6B, 6C, 16E and 16F or switches 6A, 6D, 16E and 16F are all turned on and the switches of the full-bridge circuit 71 are turned off. In FIG. 7 and FIG. 9 the short-circuit time is positive, and in FIG. 11 it is negative. By changing the short-circuit time in increments or continuously depending on load conditions, the quantity of energy absorbed by the clamp circuit is considerably decreased, and soft switching is possible under all load conditions (with no extra components or large magnetizing current).

In FIG. 7 through FIG. 11 current is applied to the secondary winding 56A for a longer duration than current is applied to the secondary winding 56B. Since the secondary circuit 96 in FIG. 6 is symmetric, it is also possible to change the operation so that current is applied to the secondary winding 56B for a longer duration. If the turns ratios, nₜ₁ and nₜ₂, of the secondary windings 56A and 56B are different, the change in operation adds an additional level to the converter. However, it is still only possible to apply three different voltage levels to the inductive element 46 between voltage polarity changes of the primary winding 54 (i.e. levels of 0, nₜ₁V_{d}, and (nₜ₁+nₜ₂)V_{d} or levels of 0, nₜ₂V_{d}, and (nₜ₁+nₜ₂)V_{d}). If the secondary windings' turns ratios nₜ₁ and nₜ₂ are equal, it is also possible to alternate between the secondary windings 56A and 56B as the longer duration winding. This type of commutation is illustrated for a different secondary circuit 96 in FIG. 33 through FIG. 36A-H′.

In FIG. 7 through FIG. 11 three voltage levels are applied to the current source 46, but in many applications it is desirable to only apply two of these voltage levels depending on converter conditions. To accomplish this appropriate time periods are eliminated, and the switch states are slightly modified so that switches 16E and 16F in FIG. 6 operate at the same frequency as the other switches in the mixed leg circuit 77B. If it is desired to only utilize the levels 0 and nₜ₁V_{d} for FIG. 7, the time periods F and F′ are eliminated, switch 16E remains on during time periods C through E, and switch 16F remains on during time periods C′ through E′. If it is desired to only utilize the levels 0 and nₜ₁V_{d} for FIG. 9 or FIG. 11, the time periods E and E′ are eliminated, switch 16F remains on during time period D, and switch 16E remains on during time period D′. If it is desired to only utilize the levels nₜ₁V_{d} and (nₜ₁+nₜ₂)V_{d} for FIG. 7, FIG. 9, and FIG. 11, the time periods A and A′ are eliminated, and switches 6A′ and 6B′ are on continuously. Also, for FIG. 7 the bi-directional phase leg 22B's switch transitions that occur in time periods A and A′ happen in time period I′ and I respectively, switch 6A turns on at the start of time period I and also remains on during time periods B and C, switch 6B turns on at the start of time period I′ and also remains on during time periods B′ and C′, switch 16E remains off during time period I′, B, and C, and switch 16F remains off during time period I, B′, and C′. Also, for FIG. 9 and FIG. 11 switch 6A turns on at the start of time period F′ (or G′ for FIG. 11) and remains on during time periods G′ and H′, switch 6B turns on at the start of time period F (or G for FIG. 11) and remains on during time periods G and H, switch 16E remains off during time period F, G, F′, G′, and H′, and switch 16F remains off during time period F, G, H, F′, and G′. When only two levels are applied to the current source 46, the short-circuit time is started by turning on only one switch.

The secondary winding currents, Iₛ₁ and Iₛ₂, for the mixed leg circuit 77B in FIG. 6 may not be equal during the voltage polarity transitions of the primary winding 54. If the secondary winding currents, Iₛ₁ and Iₛ₂, are not equal, the waveforms and the current paths in the circuit diagrams will be slightly different, but the operation of the mixed leg circuit 77B is still basically the same.

Example Embodiment with Two High-Frequency Links

FIG. 12 illustrates an example primary circuit 90 appropriate for the example embodiment in FIG. 2. The primary circuit 90 in FIG. 12 comprises two full-bridge circuits 71, but with a common phase leg 32A shared by both full-bridge circuits 71. Separate phase legs can also be utilized, but sharing the phase leg 32A is advantageous in soft switching this phase leg. No snubber capacitances are shown in FIG. 12, but they can be included across each switch, across each primary winding, or across both the switches and the primary windings.

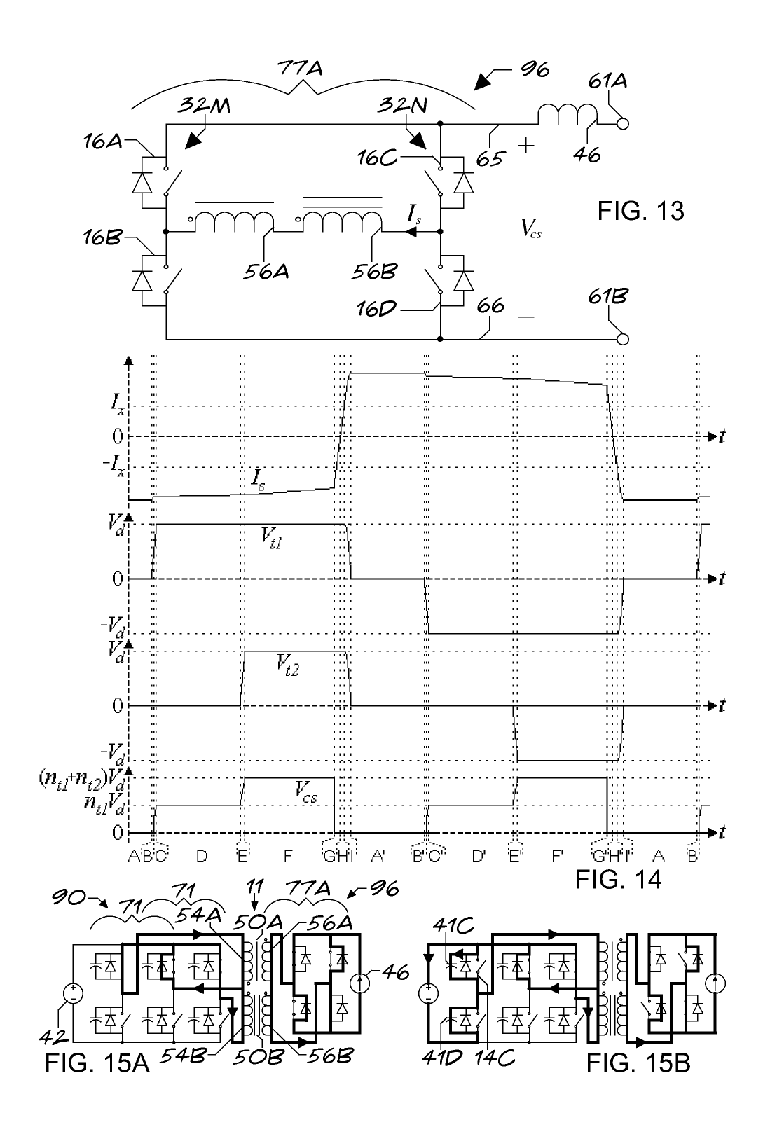

FIG. 13 illustrates an example secondary circuit 96 appropriate for the example embodiments in FIG. 2 and FIG. 3. This secondary circuit 96 comprises a full-bridge circuit 77A connected to an inductive element 46. The secondary windings 56A and 56B of high-frequency links 50A and 50B respectively are connected in series between the phase legs 32M and 32N of the full-bridge circuit 77A. The voltages across the secondary windings 56A and 56B are the primary winding voltages multiplied by the turns ratios between the primary windings 54A and 54B the secondary winding 56A and 56B (i.e. nₜ₁Vₜ₁ and nₜ₂Vₜ₂ for secondary windings 56A and 56B respectively). Inversely, each primary winding current is the secondary winding current multiplied by the turns ratio (i.e. nₜ₁Iₛ and nₜ₂Iₛ for primary windings 54A and 54B respectively) plus additional magnetizing currents. If the secondary circuit 96 in FIG. 13 is utilized in the example embodiment in FIG. 3, with a primary circuit 90 like in FIG. 67, or other similar embodiments, a single secondary winding 56, 56A, or 56B replaces the secondary windings 56A and 56B in the diagrams of the secondary circuits 96. Similarly, other example secondary circuits 96 that include secondary windings 56A and 56B (also possibly 56B′) of the high-frequency links 50A and 50B illustrated herein can be replaced with a single secondary winding for appropriate embodiments.

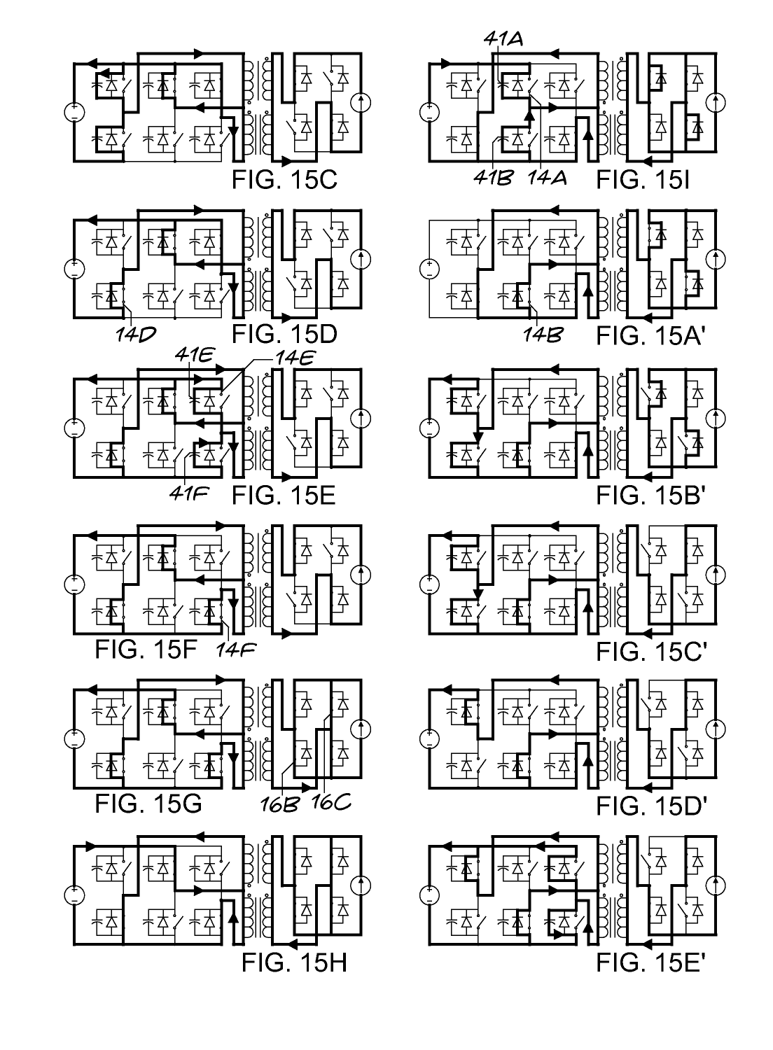

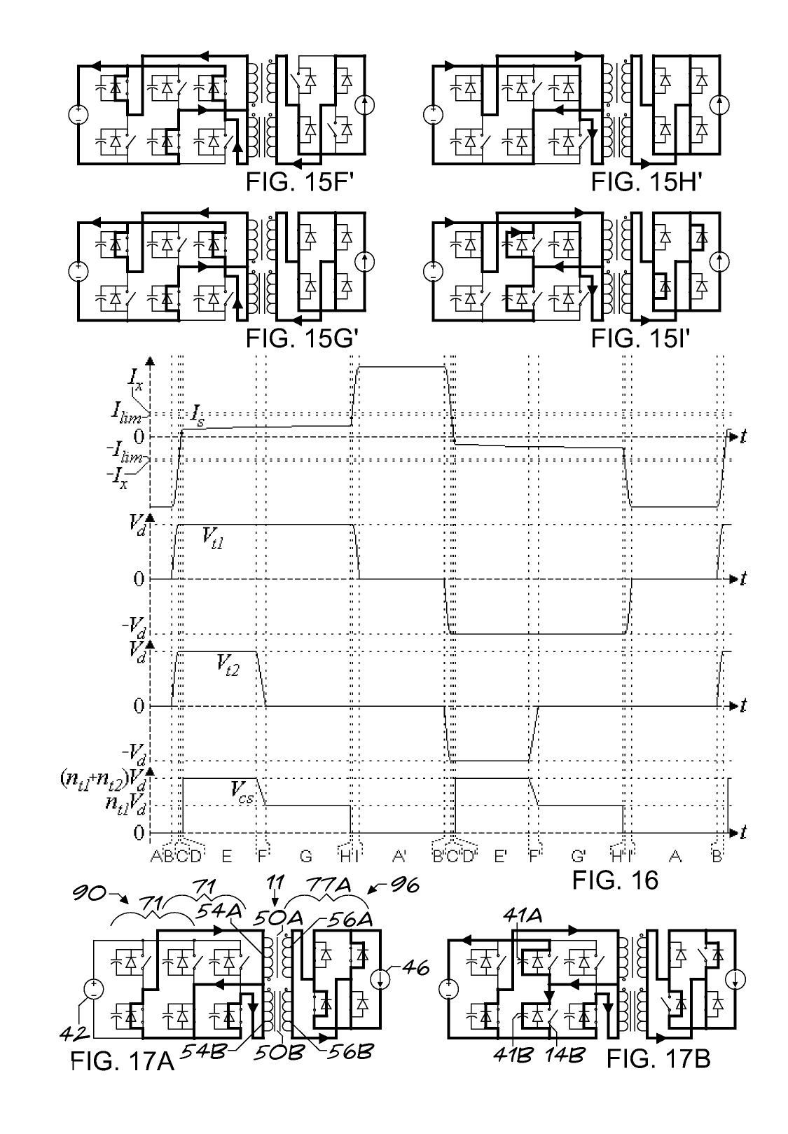

Combining the primary circuit 90 in FIG. 12 and the secondary circuit 96 in FIG. 13 is one example of the converter 11 illustrated in FIG. 2. The example commutation method for this converter 11 controls the duration voltage is applied to the primary windings 54A and 54B. Examples of this commutation method are illustrated in FIG. 14 through FIG. 18. An example of commutating this converter 11 for power transfer from the secondary circuit 96 is illustrated with the voltage and current waveforms in FIG. 14 and the commutation circuit diagrams in FIGS. 15A-I′.

After time period A in FIG. 14 (the switch state in FIG. 15A) switch 14C is turned off at zero voltage. This causes the resonant charging and discharging of the primary snubber capacitors 41C and 41D with the magnetizing current and stored leakage inductance energy of the high-frequency link 50A (FIG. 15B). During time period B switches 16B and 16C are turned off at zero voltage. When the secondary winding current, Iₛ, equals the current in the inductive element 46, it begins time period C (FIG. 15C). When the snubber capacitors' voltages reach the dc voltage rails, the current starts to conduct in the diode direction of switch 14D (FIG. 15D). During time period D switch 14D is turned on at zero voltage. After time period D is over, switch 14E is turned off at zero voltage. This causes the charging and discharging of the primary snubber capacitors 41E and 41F (FIG. 15E). When the snubber capacitors' voltages reach the dc voltage rails, the current starts to conduct in the diode direction of switch 14F (FIG. 15F). During time period F switch 14F is turned on at zero voltage. After time period F is over, switches 16B and 16C are turned on at zero current to short-circuit the secondary windings 56A and 56B. This results in an increase in the secondary winding current, Iₛ, to Iₓ (FIG. 15G and FIG. 15H). When the secondary winding current, Iₛ, equals Iₓ, switch 14A is turned off at zero voltage. This causes the resonant charging and discharging of the primary snubber capacitors 41A and 41B until the primary winding voltages, Vₜ₁ and Vₜ₂, equal zero (FIG. 15I). Time period I also results in an increase in the secondary winding current, Iₛ. When the primary winding voltages, Vₜ₁ and Vₜ₂, equal zero, time period A′ starts and current starts to conduct in the diode direction of switch 14B (FIG. 15A′). During time period A′ switch 14B is turned on at zero voltage. FIGS. 15A′-I′ show the remainder of the commutation cycle, which is similar to FIGS. 15A-I, but the polarity of the primary winding voltages, Vₜ₁ and Vₜ₂, and the secondary winding current, Iₛ, are all opposite. After time period I′ the cycle is reset starting with time period A.

If the secondary winding current, Iₛ, at the end of time period H (i.e. Iₓ in FIG. 14) is sufficiently greater than the magnitude of current in the inductive element 46, the voltage of snubber capacitors 41A and 41B may reach the dc voltage rails prior to the secondary winding current, Iₛ, becoming equal to the current in the inductive element 46. In either scenario the secondary winding current, Iₛ, with respect to the positive voltage of the winding 56A (i.e. sgn(Vₜ₁)*Iₛ) is less than the negative current of the inductive element 46 when switches 16B and 16C or switches 16A and 16D are turned off. Since under these conditions current is conducting in the diode direction of the secondary circuit switches that are being turned off (see FIG. 15B or FIG. 15B′ as examples), the secondary circuit's clamp circuit 99 (or the secondary circuit 96 itself) absorbs a minimal amount of energy. If the secondary winding current, Iₛ, with respect to the positive voltage of the winding 56A is greater than the negative current of the inductive element 46 when switches 16B and 16C or switches 16A and 16D are turned off, the difference in current between the secondary windings 56A and 56B and the inductive element 46 is absorbed by the clamp circuit 99 (or the secondary circuit 96 itself). However, the short-circuit time (time periods G through H and G′ through H′ in FIG. 14) is still beneficial in that it decreases the difference in current, and thus the energy absorbed by the clamp circuit 99 (or the secondary circuit 96 itself).

The above example commutation method is illustrated with the idealization that there is no inherent (i.e. parasitic) capacitance across the switches 16A, 16B, 16C, and 16D. If the switches include a significant inherent capacitance, the commutation method can be modified to utilize this capacitance to further reduce the energy absorbed by the clamp circuit 99 (or the secondary circuit 96 itself). As one example, the switches 16B and 16C can be turned off at a preset time with respect to switch 14C turning off and prior to the current in the secondary windings 56A and 56B becoming greater than the current in the inductive element 46. This allows the inherent capacitance across the switches 16B and 16C to charge at the same time as the secondary winding current, Iₛ, is increasing to become equal to the current in the inductive element 46. The above example commutation method is also illustrated with the idealization that there is no conduction loss during the freewheeling time periods A and A′. The conduction loss will result in the current at the start of time periods A and A′ being of a greater amplitude (i.e. overshooting the desired value). This conduction loss in some applications may also result in it being desirable to turn off the appropriate switches in the full-bridge circuit 77A at or near the start of time periods A and A′. An additional variation on the above example commutation methods is to short-circuit the secondary winding 56 at approximately the same time as a switch in phase leg 32A is turned off.

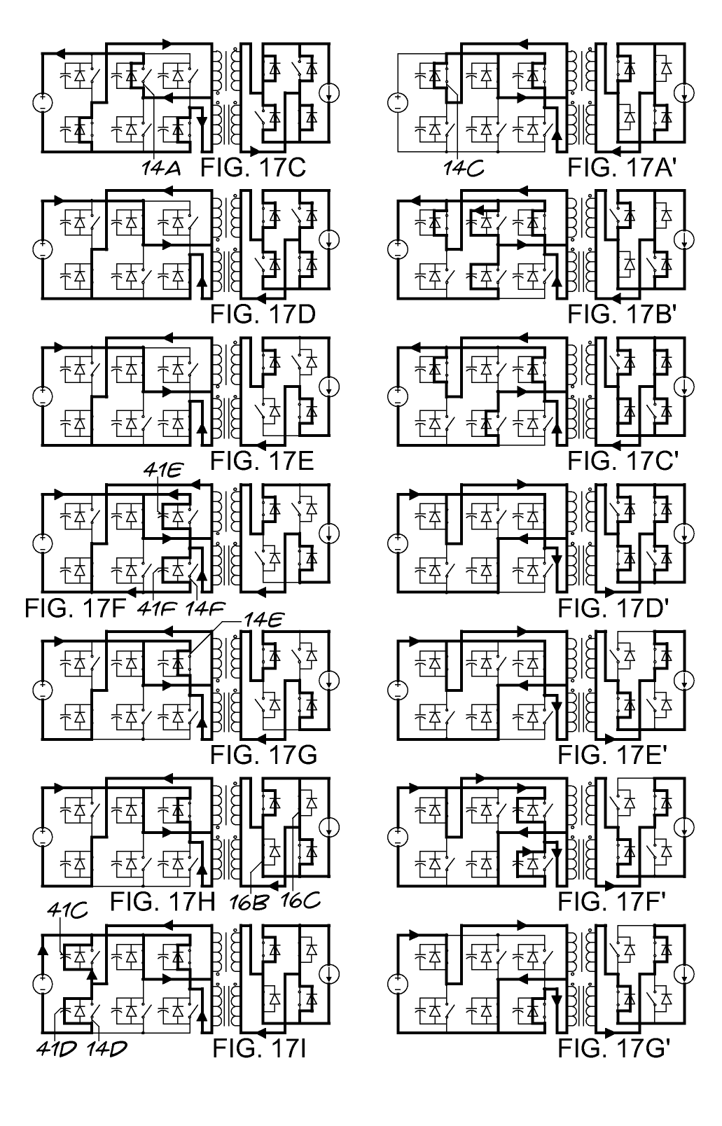

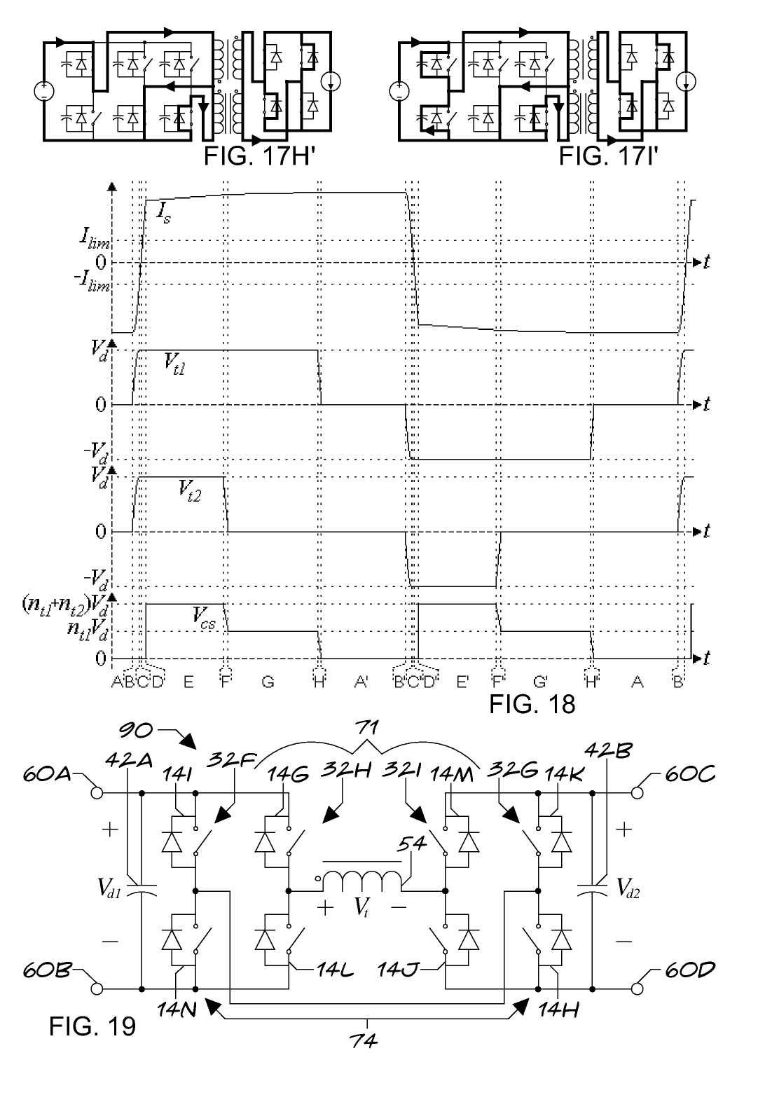

The commutation method utilizing the short-circuiting of the secondary windings 56A and 56B is also applicable for power transfer to the secondary circuit 96 under low load conditions. An example of commutating the same converter 11 for power transfer to the secondary circuit 96 is illustrated with the voltage and current waveforms in FIG. 16 and the commutation circuit diagrams in FIGS. 17A-I′.

After time period A in FIG. 16 (the switch state in FIG. 17A) switch 14B is turned off at zero voltage. This causes the resonant charging and discharging of the primary snubber capacitors 41A and 41B with the magnetizing current and stored leakage inductance energy of the high-frequency links 50A and 50B (FIG. 17B). When the snubber capacitors' voltages reach the dc voltage rails, the current starts to conduct in the diode direction of switch 14A (FIG. 17C). During time period C switch 14A is turned on at zero voltage. Time period C continues until the secondary winding current, Iₛ, changes polarity, which starts time period D (FIG. 17D). During time periods B, C, or D switches 16B and 16C are turned off at zero voltage. When the secondary winding current, Iₛ, equals the current in the inductive element 46, it begins time period E (FIG. 17E). After time period E is over, switch 14F is turned off at zero voltage. This causes the charging and discharging of the primary snubber capacitors 41E and 41F until the primary winding voltage, Vₜ₂, equals zero (FIG. 17F). When the primary winding voltage, Vₜ₂, equals zero, current starts to conduct in the diode direction of switch 14E (FIG. 17G). During time period G switch 14E is turned on at zero voltage. After time period G is over, switches 16B and 16C are turned on at zero current to short-circuit the secondary windings 56A and 56B. This results in an increase in the secondary winding current, Iₛ to Iₓ (FIG. 17H). The secondary winding current, Iₛ, at the end of time period H (i.e. Iₓ in FIG. 16) should be greater than Iₗᵢₘ, which is the minimum current required to achieve the zero voltage switch transition of the primary switch 14B in time period B′. When the secondary winding current, Iₛ, equals Iₓ, switch 14D is turned off at zero voltage. This causes the resonant charging and discharging of the primary snubber capacitors 41C and 41D until the primary winding voltage, Vₜ₁, equals zero (FIG. 17I). Time period I also results in an increase in the secondary winding current, Iₛ. When the primary winding voltage, Vₜ₁, equals zero, time period A′ starts and current starts to conduct in the diode direction of switch 14C (FIG. 17A′). During time period A′ switch 14C is turned on at zero voltage. FIGS. 17A′-I′ show the remainder of the commutation cycle, which is similar to FIGS. 17A-I, but the polarity of the primary winding voltages, Vₜ₁ and Vₜ₂, and the secondary winding current, Iₛ, are all opposite. After time period I′ the cycle is reset starting with time period A.

If the secondary winding current, Iₛ, at the end of time periods G and G′ in FIG. 16 is sufficient to achieve the zero voltage switch transition in time periods B′ and B, then the time periods H and H′ in FIG. 16 and the switch states in FIG. 17H and FIG. 17H′ can be eliminated. An example of the voltage and current waveforms for this type of transition are illustrated in FIG. 18. In this type of transition the switches 16B and 16C or switches 16A and 16D are not turned on until after the primary winding voltage, Vₜ₁, is zero. As an in-between option of FIG. 16 and FIG. 18, the switches 16B and 16C can also be turned on as the primary winding voltage, Vₜ₁, decreases to zero (also switches 16A and 16D turned on as Vₜ₁ increases to zero).

For the converter 11 illustrated in FIG. 14 through FIG. 18, the short-circuit time is the time between when the switches of the full-bridge circuit 77A are turned on and the switches of the phase legs 32A (FIGS. 15A-I′) or 32B (FIGS. 17A-I′) are turned off. In FIG. 14 and FIG. 16 the short-circuit time is positive, and in FIG. 18 it is negative. By changing the short-circuit time in increments or continuously depending on load conditions, the quantity of energy absorbed by the clamp circuit is considerably decreased, and soft switching is possible under all load conditions (with no extra components or large magnetizing current).

Under low load conditions (i.e. low magnitude of current in the inductive element 46) the charging and discharging of the snubber capacitances 41E and 41F (switch states FIG. 17F and FIG. 17F′ as examples) may take to long for the zero voltage transitions to take place in the switches of phase leg 32C. In some application this is acceptable since the loss is still reduced by the voltage across the switch being less and the low magnitude of current. If this is not acceptable, a small inductor can be connected between lines 63 and 64 of the primary circuit 90 in FIG. 12. The current that flows in this extra inductor assists in the zero voltage switch transitions of phase leg 32C. The magnitude of the current in the extra inductor will be minimal, and therefore the extra inductor will only minimally increase the size and conduction loss of the converter.

In FIG. 14 through FIG. 18 voltage is applied to the primary winding 54A for a longer duration than the voltage applied to the primary winding 54B. Since the primary circuit 90 in FIG. 12 is symmetric, it is also possible to change the operation so that voltage is applied to the primary winding 54B for a longer duration. If the turns ratios, nₜ₁ and nₜ₂, of the high-frequency links 50A and 50B are different, the change in operation adds an additional level to the converter. However, it is still only possible to apply three different voltage levels to the inductive element 46 between voltage polarity changes of the primary windings 54A and 54B (i.e. levels of 0, nₜ₁V_{d}, and (nₜ₁+nₜ₂)V_{d} or levels of 0, nₜ₂V_{d}, and (nₜ₁+nₜ₂)V_{d}).

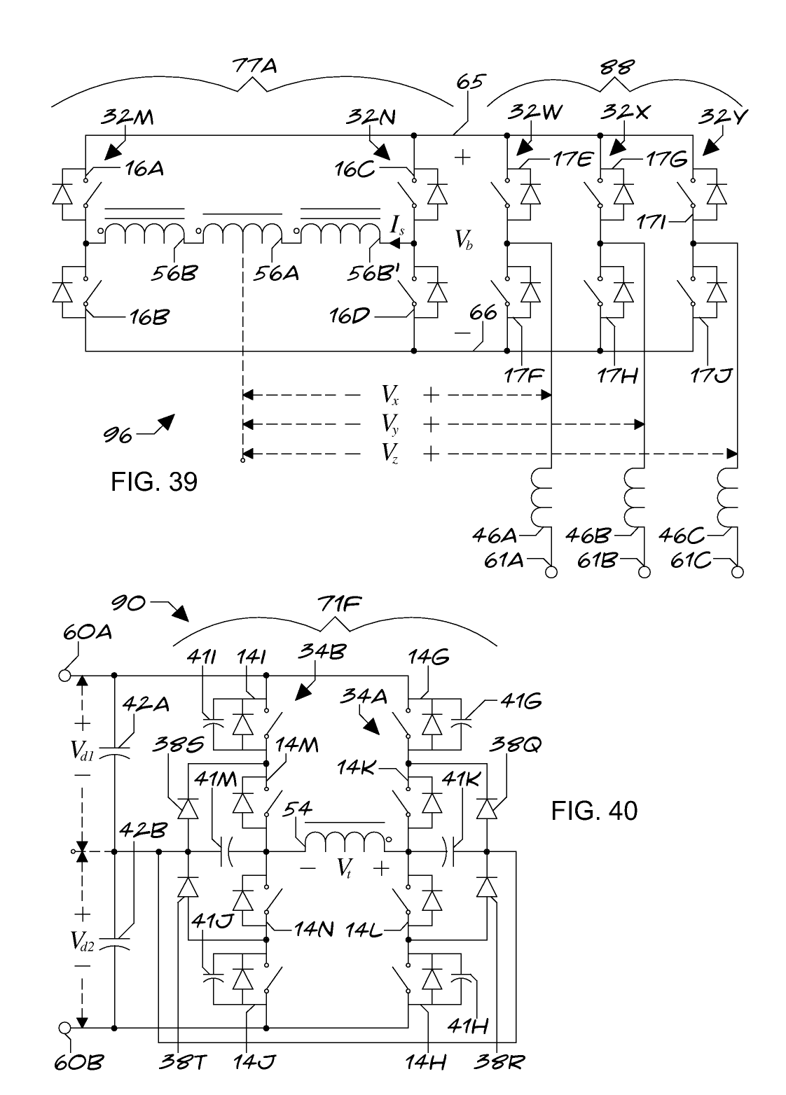

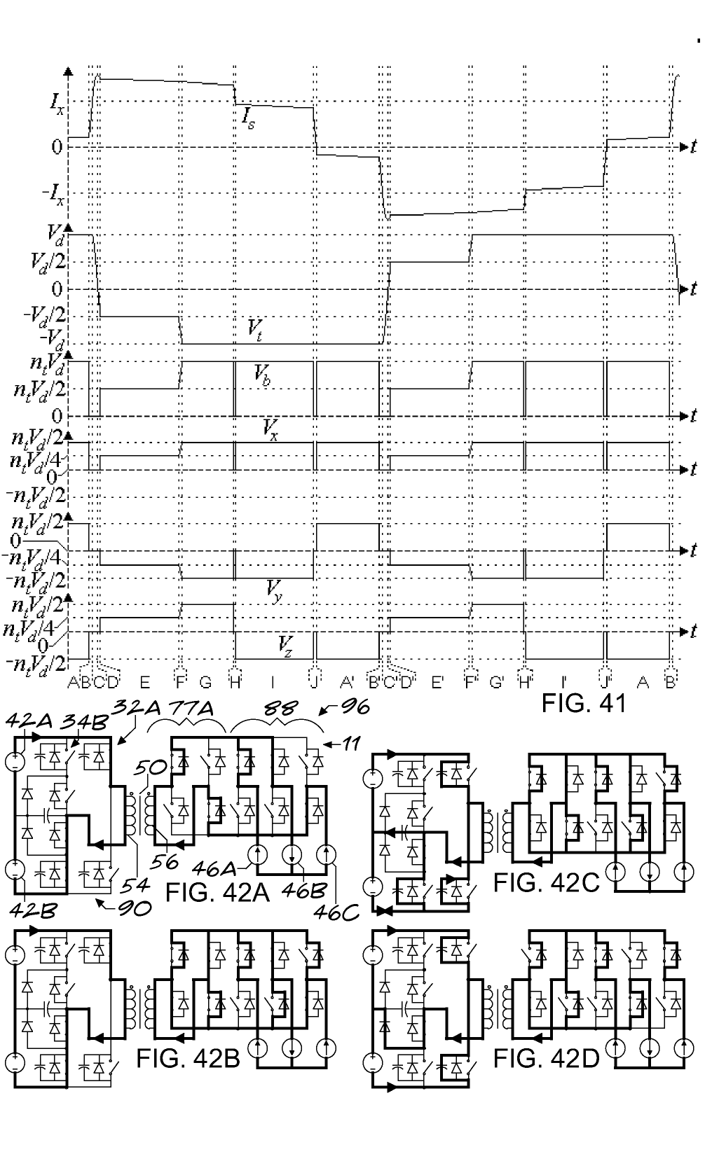

In FIG. 14 through 18 three voltage levels are applied to the current source 46, but in many applications it is desirable to only apply two of these voltage levels depending on converter conditions. To accomplish this appropriate time periods are eliminated. If it is desired to only utilize the levels 0 and nₜ₁V_{d}, the time periods F and F′ in FIG. 14 or the time periods E and E′ in FIG. 16 or FIG. 18 are eliminated. If it is desired to only utilize the levels nₜ₁V_{d} and (nₜ₁+nₜ₂)V_{d}, the time periods A and A′ in FIG. 39, FIG. 41, or FIG. 42 are eliminated. Due to the elimination of time periods A and A′, the switch transitions of the phase legs 32A and 32B can occur at the same time (i.e. similar to the polarity transitions of the full-bridge circuit 71 in FIG. 7 through FIG. 11).

Example Embodiment with Two Primary Side Capacitive Elements

FIG. 19 illustrates an example primary circuit 90 appropriate for the example embodiment in FIG. 3. The primary circuit 90 in FIG. 19 comprises the full-bridge circuit 71 and a full-bridge circuit 74. In the full-bridge circuit 71 the primary winding 54 is connected between two phase legs 32H and 32I, while the phase legs phase legs 32F and 32G of the full-bridge circuit 74 are connected directly to each other. The phase legs 32F and 32H are connected to the capacitive element 42A, and the phase legs 32G and 32I are connected to the capacitive element 42B. No snubber capacitances are shown in FIG. 19, but they can be included across each switch, across the primary winding, or across both the switches and the primary winding.

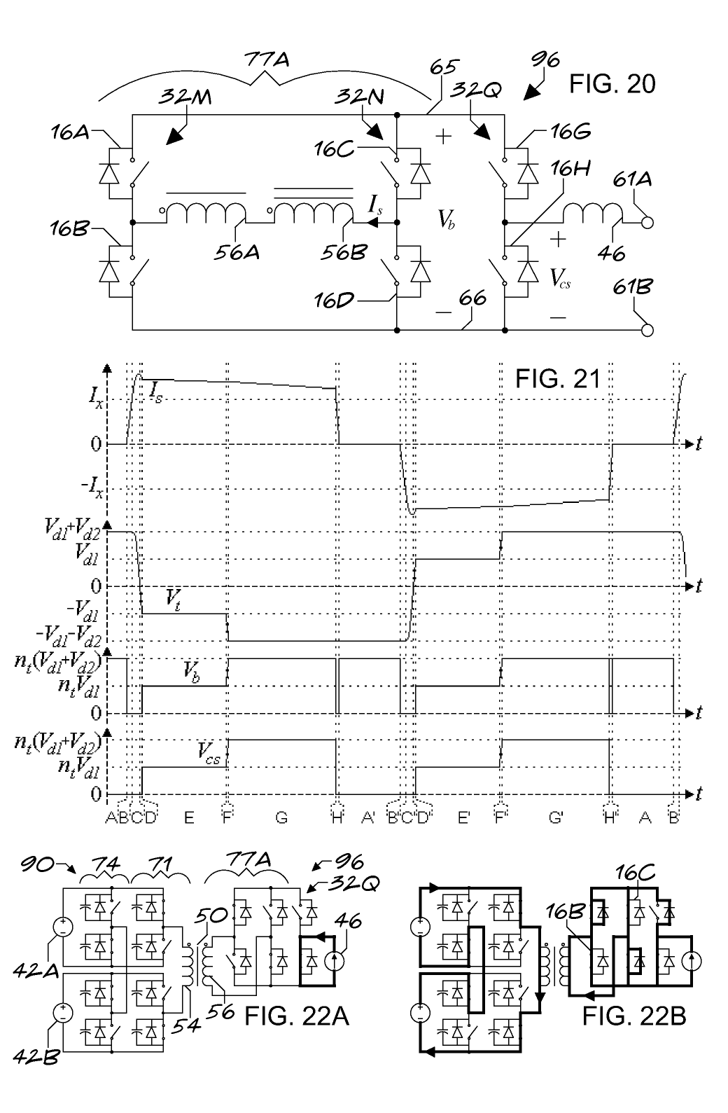

FIG. 20 illustrates an example secondary circuit 96 appropriate for the example embodiments in FIG. 2 and FIG. 3. This secondary circuit 96 comprises the full-bridge circuit 77A connected to a phase leg 32Q that is connected to the inductive element 46. As already stated, when the secondary circuit 96 is utilized in the example embodiment in FIG. 3, the secondary windings 56A and 56B are replaced with the secondary winding 56. The voltage across the secondary winding 56 is the primary winding voltage multiplied by the turns ratio between the primary winding 54 and the secondary winding 56 (i.e. nₜVₜ). Inversely, the primary winding current is the secondary winding current multiplied by the turns ratio (i.e. nₜIₛ) plus additional magnetizing current.

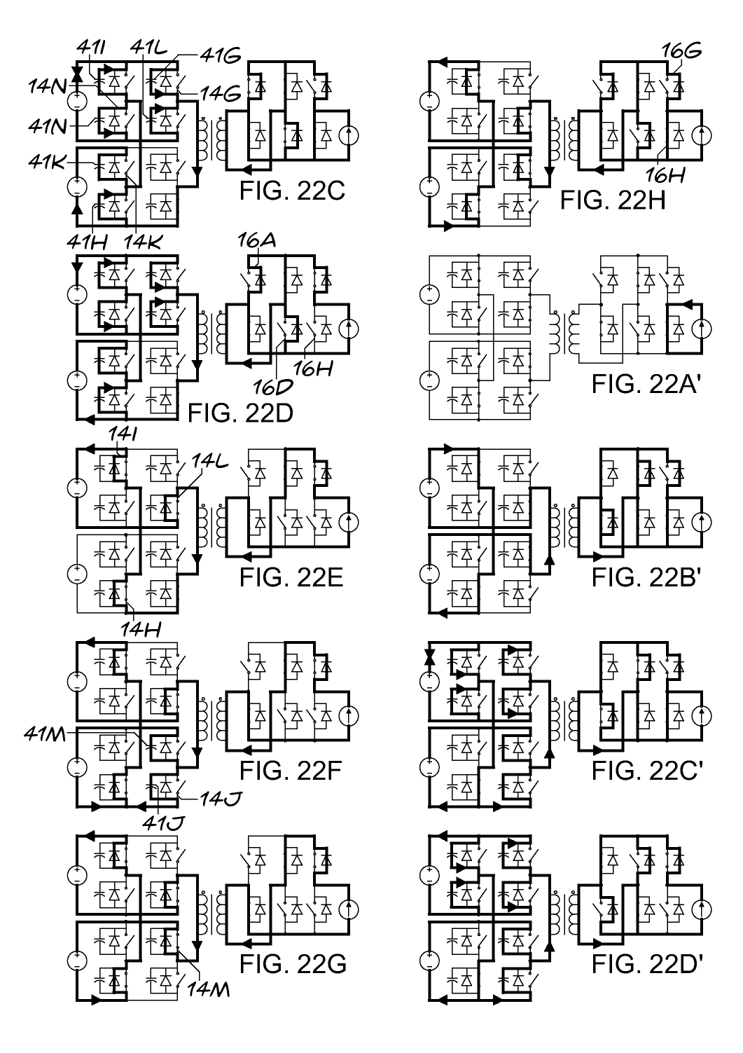

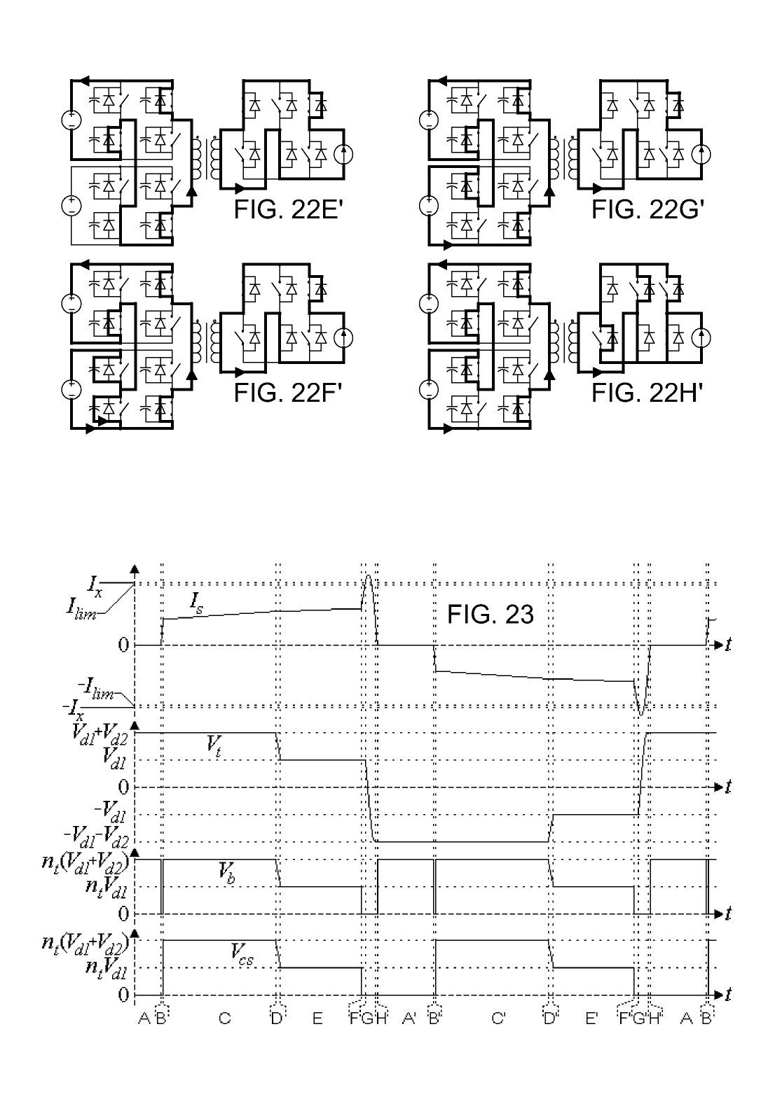

Combining the primary circuit 90 in FIG. 19 and the secondary circuit 96 in FIG. 20 is one example of the converter 11 illustrated in FIG. 3. The example commutation method for this converter 11 controls the duration voltage is applied to the primary winding 54, and the duration current is applied to the secondary winding 56. Examples of this commutation method are illustrated in FIG. 21 through FIG. 24A-H′. An example of commutating this converter 11 for power transfer from the secondary circuit 96 is illustrated with the voltage and current waveforms in FIG. 21 and the commutation circuit diagrams in FIGS. 22A-H′.

After time period A in FIG. 21 (the switch state in FIG. 22A) switches 16B and 16C are turned on at zero current to short-circuit the secondary winding 56. This results in an increase in the secondary winding current, Iₛ, to Iₓ (FIG. 22B). When the secondary winding current, Iₛ, equals Iₓ, switches 14G, 14K, and 14N are turned off at zero voltage. This causes the resonant charging and discharging of the primary snubber capacitors 41G, 41H, 41I, 41K, 41L, and 41N with the magnetizing current and stored leakage inductance energy of the high-frequency link 50 (FIG. 22C). When the secondary winding current, Iₛ, is near its maximum, the switches 16A, 16D, and 16H are turned off at zero voltage, switch 16G is turned on at zero voltage, and time period D starts. The secondary winding current, Iₛ, decreases until it is equal to the current in the inductive element 46 (FIG. 22D). When the snubber capacitors' voltages reach the dc voltage rails of V_{d1} and V_{d2}, the current starts to conduct in the diode direction of switches 14H, 14I, and 14L (FIG. 22E). During time period E switches 14H, 14I, and 14L are turned on at zero voltage. After time period E is over, switch 14J is turned off at zero voltage. This causes the charging and discharging of the primary snubber capacitors 41J and 41M (FIG. 22F). When the snubber capacitors' voltages reach the dc voltage rails of V_{d2}, the current starts to conduct in the diode direction of switch 14M (FIG. 22G). During time period G switch 14M is turned on at zero voltage. After time period G switch 16G is turned off at zero voltage, and switch 16H is then turned on at zero current (switch 16H on then switch 16G off also valid). This results in the secondary winding current, Iₛ, decreasing until it reaches zero (FIG. 22H). When the secondary winding current, Iₛ, falls to zero, it begins time period A′ in which no current conducts in the secondary winding 56 (FIG. 22A′). FIGS. 22A′-H′ show the remainder of the commutation cycle, which is similar to FIGS. 22A-H, but the polarity of the primary winding voltage, Vₜ, and the secondary winding current, Iₛ, are both opposite. After time period H′ the cycle is reset starting with time period A.

In FIG. 21 the secondary winding current, Iₛ, at the end of time period B is a value (Iₓ) that results in it reaching the current in the inductive element 46 at approximately the same time as the snubber capacitors' voltages reach the dc voltage rails. In the majority of situations one of these two events will occur first, but the only change to the switch states is that if the secondary winding current, Iₛ, at the end of time period B is greater than the magnitude of current in the inductive element 46, then the switch 16H can be turned off immediately after time period B. In any of these scenarios the secondary winding current, Iₛ, with respect to the positive voltage of the winding (i.e. sgn(Vₜ)*Iₛ) is less than the negative current of the inductive element 46 when switch 16H is turned off. This results in current conducting in the diode direction of the secondary circuit switches (in FIG. 22D or FIG. 22D′ as examples), and the secondary circuit's clamp circuit 99 (or the secondary circuit 96 itself) absorbs a minimal amount of energy. If the secondary winding current, Iₛ, with respect to the positive voltage of the winding is greater than the negative current of the inductive element 46 when switch 16H is turned off, the difference in current between the secondary winding 56 and the inductive element 46 is absorbed by the clamp circuit 99 (or the secondary circuit 96 itself). However, the short-circuit time (time periods B and B′ in FIG. 21) is still beneficial in that it decreases the difference in current, and thus the energy absorbed by the clamp circuit 99 (or the secondary circuit 96 itself).

The above example commutation method is illustrated with the idealization that there is no inherent (i.e. parasitic) capacitance across the switches 16A, 16B, 16C, 16D, 16E, and 16F. If the switches include a significant inherent capacitance, the commutation method can be modified to utilize this capacitance to further reduce the energy absorbed by the clamp circuit 99 (or the secondary circuit 96 itself). As one example, the switches 16A, 16D, and 16F can be turned off and switch 16E turned on at a preset time after the switch 16B and 16C are turned on and prior to the current in the secondary winding 56 becoming greater than the current in the inductive element 46. This allows the inherent capacitance across the switches 16A, 16D, and 16F to charge at the same time as the secondary winding current, Iₛ, is increasing to become equal to the current in the inductive element 46. At low load conditions a significant inherent capacitance also makes it advantageous to short circuit the secondary winding 56 just before to just after the primary circuit's switches are turned off. As an example switches 16B and 16C are turned on at approximately the same time as switches 14G, 14K, and 14N are turned off.

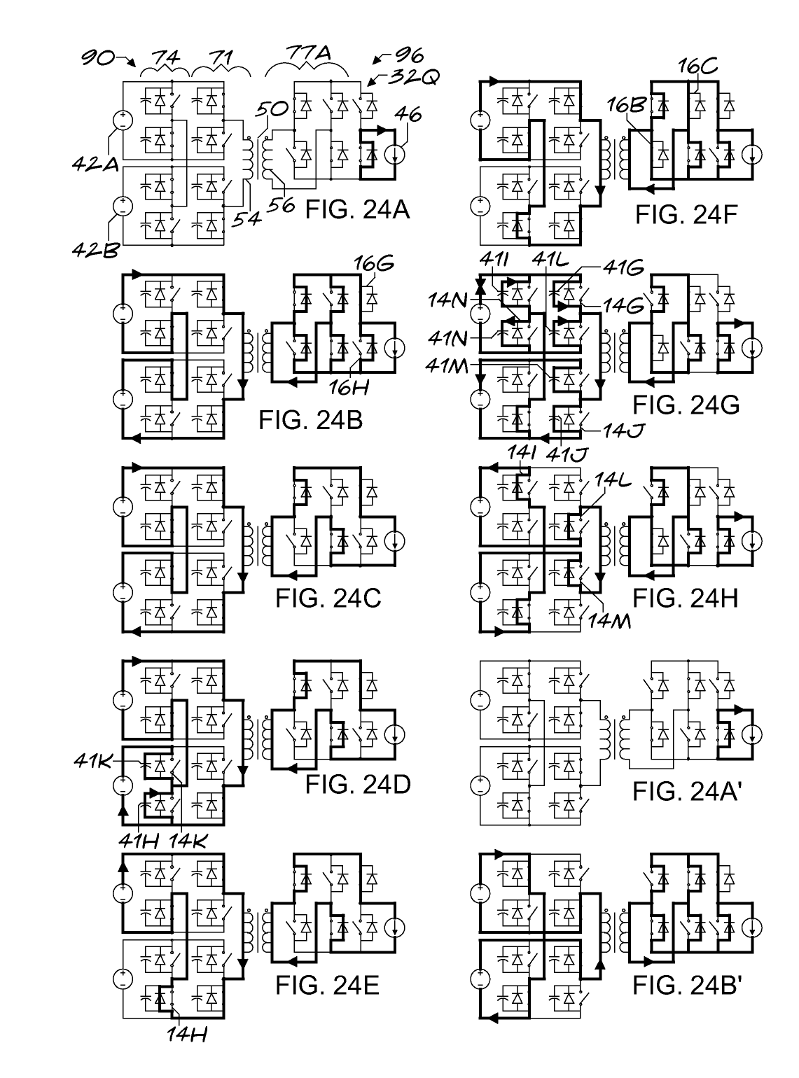

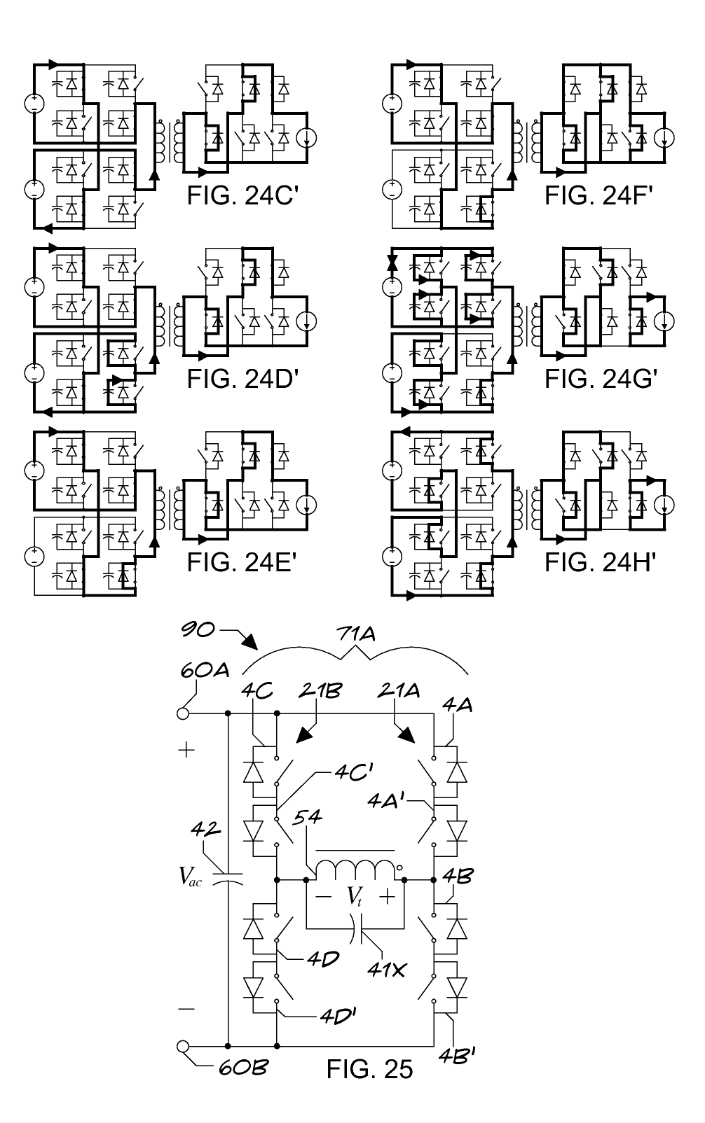

The commutation method utilizing the short-circuiting of the secondary winding 56 is also applicable for power transfer to the secondary circuit 96 under low load conditions. An example of commutating the same converter 11 for power transfer to the secondary circuit 96 is illustrated with the voltage and current waveforms in FIG. 23 and the commutation circuit diagrams in FIGS. 24A-H′.

After time period A in FIG. 23 (the switch state in FIG. 24A) switch 16H is turned off at zero voltage and switch 16G is then turned on at zero current (switch 16G on then switch 16H off also valid). This results in the secondary winding current, Iₛ, increasing until it is equal to the current in the inductive element 46 (FIG. 24B). When the secondary winding current, Iₛ, equals the current in the inductive element 46, it begins time period C (FIG. 24C). After time period C is over, switch 14K is turned off at zero voltage. This causes the charging and discharging of the primary snubber capacitors 41H and 41K (FIG. 24D). When the snubber capacitors' voltages reach the dc voltage rails of V_{d2}, the current starts to conduct in the diode direction of switch 14H (FIG. 24E). During time period E switch 14H is turned on at zero voltage. After time period E is over, switches 16B and 16C are turned on at zero current to short-circuit the secondary winding 56. This results in an increase in the secondary winding current, Iₛ, to Iₓ (FIG. 24F). The secondary winding current, Iₛ, at the end of time period D (i.e. Iₓ in FIG. 23) should be greater than Iₗᵢₘ, which is the minimum current required to achieve the zero voltage switch transition of the primary switches 14I, 14L, and 14M in time period G. When the secondary winding current, Iₛ, equals Iₓ, switches 14G, 14J, and 14N are turned off at zero voltage. This causes the resonant charging and discharging of the primary snubber capacitors 41G, 41I, 41J, 41L, 41M, and 41N with the magnetizing current and stored leakage inductance energy of the high-frequency link 50 (FIG. 24G). When the snubber capacitors' voltages reach the dc voltage rails of V_{d1} and V_{d2}, the current starts to conduct in the diode direction of switches 14I, 14L, and 14M (FIG. 24H). During time periods G or H switch 16H is turned on at zero voltage, and switches 16A, 16D, and 16G are turned off at zero voltage. During time period H switches 14I, 14L, and 14M are turned on at zero voltage. When the secondary winding current, Iₛ, falls to zero, it begins time period A′ in which no current conducts in the secondary winding 56 (FIG. 24A′). FIGS. 24A′-H′ show the remainder of the commutation cycle, which is similar to FIGS. 24A-H, but the polarity of the primary winding voltage, Vₜ, and the secondary winding current, Iₛ, are both opposite. After time period H′ the cycle is reset starting with time period A.

If the secondary winding current, Iₛ, at the end of time periods E and E′ in FIG. 23 is sufficient to achieve the zero voltage switch transition in time periods G and G′, then the time periods F and F′ in FIG. 23 and the switch states in FIG. 24F and FIG. 24F′ can be eliminated. This type of transition is similar to the types illustrated in FIG. 11 or FIG. 18. In this type of transition the switches 16B and 16C are not turned on until after the primary winding voltage, Vₜ, is negative (also switches 16A and 16D are not turned on until Vₜ is positive), and the switches in the phase leg 32Q also transition after the polarity change of the primary winding 54. As an in-between option of this type of transition and the transitions in FIG. 23, the switches 16B and 16C can also be turned on as the primary winding voltage, Vₜ, decreases to zero (also switches 16A and 16D turned on as Vₜ increases to zero).

For the converter 11 illustrated in FIG. 21 through FIG. 24A-H′, the short-circuit time is the time between when the switches of the full-bridge circuit 77A are turned on and the switches of the phase legs 32F and 32H are turned off. Similar to the example embodiments described above, the short-circuit time can range from positive to negative values. By changing the short-circuit time in increments or continuously depending on load conditions, the quantity of energy absorbed by the clamp circuit is considerably decreased, and soft switching is possible under all load conditions (with no extra components or large magnetizing current).

In FIG. 21 through FIG. 24A-H′ V_{d1} is applied to the primary winding 54 for a longer duration than V_{d2}. Since the primary circuit 90 in FIG. 19 is symmetric, it is also possible to change the operation so that V_{d2} is applied to the primary winding 54 for a longer duration. If V_{d1} and V_{d2} are different, the change in operation adds an additional level to the converter. However, it is still only possible to apply three different voltage levels to the inductive element 46 between voltage polarity changes of the primary windings 54 (i.e. levels of 0, nₜV_{d1}, and nₜ(V_{d1}+V_{d2}) or levels of 0, nₜV_{d2}, and nₜ(V_{d1}+V_{d2})). If V_{d1} and V_{d2} are equal, it is also possible to alternate between V_{d1} and V_{d2} as the longer duration voltage. This type of commutation is illustrated for a different primary circuit 90 and secondary circuit 96 in FIG. 41 and FIG. 42A-J′. Since the primary circuit 90 in FIG. 19 utilizes two capacitive elements 42A and 42B that are connected to two independent sources, any of these type of commutations are possible. Other example primary circuits 90 that utilize split capacitors connected to a single source are described herein with respect to the primary circuit 90 in FIG. 19, and for these circuits the example commutation method that alternates between V_{d1} and V_{d2} as the middle level is assumed.

In FIG. 21 through FIG. 24A-H′ three voltage levels are applied to the current source 46, but in many applications it is desirable to only apply two of these voltage levels depending on converter conditions. To accomplish this appropriate time periods are eliminated, and the switch states are slightly modified. If it is desired to only utilize the levels 0 and nₜV_{d1}, the time periods F, G, F′, and G′ in FIG. 21 are eliminated, the time periods C, D, C′, and D′ in FIG. 23 are eliminated, switches 14H and 14J are continuously on, and switches 14K and 14M are continuously off. If it is desired to only utilize the levels nₜV_{d1} and nₜ(V_{d1}+V_{d2}), the time periods A and A′ in FIG. 21 and FIG. 23 are eliminated, switch 16G is continuously on, and switch 16H is continuously off.

In the illustrations in FIG. 22A-H′ and FIG. 24A-H′ and the above example commutation descriptions the current freewheels in the switches 14H and 14J when V_{d1} is applied to the primary winding 54. Alternatively, the current could freewheel in the top switches 14K and 14M. This alternative implementation should be assumed when describing the operation of other example primary circuits 90 that utilize split capacitors connected to a single source with respect to the primary circuit 90 in FIG. 19.

For the converter 11 in FIG. 14 through FIG. 18 the example commutation method controls the duration of voltage applied to the primary windings 54A and 54B. For the converter 11 in FIG. 21 through FIG. 24A-H′ the example commutation method controls the duration of voltage applied to the primary winding 54 and the duration of current applied to the secondary winding 56. If the secondary circuits of these two converters 11 are swapped, the example commutation method's controls will also be swapped.

Example Embodiments with Primary Side AC Sources

The three example embodiments in FIG. 1, FIG. 2, and FIG. 3 are illustrated for a single primary side dc source, but primary circuits 90 appropriate for ac sources can also be utilized. A dc primary circuit 90 can be changed to an ac one phase primary circuit 90 by replacing the primary circuit's switches with bi-directional switches. The bi-directional full-bridge circuit 71A illustrated in FIG. 25 is one example of a one phase ac primary circuit 90. In the bi-directional full-bridge circuit 71A the primary winding 54 is connected between two switch matrixes 21A and 21B that are connected to the capacitive element 42. Switch matrix 21A comprises bi-directional switches 4A-4A′ and 4B-4B′, and switch matrix 21B comprises bi-directional switches 4C-4C′ and 4D-4D′. The primary circuit 90 in FIG. 25 includes snubber capacitances 41A, 41B, 41C, and 41D across the bi-directional switches 4A-4A′, 4B-4B′, 4C-4C′, and 4D-4D′ respectively. If the bi-directional switches in a primary circuit 90 are implemented with two back-to-back switches, separate capacitive snubber elements across each switch can also be used. Alternatively, snubber capacitances can also be included across the primary winding or across both the bi-directional switches and primary winding.

In one phase ac primary circuits 90 the operation of the bi-directional switches depends on the polarity of V_{ac}. For the bi-directional full-bridge circuit 71A as an example, if V_{ac} is positive, the switches 4A, 4B, 4C, and 4D in FIG. 25 can operate the same as switches 14A, 14B, 14C, and 14D respectively in FIG. 4, and switches 4A′, 4B′, 4C′, and 4D′ in FIG. 25 can be continuously on. If V_{ac} is negative, the functions of switches 4A′, 4B′, 4C′, and 4D′ can be swapped with switches 4B, 4A, 4D, and 4C respectively in FIG. 25. The switches that are continuously on can initially be turned on at zero voltage when V_{ac} changes polarity, or when voltage is being blocked in the opposite direction by the other switch in each bi-directional switch.

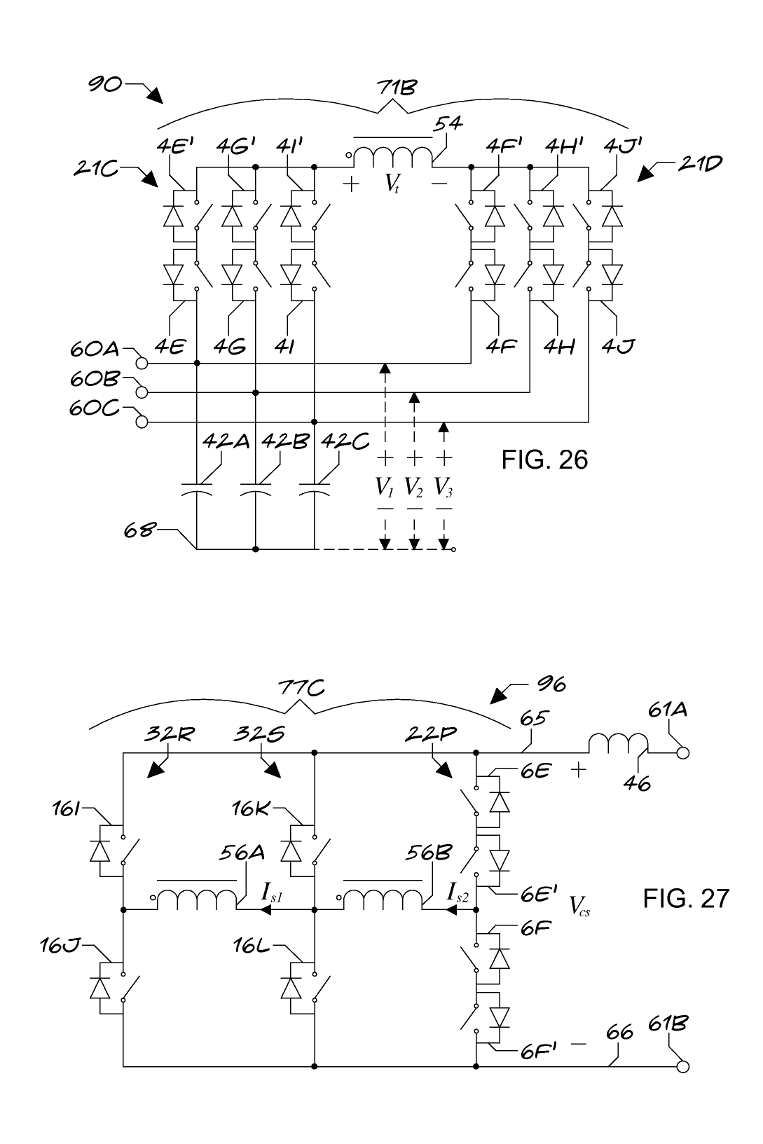

A one phase ac primary circuit 90 can be extended to multiple ac phases by adding extra bi-directional switches to each switch matrix. The bi-directional full-bridge circuit 71B illustrated in FIG. 26 is one example of this for three phases. In the example circuit 71B the primary winding 54 is connected between the switch matrixes 21C and 21D. A bi-directional switch in each switch matrix 21C and 21D is connected to the capacitive elements 42A, 42B, and 42C. Switch matrix 21C comprises bi-directional switches 4E-4E′, 4G-4G′, and 4I-4I′, and switch matrix 21D comprises bi-directional switches 4F-4F′, 4H-4H′, and 4J-4J′. No snubber capacitances are shown in FIG. 26, but they can be included across each bi-directional switch, across the primary winding, or across both the bi-directional switches and the primary winding. The number of phases can be further increased by adding extra bi-directional switches to each switch matrix 21C and 21D. Each extra bi-directional switch is connected between the primary winding 54 and the capacitive element of one of the additional phases.

FIG. 27 illustrates an example secondary circuit 96 appropriate for the example embodiment in FIG. 1. This secondary circuit 96 comprises a mixed leg circuit 77C connected to an inductive element 46. The mixed leg circuit 77C comprises the secondary winding 56A connected between phase legs 32R and 32S, and the secondary winding 56B connected between the phase leg 32S and a bi-directional phase leg 22P.

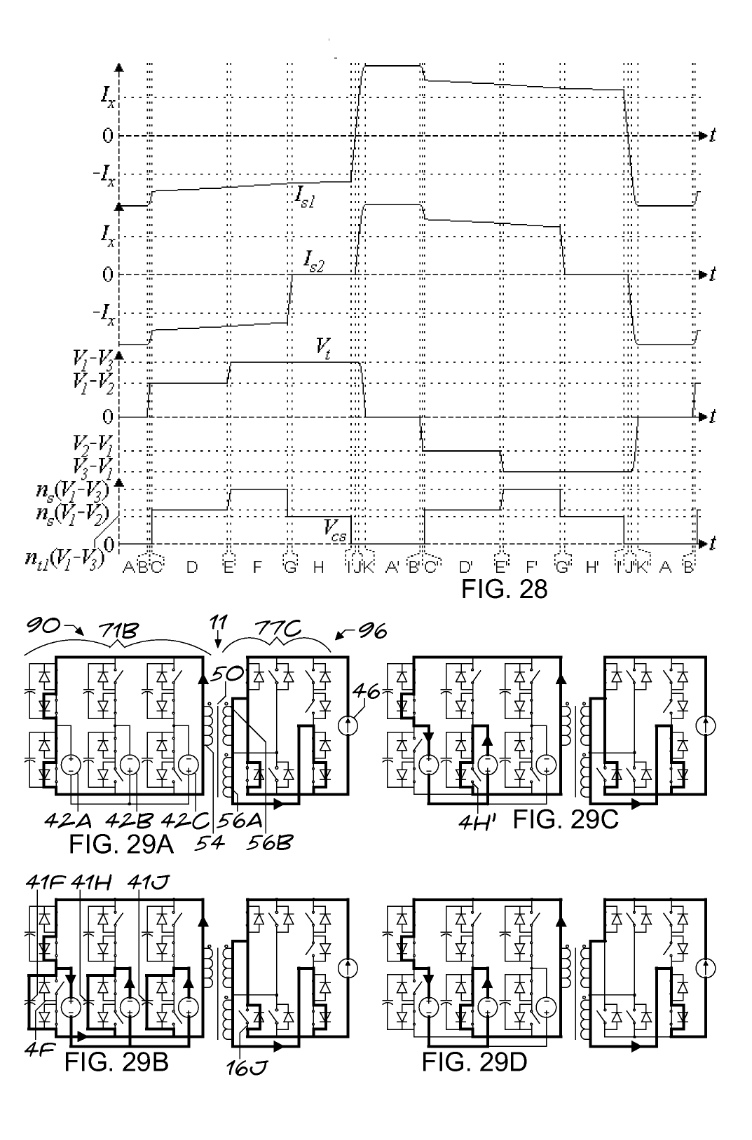

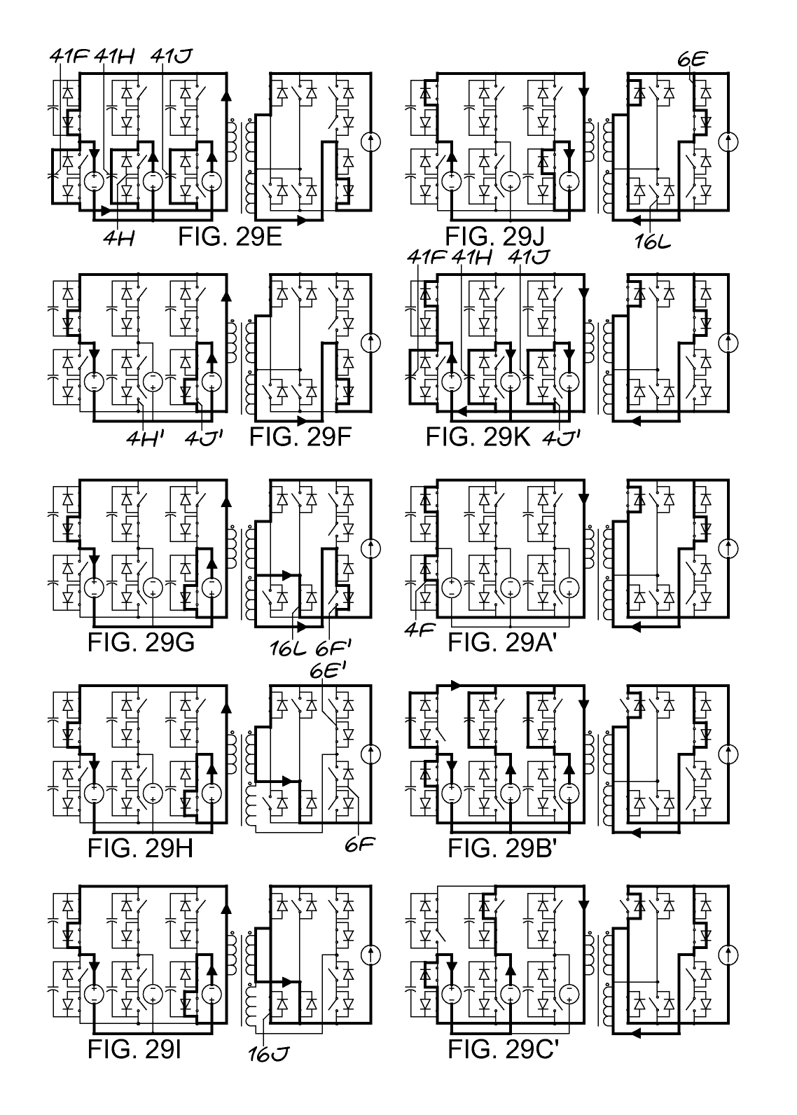

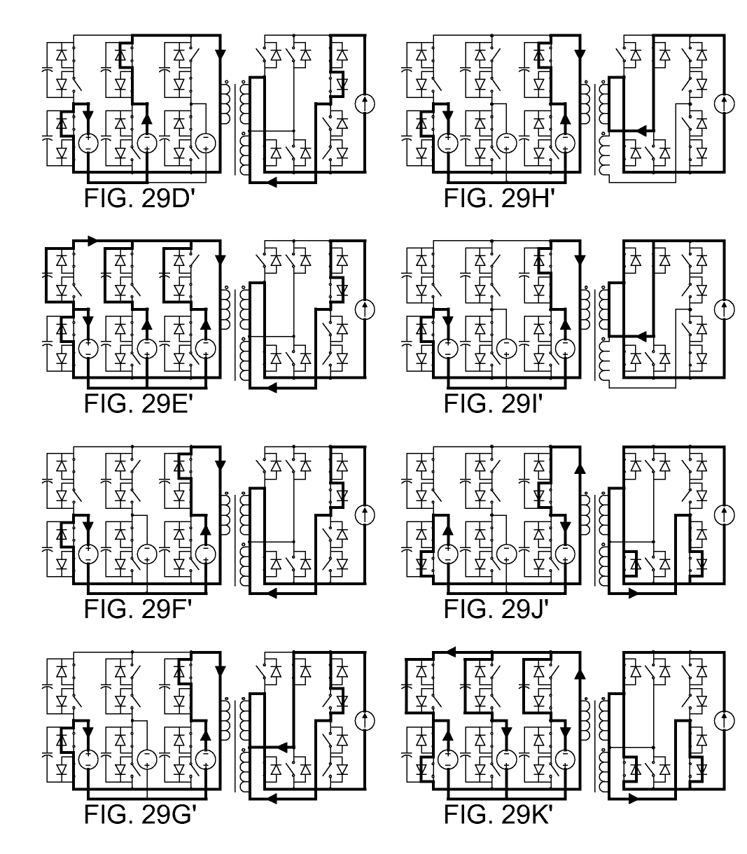

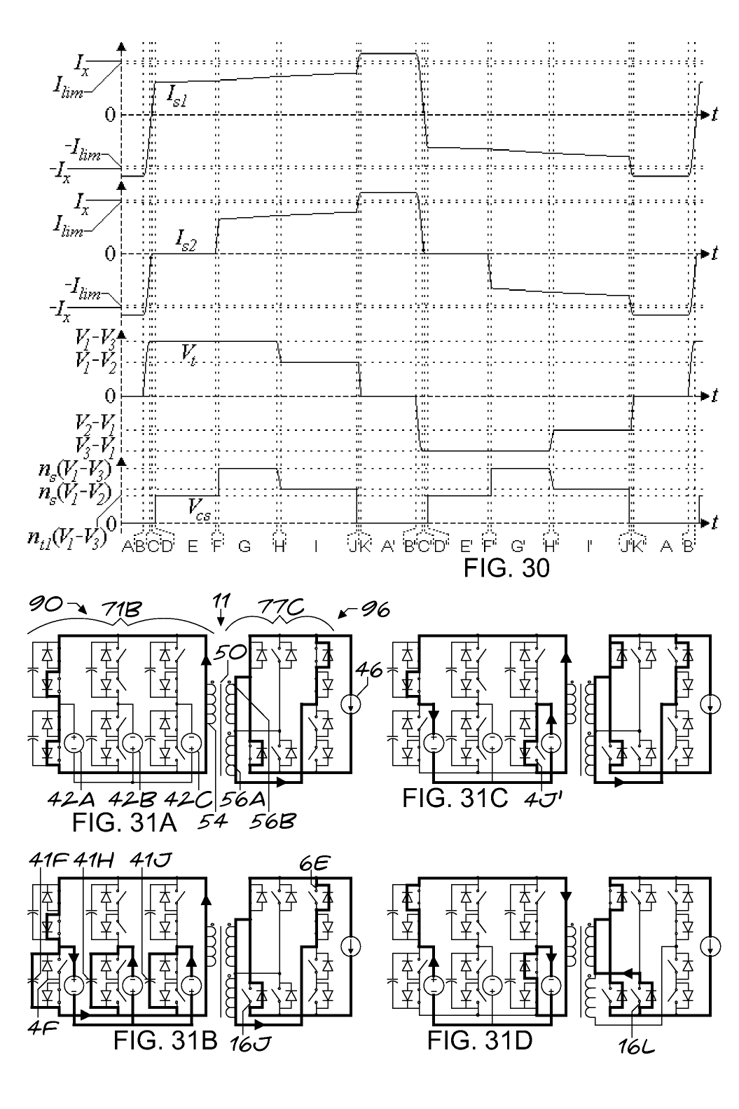

Combining the primary circuit 90 in FIG. 26 and the secondary circuit 96 in FIG. 27 is similar to the example converter 11 illustrated in FIG. 1, but with three ac sources connected to the primary side. The example commutation method for this converter 11 controls the duration voltage is applied to the primary winding 54, and the duration current is applied to the secondary winding 56B. Examples of this commutation method are illustrated in FIG. 28 through FIG. 31A-K′. The turns ratio nₛ in FIG. 28 and FIG. 30 is the sum of nₜ₁ and nₜ₂ (i.e. nₛ=nₜ₁+nₜ₂). While the multiple ac sources complicate the commutation of the primary circuit 90, an example commutation method for the secondary circuit 96 in FIG. 27 could be the same as with a dc primary circuit 90, such as in FIG. 4. An example of commutating this converter 11 for power transfer from the secondary circuit 96 is illustrated with the voltage and current waveforms in FIG. 28 and the commutation circuit diagrams in FIGS. 29A-K′. In all the example voltage and current waveforms, the example commutation circuit diagrams, and the descriptions herein that utilize the three primary capacitive elements 42A, 42B, and 42C, it is assumed that V₁>V₂>V₃, |V₁|>|V₃|, and V₂<0. Those with ordinary skill in the art will see how the commutation and control will be changed for different voltage conditions than these.

After time period A in FIG. 28 (the switch state in FIG. 29A) switch 4F is turned off at zero voltage. This causes the resonant charging and discharging of the primary snubber capacitors 41F, 41H, and 41J with the magnetizing current and stored leakage inductance energy of the high-frequency link 50 (FIG. 29B). During time period B switch 16J is turned off at zero voltage. When the snubber capacitors' voltages reach the ac voltage rail of V₂, the current starts to conduct in the diode direction of switch 4H′ (FIG. 29C). During time period C switch 4H′ is turned on at zero voltage. When the secondary winding currents, Iₛ₁ and Iₛ₂, equal the current in the inductive element 46, it begins time period D (FIG. 29D). After time period D is over, switch 4H is turned off at zero voltage. This causes the charging and discharging of the primary snubber capacitors 41F, 41H, and 41J (FIG. 29E). When the snubber capacitors' voltages reach the ac voltage rail of V₃, the current starts to conduct in the diode direction of switch 4J′ (FIG. 29F). During time period F switch 4J′ is turned on at zero voltage, and switch 4H′ is turned off at zero voltage. After time period F is over, switch 6F′ is turned off at zero voltage and switch 16L is then turned on at zero current (switch 16L on then switch 6F′ off also valid). This results in the secondary winding current, Iₛ₂, increasing until it is equal to zero (FIG. 29G). When the secondary winding current, Iₛ₂, equals zero, it begins time period H (FIG. 29H). During time period H switch 6E′ is turned on at zero voltage, and switch 6F′ is turned off at zero voltage. After time period H is over, switch 16J is turned on at zero current to short-circuit the secondary winding 56A. This results in an increase in the secondary winding current, Iₛ₁, to zero (FIG. 29I). When the secondary winding current, Iₛ₁, equals zero, switch 6E is turned on at zero current to short-circuit the secondary windings 56A and 56B. This results in an increase in the secondary winding currents, Iₛ₁ and Iₛ₂, to Iₓ (FIG. 29J). During time period J switch 16L is turned off at zero voltage or zero current. When the secondary winding currents, Iₛ₁, and Iₛ₂, equal Iₓ, switch 4J′ is turned off at zero voltage. This causes the resonant charging and discharging of the primary snubber capacitors 41F, 41H, and 41J until the primary winding voltage, Vₜ, equals zero (FIG. 29K). When the primary winding voltage, Vₜ, equals zero, time period A′ starts and current starts to conduct in the diode direction of switch 4F (FIG. 29A′). During time period A′ switch 4F is turned on at zero voltage. During time periods A′ through the next time period A switch 4H is turned on at zero voltage. FIGS. 29A′-K′ show the remainder of the commutation cycle, which is similar to FIGS. 29A-K, but the polarity of the primary winding voltage, Vₜ, and the secondary winding currents, Iₛ₁, and Iₛ₂, are all opposite. After time period K′ the cycle is reset starting with time period A.

In FIG. 28 the secondary winding currents, Iₛ₁ and Iₛ₂, at the end of time period J (i.e. Iₓ in FIG. 28) are greater than the magnitude of current in the inductive element 46, and the snubber capacitors' voltages reach the ac voltage rails before the secondary winding currents, Iₛ₁ and Iₛ₂, reach the current in the inductive element 46. Similar to FIG. 7 and FIG. 14, it is also possible for the secondary winding currents, Iₛ₁ and Iₛ₂, to reach the current in the inductive element 46 first. In either scenario the secondary winding currents, Iₛ₁ and Iₛ₂, with respect to the positive voltage of the windings (i.e. sgn(Vₜ)*Iₛ₁ and sgn(Vₜ)*Iₛ₂) are less than the negative current of the inductive element 46 when switch 16J or switch 16I is turned off. This results in current conducting in the diode direction of the secondary circuit switch that is being turned off (see FIG. 29B or FIG. 29B′ as examples), and the secondary circuit's clamp circuit 99 (or the secondary circuit 96 itself) absorbs a minimal amount of energy. If the secondary winding currents, Iₛ₁ and Iₛ₂, with respect to the positive voltage of the windings are greater than the negative current of the inductive element 46 when switch 16J or switch 16I is turned off, the difference in current between each secondary winding 56A and 56B and the inductive element 46 is absorbed by the clamp circuit 99 (or the secondary circuit 96 itself). However, the short-circuit time (time periods I through J and I′ through J′ in FIG. 28) is still beneficial in that it decreases the differences in current, and thus the energy absorbed by the clamp circuit 99 (or the secondary circuit 96 itself).

This example commutation method can also be modified similar to the example embodiments described above. The commutation method can be modified to utilize the inherent capacitance across the secondary circuit's switches and bi-directional switches to reduce the energy absorbed by the clamp circuit 99 (or the secondary circuit 96 itself). The example commutation method can also be modified to account for the conduction loss during the freewheeling time periods A and A′, similar to the description given for the example embodiment in FIG. 14 through FIG. 18.

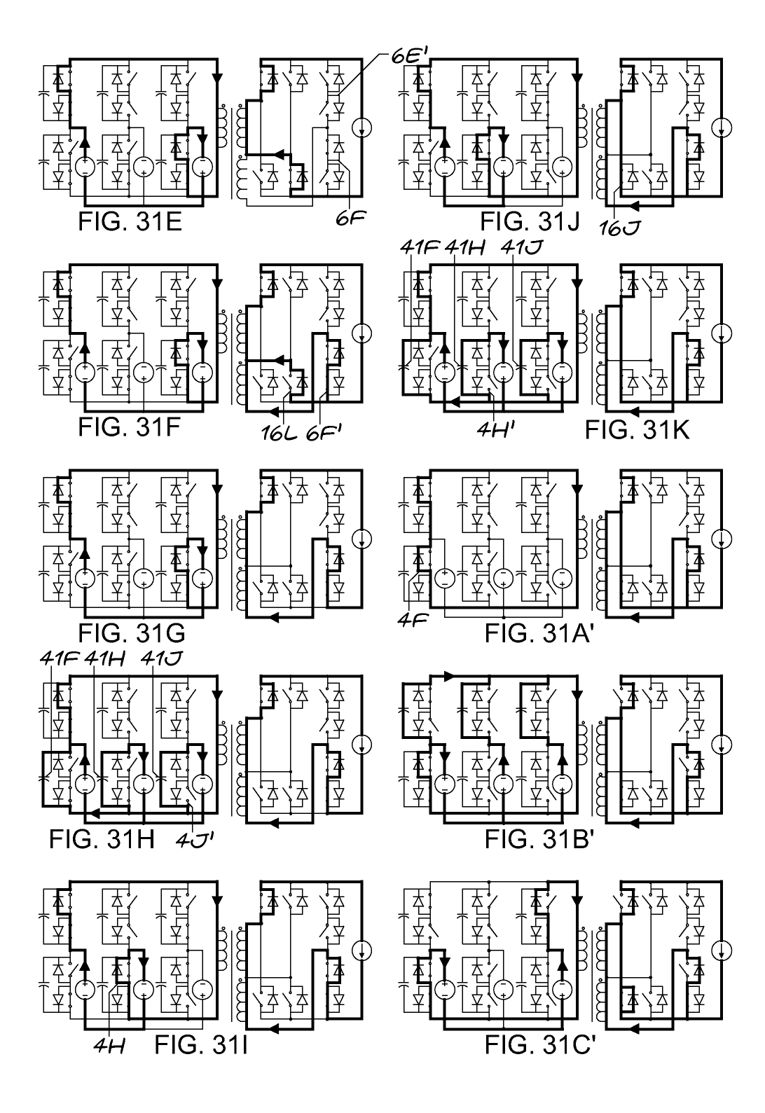

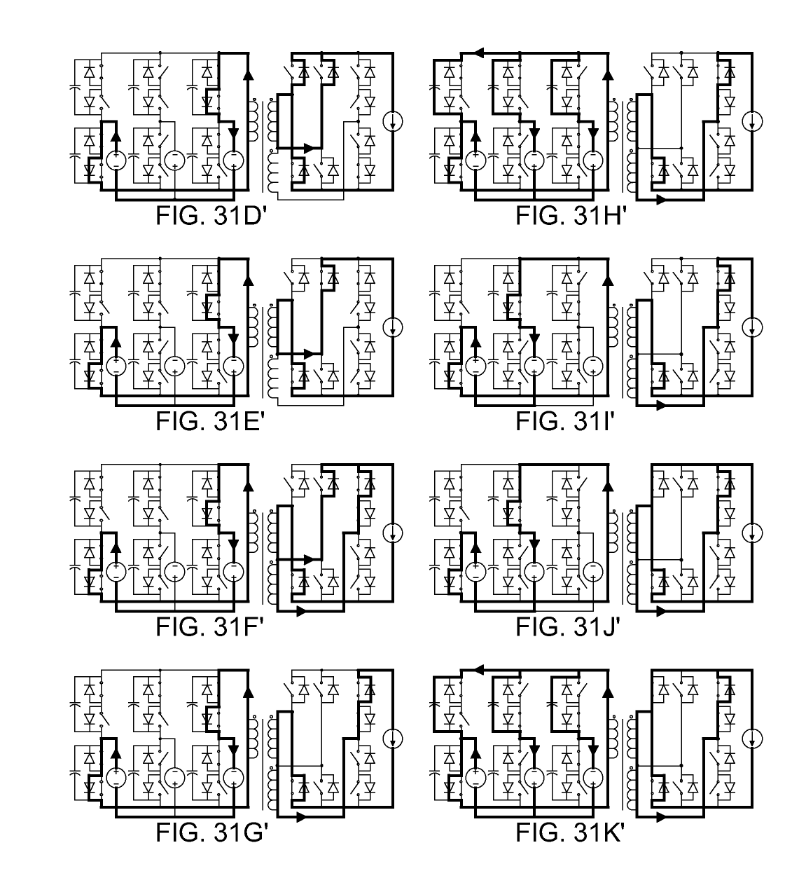

The commutation method utilizing the short-circuiting of the secondary windings 56A and 56B is also applicable for power transfer to the secondary circuit 96 under low load conditions. An example of commutating the same converter 11 for power transfer to the secondary circuit 96 is illustrated with the voltage and current waveforms in FIG. 30 and the commutation circuit diagrams in FIGS. 31A-K′.

After time period A in FIG. 30 (the switch state in FIG. 31A) switch 4F is turned off at zero voltage. This causes the resonant charging and discharging of the primary snubber capacitors 41F, 41H, and 41J with the magnetizing current and stored leakage inductance energy of the high-frequency link 50 (FIG. 31B). During time period B switches 6E and 16J are turned off at zero voltage. When the snubber capacitors' voltages reach the ac voltage rail of V₃, the current starts to conduct in the diode direction of switch 4J′ (FIG. 31C). During time period C switch 4J′ is turned on at zero voltage. Time period C continues until the secondary winding current, Iₛ₁, changes polarity, and the secondary winding current, Iₛ₂, decreases to zero, which starts time period D. During time period D current starts to conduct in the diode direction of switch 16L, and switch 16L is turned on at zero voltage (FIG. 31D). When the secondary winding current, Iₛ₁, equals the current in the inductive element 46 it begins time period E (FIG. 31E). During time period E switch 6F is turned on at zero voltage, and switch 6E′ is turned off at zero voltage. After time period E is over, switch 16L is turned off at zero voltage and switch 6F′ is then turned on at zero current (switch 6F′ on then switch 16L off also valid). This results in the secondary winding current, Iₛ₂, increasing until it is equal to the current in the inductive element 46 (FIG. 31F). When the secondary winding current, Iₛ₂, equals the current in the inductive element 46, it begins time period G (FIG. 31G). During time periods C through G switch 4H′ is turned on at zero voltage. After time period G is over, switch 4J′ is turned off at zero voltage. This causes the charging and discharging of the primary snubber capacitors 41F, 41H, and 41J (FIG. 31H). When the snubber capacitors' voltages reach the ac voltage rail of V₂, the current starts to conduct in the diode direction of switch 4H (FIG. 31I). During time period I switch 4H is turned on at zero voltage. After time period I is over, switch 16J is turned on at zero current to short-circuit the secondary windings 56A and 56B. This results in an increase in the secondary winding currents, Iₛ₁ and Iₛ₂, to Iₓ (FIG. 31J). The secondary winding currents, Iₛ₁ and Iₛ₂, at the end of time period J (i.e. Iₓ in FIG. 30) should be greater than Iₗᵢₘ, which is the minimum current required to achieve the zero voltage switch transition of the primary switch 4I′ in time period B′. When the secondary winding currents, Iₛ₁ and Iₛ₂, equal Iₓ, switch 4H′ is turned off at zero voltage. This causes the resonant charging and discharging of the primary snubber capacitors 41F, 41H, and 41J until the primary winding voltage, Vₜ, equals zero (FIG. 31K). When the primary winding voltage, Vₜ, equals zero, time period A′ starts and current starts to conduct in the diode direction of switch 4F (FIG. 31A′). During time period A′ switch 4F is turned on at zero voltage. During time periods A′ through the next time period A switch 4H is turned off at zero voltage. FIGS. 31A′-K′ show the remainder of the commutation cycle, which is similar to FIGS. 31A-K, but the polarity of the primary winding voltage, Vₜ, and the secondary winding currents, Iₛ₁ and Iₛ₂, are all opposite. After time period K′ the cycle is reset starting with time period A.

If the secondary winding currents, Iₛ₁ and Iₛ₂, at the end of time periods I and I′ in FIG. 30 are sufficient to achieve the zero voltage switch transition in time periods B′ and B, then the time periods J and J′ in FIG. 30 and the switch states in FIG. 31J and FIG. 31J′ can be eliminated. This type of transition is similar to the types illustrated in FIG. 11 or FIG. 18. In this type of transition the switch 16J or switch 16I is not turned on until after the primary winding voltage, Vₜ, is zero. As an in-between option of this type of transition and the transitions in FIG. 30, the switch 16J can also be turned on as the primary winding voltage, Vₜ, decreases to zero (also switch 16I turned on as Vₜ increases to zero).

For the converter 11 illustrated in FIG. 28 through FIGS. 31A-K′, the short-circuit time is the time between when a switch of phase leg 32R is turned on and a switch in circuit 71B is turned off that results in the primary winding voltage, Vₜ, transitioning to zero. Similar to the example embodiments described above, the short-circuit time can range from positive to negative values. By changing the short-circuit time in increments or continuously depending on load conditions and ac voltage levels, the quantity of energy absorbed by the clamp circuit is considerably decreased, and soft switching is possible under all load conditions (with no extra components or large magnetizing current).

In the examples in FIG. 28 through FIGS. 31A-K′ the switches 4E′, 4F′, 4I, and 4J are on at all times since V₁ and V₃ are the most positive and most negative voltages respectively. The switches 4E′, 4F′, 4I, and 4J can initially be turned on at zero voltage when voltage is being blocked in the opposite direction by the other switch in each bi-directional switch, or they can be kept on when the voltage across the capacitive element transitions from being the middle voltage to the most positive or negative voltage.

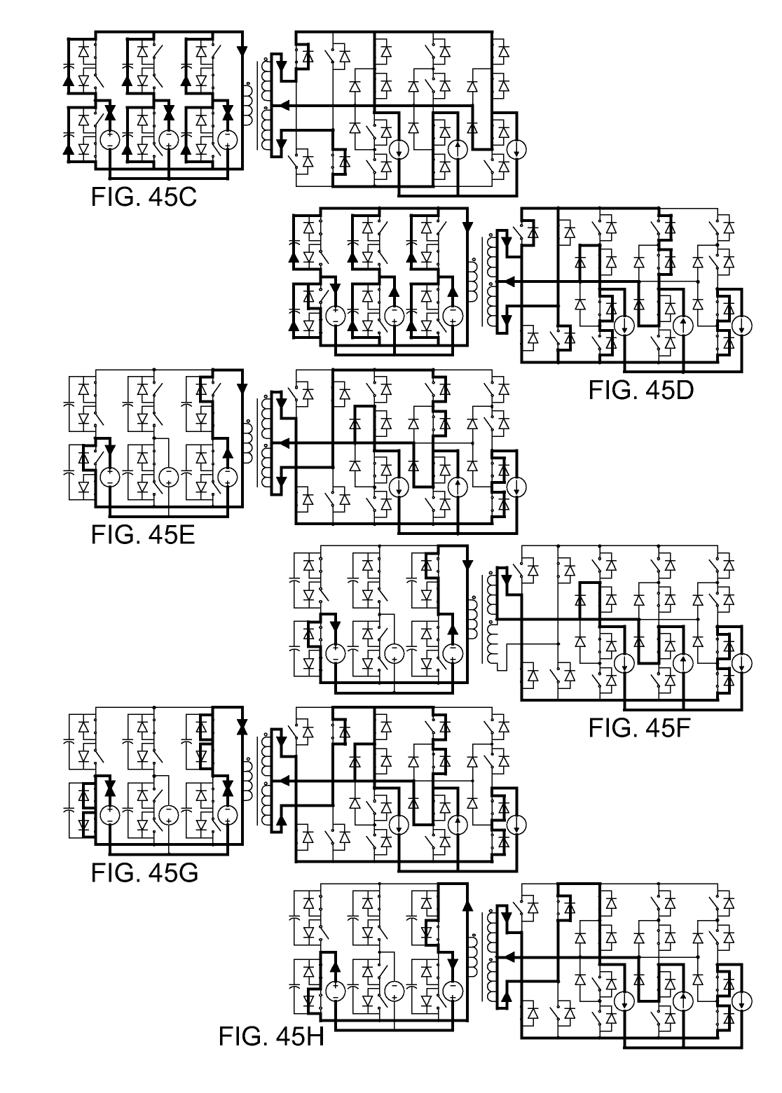

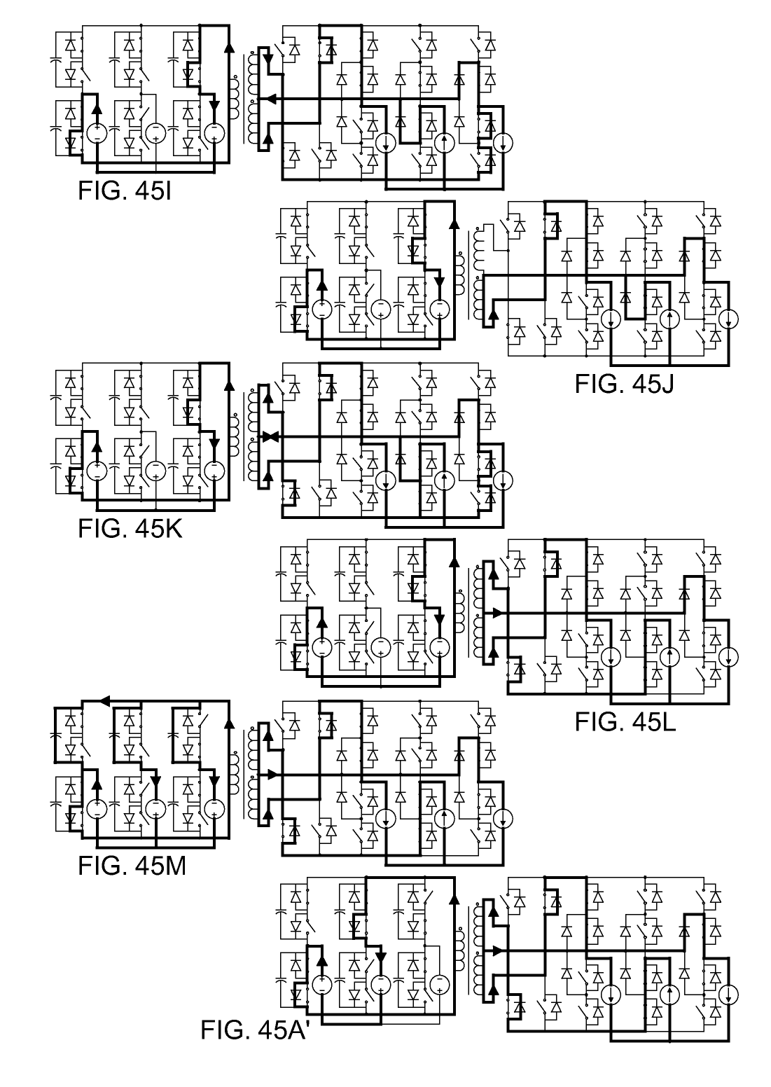

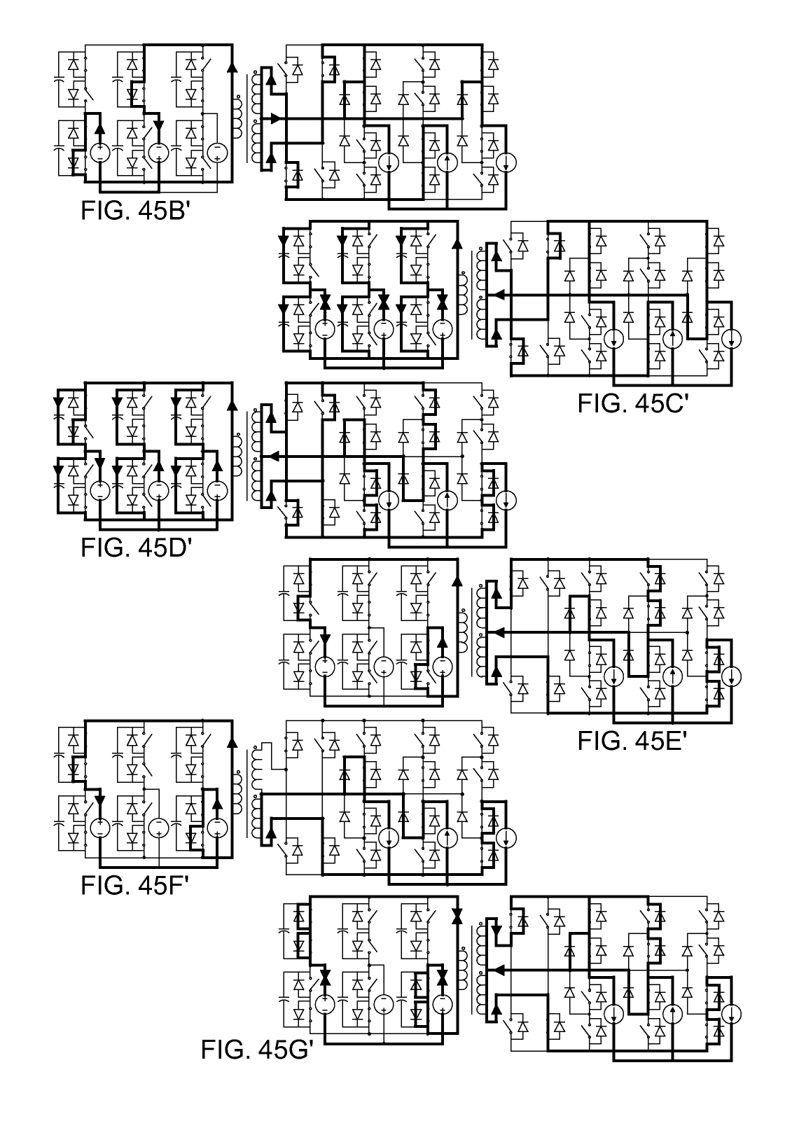

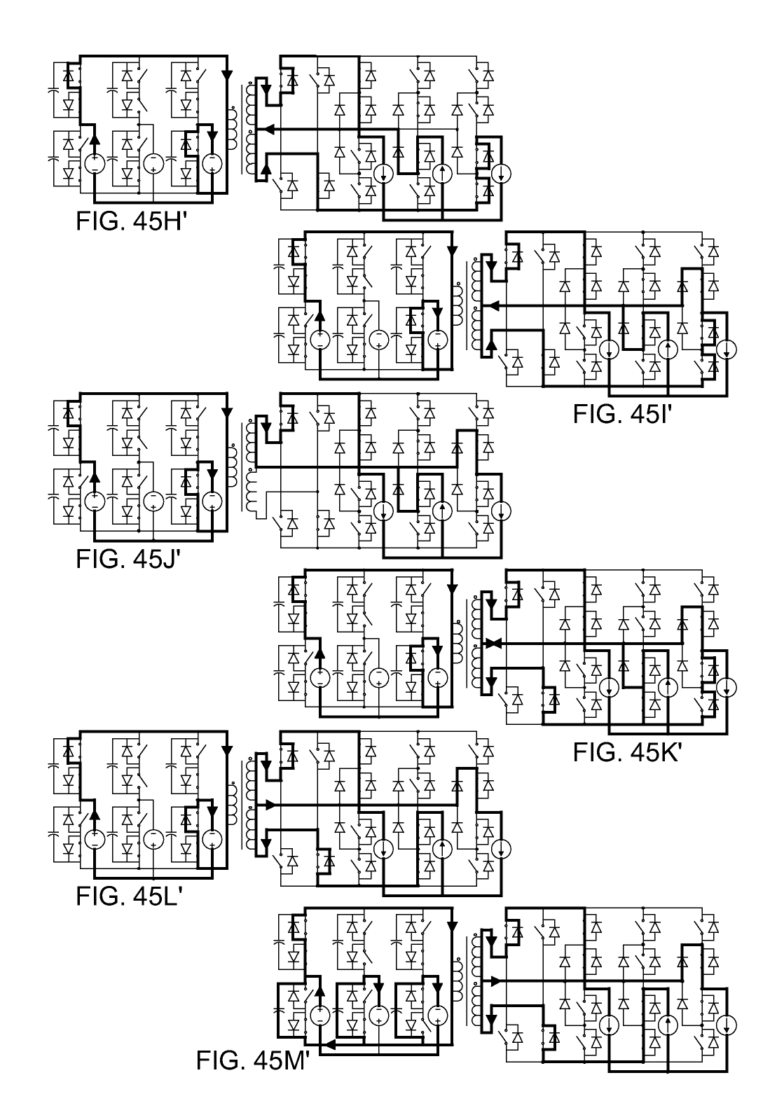

In FIG. 28 through FIGS. 31A-K′ three voltage levels of Vₜ are applied to the current source 46, but in many applications it is desirable to only apply two of these voltage levels depending on converter conditions. To accomplish this appropriate time periods are eliminated, and the switch states are slightly modified. If it is desired to only utilize the levels 0 and nₜ₁Vₜ, the time periods D, E, F, D′, E′, and F′ in FIG. 28 are eliminated, and the time periods G, H, I, G′, H′, and I′ in FIG. 30 are eliminated. It should be noted that eliminating these time periods is related to the secondary circuit, and the primary circuit switch transitions in these time periods will still occur, but instead at a level of nₜ₁Vₜ applied to the current source 46. If it is desired to only utilize the levels nₜ₁Vₜ and (nₜ₁+nₜ₂)Vₜ, the time periods A and A′ in FIG. 28 or FIG. 30 are eliminated. Due to the elimination of time periods A and A′, the switch transitions of the switch matrixes 21C and 21D can occur at the same time (i.e. similar to the commutation of the circuit 71B in FIGS. 45A-M′).

The secondary winding currents, Iₛ₁ and Iₛ₂, for the mixed leg circuit 77C in FIG. 27 may not be equal during the voltage polarity transitions of the primary winding 54. If the secondary winding currents, Iₛ₁ and Iₛ₂, are not equal, the waveforms and the current paths in the circuit diagrams will be slightly different, but the operation of the mixed leg circuit 77C is still basically the same.

Another Example Embodiment with Two Independently Controlled Secondary Windings

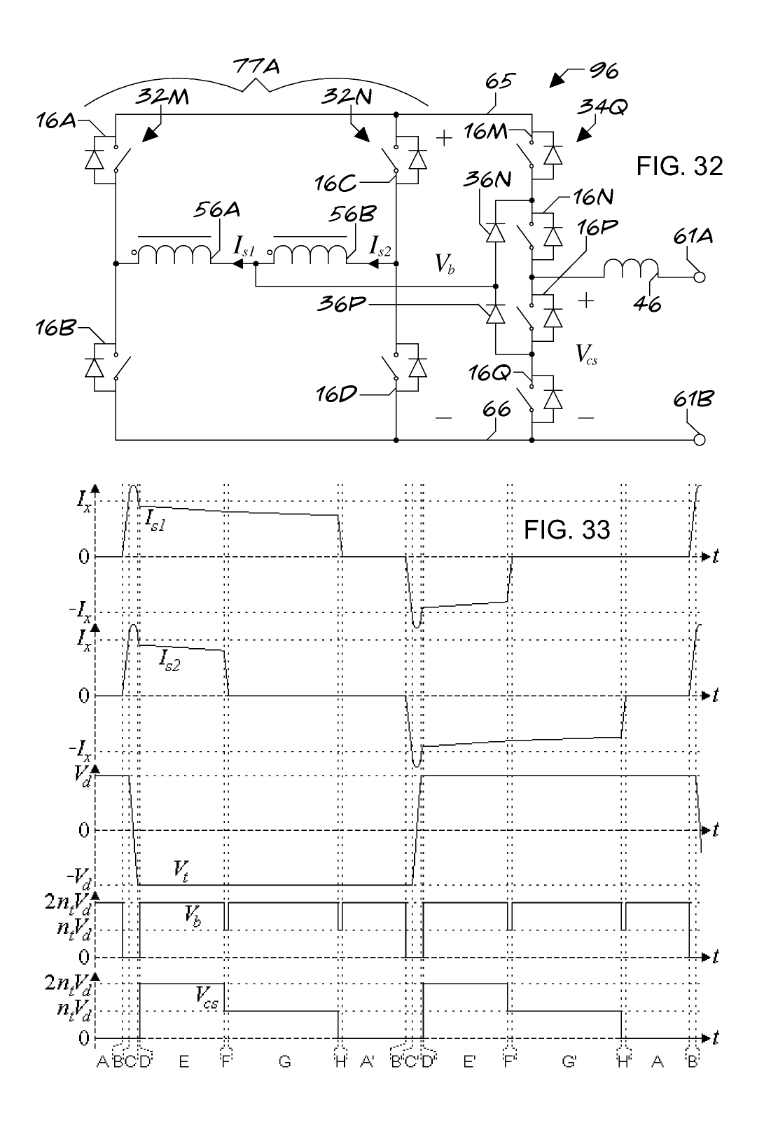

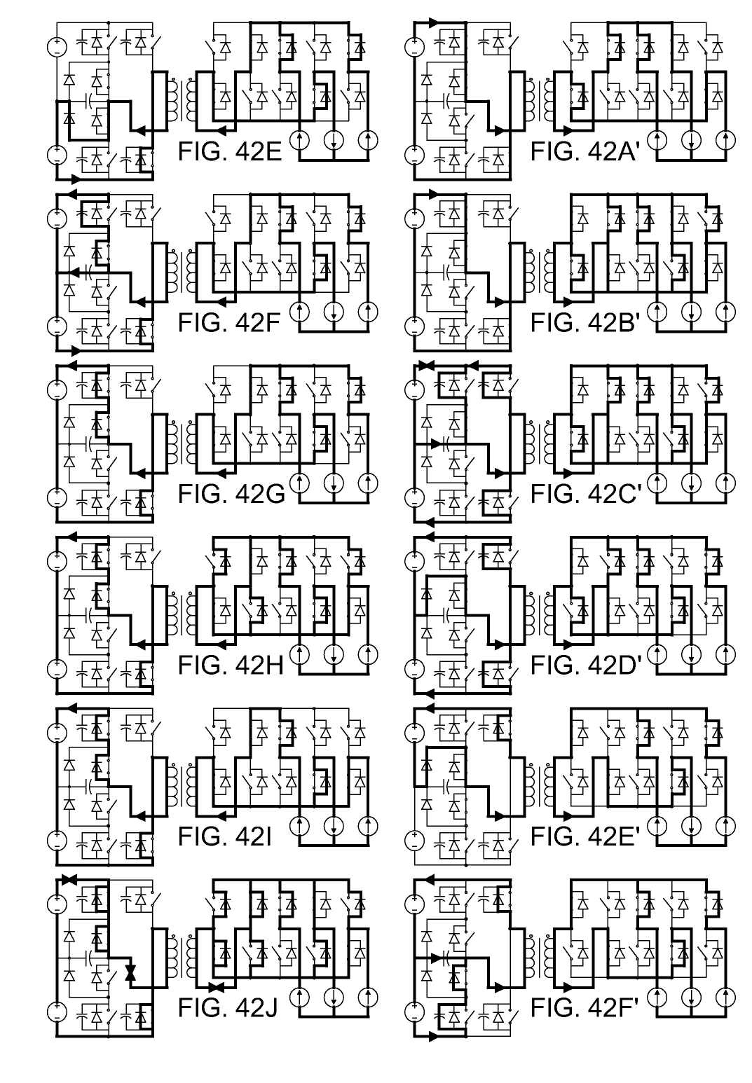

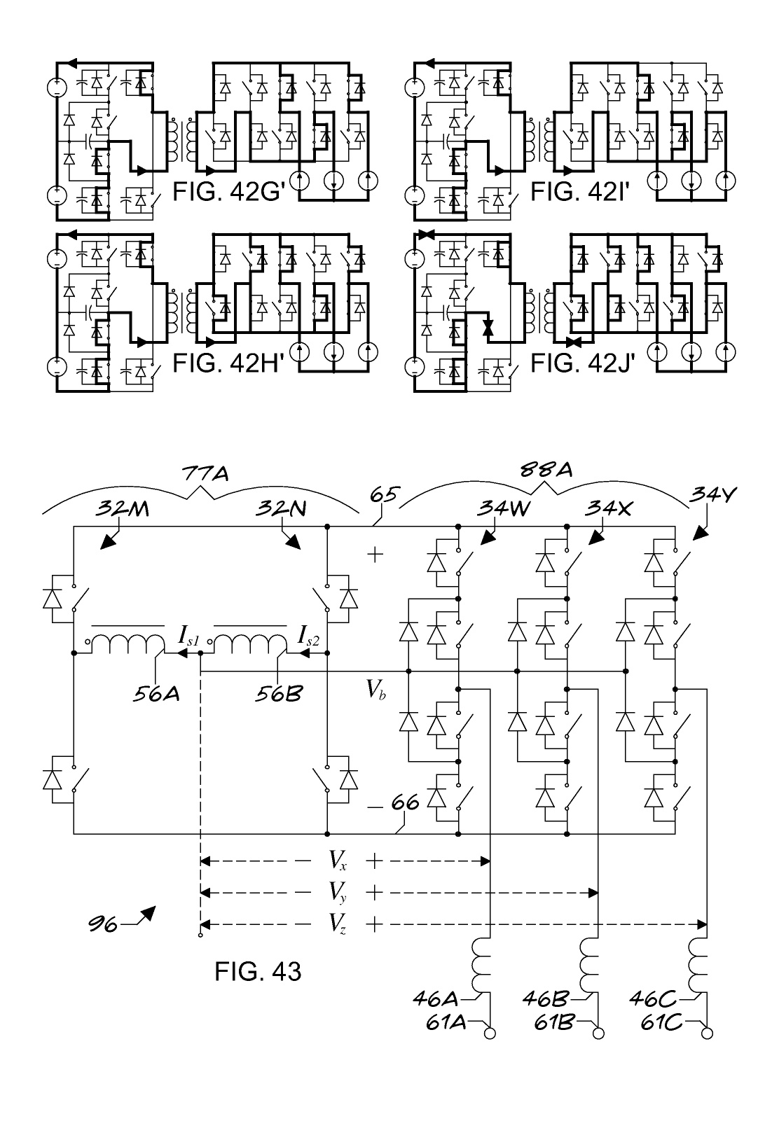

FIG. 32 illustrates an example secondary circuit 96 appropriate for the example embodiments in FIG. 1. This secondary circuit 96 is similar to the secondary circuit 96 in FIG. 20, except that the phase leg 32Q is replaced with a multilevel phase leg 34Q that is also connected to the secondary windings 56A and 56B. The multilevel phase legs described herein comprise at least three blocking elements connected in series and oriented to block current in the same direction (switches 16M, 16N, 16P, and 16Q in multilevel phase 34Q as an example). For the secondary circuit 96 in FIG. 32 (also FIG. 38 and FIG. 43) a diode is also connected between each interconnection of two blocking elements that is not connected to an inductive element and the interconnection of the secondary winding 56A and 56B (diodes 36N and 36P in multilevel phase leg 34Q as an example).

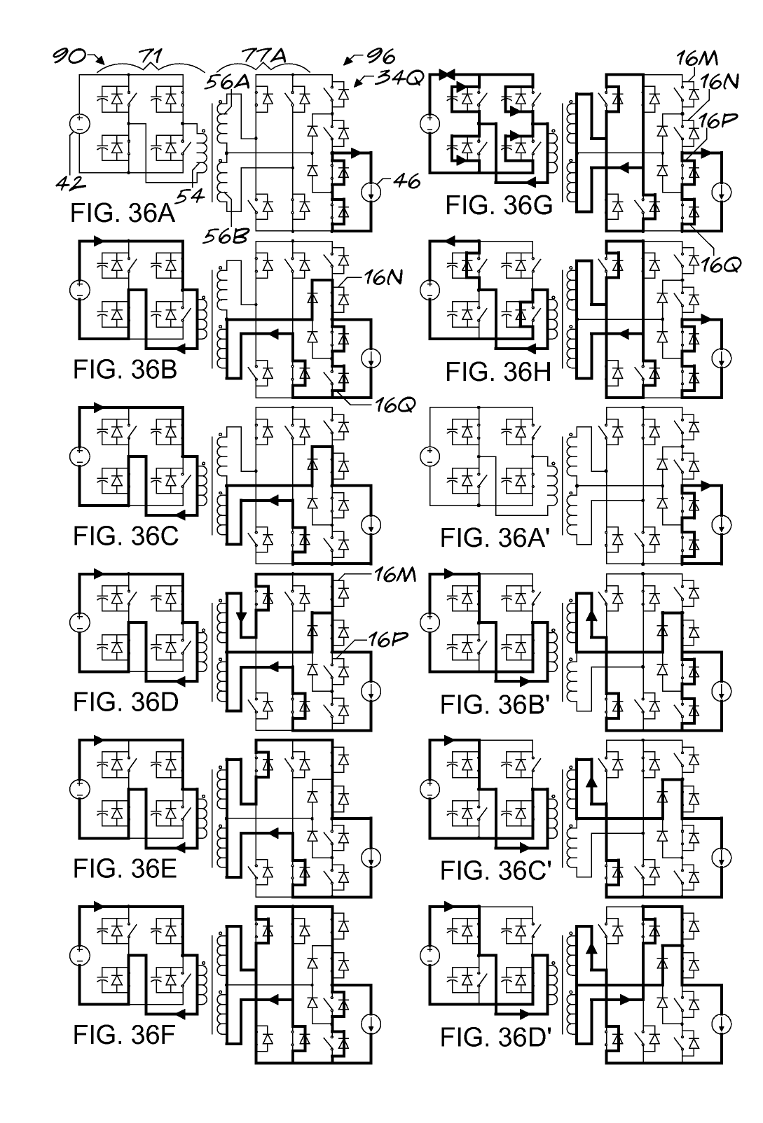

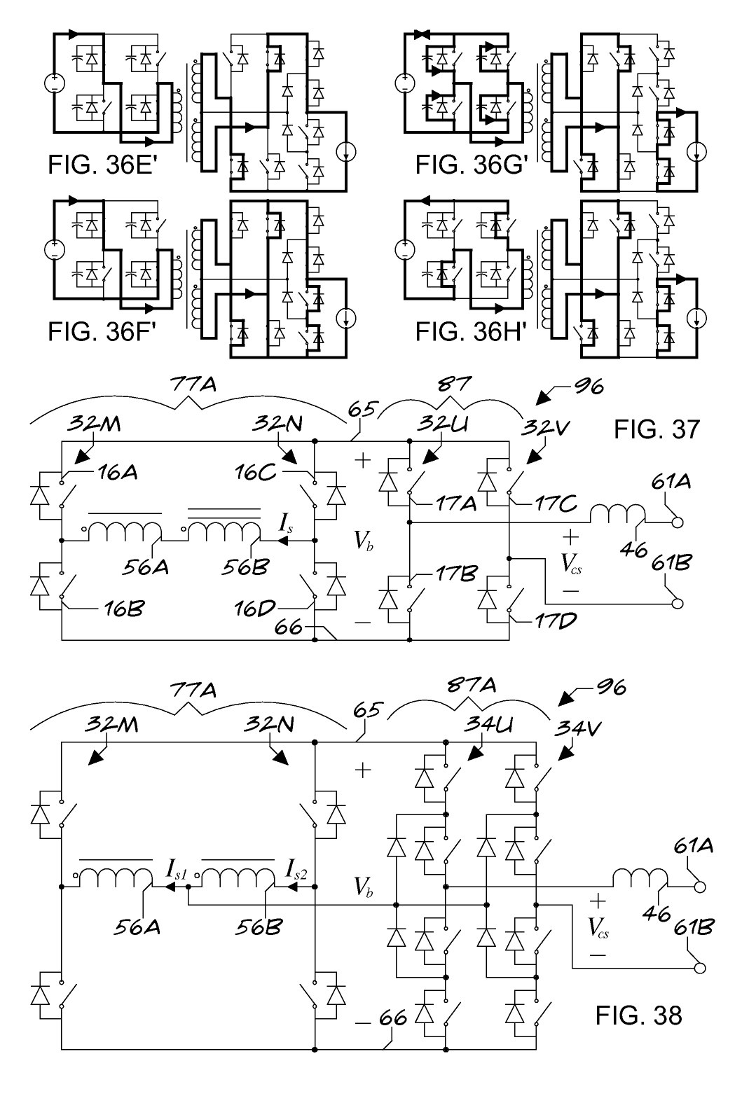

Combining the primary circuit 90 in FIG. 4 and the secondary circuit 96 in FIG. 32 is another example of the converter 11 illustrated in FIG. 1. The example commutation method for this converter 11 controls the duration current is applied to the secondary windings 56A and 56B. Examples of this commutation method are illustrated in FIG. 33 through FIGS. 36A-H′. In FIG. 33 and FIG. 35 the turns ratios, nₜ₁ and nₜ₂, of secondary windings 56A and 56B are both equal to nₜ. Unlike the example commutation methods in FIG. 7 through FIG. 11, this example commutation method alternates between the secondary windings 56A and 56B as the winding that has current applied to it for a longer duration. This results in the secondary windings 56A and 56B having more evenly distributed loss, but typically will result in the turns ratios nₜ₁ and nₜ₂ needing to be equal. An example of commutating this converter 11 for power transfer from the secondary circuit 96 is illustrated with the voltage and current waveforms in FIG. 33 and the commutation circuit diagrams in FIGS. 34A-H′, and an example for the reverse power direction are illustrated in FIG. 34 and FIGS. 36A-H′.

In FIG. 33 through FIGS. 36A-H′ the polarity transitions of the primary winding 54 are similar to that for the secondary circuit 96 in FIG. 20 due to both circuits utilizing the full-bridge circuit 77A. A minor difference for the secondary circuit 96 is that four switches in the multilevel phase leg 34Q change states (see FIG. 34C, FIG. 34C′, FIG. 36G, and FIG. 36G′) as opposed to the two switches in the phase leg 32Q. Between the polarity transitions of the primary winding 54 the multilevel phase leg 34Q changes switch states twice. One of the changes swaps the states of switches 16M and 16P (see FIG. 34F, FIG. 34F′, FIG. 36D, and FIG. 36D′), and the other swaps the states of switches 16N and 16Q (see FIG. 34H, FIG. 34H′, FIG. 36B, and FIG. 36B′). This example commutation method can also be modified similar to the example embodiments described above (i.e. utilizing the inherent capacitance across the secondary circuit's switches as an example).

For the converter 11 illustrated in FIG. 33 through FIGS. 36A-H′, the short-circuit time is the time between when the switches of the full-bridge circuit 77A are turned on and the switches of the full-bridge circuit 71 are turned off. Similar to the example embodiments described above, the short-circuit time can range from positive (FIG. 33 and FIG. 35 as examples) to negative values (i.e. Vₜ is transitioning to change polarity or has already changed polarity). By changing the short-circuit time in increments or continuously depending on load conditions, the quantity of energy absorbed by the clamp circuit is considerably decreased, and soft switching is possible under all load conditions (with no extra components or large magnetizing current).

In FIG. 33 through FIG. 36A-H′ three voltage levels are applied to the current source 46, but in many applications it is desirable to only apply two of these voltage levels depending on converter conditions. To accomplish this appropriate time periods are eliminated, and the switch states are modified. If it is desired to only utilize the levels 0 and nₜV_{d} (with nₜ=nₜ₁=nₜ₂), the time periods E and E′ in FIG. 33 or FIG. 35 are eliminated, switch 16P is continuously on, and for FIG. 33 switch 16M is continuously off. If it is desired to only utilize the levels nₜV_{d} and 2nₜV_{d}, the time periods A and A′ in FIG. 33 and FIG. 35 are eliminated, switch 16N is continuously on, and for FIG. 35 switch 16Q is continuously off. When only two levels are applied to the current source 46, the short-circuit time is started by turning on a switch in the multilevel phase leg 34Q and short-circuiting only one of the secondary windings 56A or 56B.

When applying only two voltage levels, the secondary winding currents, Iₛ₁ and Iₛ₂, for the secondary circuit 96 in FIG. 32 may not be equal during the voltage polarity transitions of the primary winding 54. If the secondary winding currents, Iₛ₁ and Iₛ₂, are not equal, the waveforms and the current paths in the circuit diagrams will be slightly different, but the operation of the example secondary circuit 96 in FIG. 32 is still basically the same.

Example Embodiments with Secondary Side AC Sources

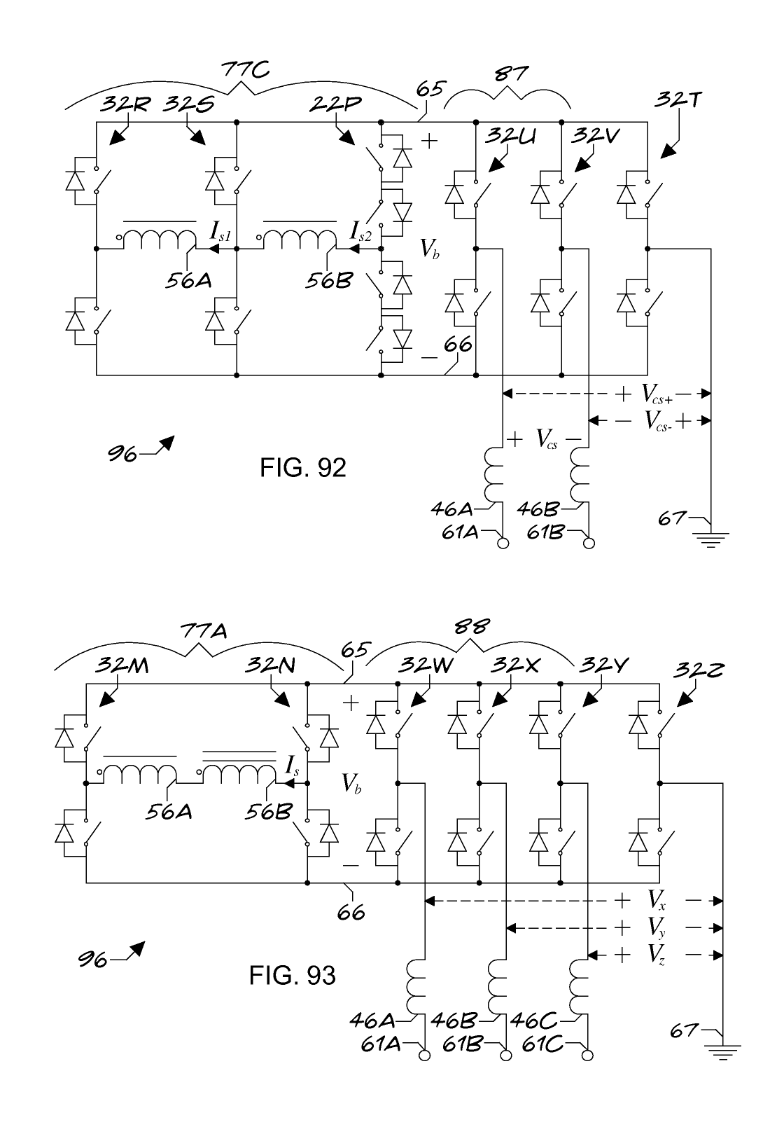

When utilized with a primary circuit 90 that generates the multiple voltage levels (primary circuits 96 appropriate for FIG. 2 and FIG. 3 as examples), adding a phase leg to the secondary circuit 96 in FIG. 10 creates a one phase ac secondary circuit 96. This secondary circuit 96 is illustrated in FIG. 37, and comprises the full-bridge circuit 77A connected by a positive line 65 and a negative line 66 to the full-bridge circuit 87. The phase legs 32U and 32V of the full-bridge circuit 87 are connected to the inductive element 46 and the inductive element's return connection 61B (or to two common inductive elements 46A and 46B similar to FIG. 91 or FIG. 92). The circuits 77A and 87 in FIG. 37 can be commutated by holding one of the phase legs 32U or 32V in a constant switch state, and commutating the rest of the circuit in the same manner as circuits 77A and 32Q in FIG. 20. While this type of commutation is within the scope of the invention, for many applications a more advantageous commutation method is described that allows all switches in the full-bridge circuit 87 to operate at the same switching frequency.

To describe this more advantageous commutation method for the example circuit 87, two additional logic signals c and p are utilized based on the example commutation of the secondary circuit 96 in FIG. 21 through FIG. 24A-H′. The logic signal p is in the on state when the primary winding voltage, Vₜ, is positive, and otherwise is in the off state. The logic signal p however changes state at the same time as switch 16H in FIG. 20 rather than at the exact time the primary winding voltage, Vₜ, changes polarity. The logic signal c is in the off state if the output voltage, V_{cs}, is desired to be negative, and otherwise is in the on state. For this commutation method the switches in FIG. 37 operate with the following logical expressions using the defined logic signals and the commutation for the switches in FIG. 20:
16A=16A; 16B=16B; 16C=16C; 16D=16D;
17A=c & (˜p|16G)|˜c & ˜p & 16H; 17B=˜c & (p|16G)|c & p & 16H;
17C=˜c & (˜p|16G)|c & ˜p & 16H; 17D=c & (p|16G)|˜c & p & 16H.
   Where & is the logical AND, | is the logical OR, and ˜ is the logical negation (or changes the on/off state of the signal or switch). In these logical operations negating (˜) all the p signals will also give equivalent operation. For clarity it should be understood that by using these logical operations it facilitates the different commutation utilized under different power transfer conditions.

The above commutation method applies voltage levels of either 0V and +V_{br} or 0V and −V_{br} to the inductive element 46. Another commutation method within the scope of the invention applies voltage levels of +V_{br} and −V_{br} to the inductive element 46. This type of commutation simultaneously changes the switch states of phase legs 32U and 32V and follows the same principles as are set forth for the three phase secondary circuit composed of circuits 77A and 88 in FIG. 39 and functionally illustrated in FIG. 41 and FIGS. 42A-J′. While this type of commutation is within the scope of the invention, it is typically less desirable than the above commutation method. By holding both phase legs 32U and 32V in a switch state based on the desired polarity of V_{cs}, and commutating the primary circuit 90 and the full-bridge circuit 77A in FIG. 37 the same as described for the secondary circuit 77A in FIG. 13, another commutation method within the scope of the invention is possible (this commutation could also be applied to the secondary circuit 96 in FIG. 20). Unless the duration that voltage is applied to the inductive element 46 is high (i.e. typically greater than 90 percent of the time), this commutation method is also less advantageous than the more advantageous commutation method from above. However, in some applications it is advantageous to switch between this commutation method and the more advantageous commutation method depending on the duration that voltage is applied to the inductive element 46.

Similar to FIG. 37 a multilevel phase leg can be added to the secondary circuit 96 in FIG. 32 to create a one phase ac secondary circuit 96. This secondary circuit 96 is illustrated in FIG. 38, and comprises the full-bridge circuit 77A connected by a positive line 65 and a negative line 66 to the multilevel full-bridge circuit 87A. Example commutation methods for the multilevel phase legs 34U and 34V are analogous to those for the phase legs in FIG. 37, but with multilevel phase leg transitions like those in FIG. 33 through FIGS. 36A-H′. It is also possible to change one of the multilevel phase legs 34U or 34V in circuit 87A to a phase leg like 32U and 32V in FIG. 37, but if such a change is made, a commutation method other than the one analogous to the advantageous commutation method from above must be utilized.

When utilized with a primary circuit 90 that generate the multiple voltage levels (primary circuits 96 appropriate for FIG. 2 and FIG. 3 as examples), adding another phase leg to the secondary circuit 96 in FIG. 37 creates a three phase ac secondary circuit 96. This secondary circuit 96 is illustrated in FIG. 39, and comprises the full-bridge circuit 77A connected by the positive line 65 and negative line 66 to a second circuit 88 comprising the three phase legs 32W, 32X, and 32Y. The three phase legs 32W, 32X, and 32Y are connected to the inductive elements 46A, 46B, and 46C respectively. Additional phase legs can be connected to the positive line 65 and negative line 66 to further increase the number of phases (or inductive elements).

Each phase leg 32W, 32X, and 32Y in FIG. 39 is independently commutated the same as phase leg 32Q in FIG. 20. Therefore when the current in the inductive element connected to a phase leg is positive (ie current conducting away from the phase leg), the bottom switch in the phase leg (switch 17F in phase leg 32W as an example) is initially on after the primary winding voltage(s), Vₜ, Vₜ₁, or Vₜ₂, changes polarity. Conversely, when the current in the inductive element connected to a phase leg is negative, the top switch in the phase leg (switch 17E in phase leg 32W as an example) is initially on after the primary winding voltage(s), Vₜ, Vₜ₁, or Vₜ₂, changes polarity. During the polarity change of the primary winding voltage(s), Vₜ, Vₜ₁, or Vₜ₂, the change in switch state of each phase leg 32W, 32X, and 32Y occurs at the same time as for phase leg 32Q in FIG. 20. The full-bridge circuit 77A in FIG. 39 operates the same as the full-bridge circuit 77A in FIG. 20. FIG. 41 and FIGS. 42A-J′ illustrate example waveforms and commutation circuit diagrams utilizing a modified version of the primary circuit 90 in FIG. 40, and illustrated with the phase leg 32W clamped at all times to the positive line 65. FIG. 41 and FIGS. 42A-J′ illustrate an example where the maximum and middle voltage levels are applied to the primary winding 54, but at lower ac voltage conditions for Vₓ, V_{y}, and V_{z} either the middle and zero voltage levels can be applied to the primary winding 54, or none of the phase legs 32W, 32X, and 32Y are clamped to the positive line 65 or negative line 66.

For the example circuit 88 two phase legs can also be clamped at all times to the positive line 65 or negative line 66 of the secondary circuit 96. While this type of implementation will result in less switch transitions between polarity changes of the primary winding voltage(s), Vₜ, Vₜ₁, or Vₜ₂, it also results in a zero voltage sequence applied to the inductive elements 46A, 46B, and 46C. For the circuit 88 (or circuits with more phases) conventional pwm control can obviously be utilized, but space-vector oriented modulation can also be utilized as long as the commutation for each phase leg is appropriate.

The example circuits 77A and 88 in FIG. 39 are also appropriate for ac to trapezoidal ac three phase (or more phases). In an example commutation method for trapezoidal ac the circuit 77A in FIG. 39 operates the same as the full-bridge circuit 77A in FIG. 37, one of the phase legs 32W, 32X, or 32Y in circuit 88 has both switches off, and two of the phase legs 32W, 32X, or 32Y in circuit 88 operate the same as the full-bridge circuit 87 in FIG. 37.

FIG. 40 illustrates an example primary circuit 90 appropriate for the example embodiment in FIG. 3. The multilevel full-bridge circuit 71F in FIG. 40 comprises the primary winding 54 connected between two multilevel phase legs 34A and 34B that are connected to the capacitive elements 42A and 42B. In FIG. 40 the multilevel legs 34A and 34B comprise two diodes connected between the interconnection of capacitive elements 42A and 42B and each interconnection of two blocking elements that is not connected to the primary winding 54 (diodes 38Q and 38R in multilevel phase 34A as an example), just as has been extensively described in the literature. The primary circuit 90 in FIG. 40 includes snubber capacitances 41G, 41H, 41I, and 41J across the switches 14G, 14H, 14I, and 14J respectively along with snubber capacitances 41K and 41M connected between the interconnection of capacitive elements 42A and 42B and opposite sides of the primary winding 54. Alternatively, snubber capacitances can also be included across the primary winding, or a combination of the snubber capacitances illustrated in FIG. 40 and snubber capacitance across the primary winding.

The multilevel full-bridge circuit 71F switches in FIG. 40 can be commutated the same as the switches of the same name in FIG. 19. As previously stated, if a single source is connected to the primary circuit 90, the commutation method must alternate the middle voltage level applied to the primary winding 54 between V_{d1} and V_{d2} (V_{d1} must also equal V_{d2}). For this type of example commutation only one of the multilevel phase legs is required, and the other side of the primary winding can be a phase leg (a combination of phase leg 32A and multilevel phase leg 34B as an example). An example of this is illustrated with the primary circuit 90 in FIG. 42A. The voltage and current waveforms in FIG. 41 (V_{d1}=V_{d2}=V_{d}/2 in figure) and the commutation circuit diagrams in FIGS. 42A-J′ illustrate an example commutation method for this primary circuit 90.

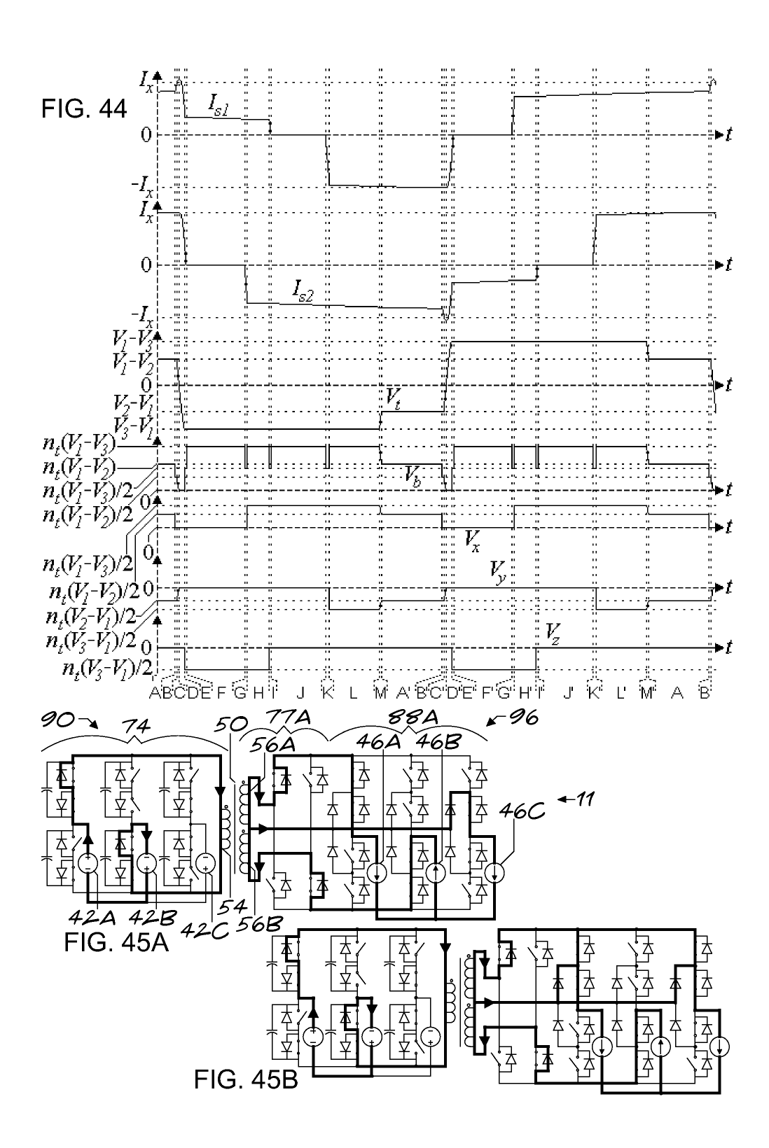

Similar to FIG. 39 a multilevel phase leg can be added to the secondary circuit 96 in FIG. 38 to create a three phase ac secondary circuit 96. This secondary circuit 96 is illustrated in FIG. 43, and comprises the full-bridge circuit 77A connected by the positive line 65 and negative line 66 to a second circuit 88A comprising the three multilevel phase legs 34W, 34X, and 34Y. The three multilevel phase legs 34W, 34X, and 34Y are connected to the inductive elements 46A, 46B, and 46C respectively. Additional multilevel phase legs can be connected to the positive line 65 and negative line 66 to further increase the number of phases (or inductive elements). Example commutation methods for the multilevel phase legs 34W, 34X, and 34Y are analogous to those for the phase legs in FIG. 39, but with the multilevel phase leg transitions like those in FIG. 33 through FIGS. 36A-H′. FIG. 44 and FIGS. 45A-M′ illustrate example waveforms and example commutation circuit diagrams of commutating the secondary circuit 96 in FIG. 39.

Converters 11 of the type in FIG. 1, FIG. 2 and FIG. 3 are commutated to control the application time for which two or three voltage levels are applied to the current source 46. The situation is similar for the converter 11 illustrated in FIG. 41 and FIGS. 42A-J′, except that the application times are controlled for three current sources 46A, 46B, and 46C. The example converter 11 in FIG. 28 through FIGS. 31A-K′ is more complicated in that two voltages from the capacitive elements 42A, 42B, and 42C are appropriately applied to the current source 46 (i.e. voltages of (V₁−V₃) and (V₁−V₂) in the example). The application time for which each voltage level is applied to a current source of any embodiments is determined in such a way to achieve certain control objectives. Some examples of these control objectives for dc to dc, dc to ac (same as ac to dc), and ac to ac conversion are: controlling the voltage of at least one capacitive element connected directly or indirectly to the primary circuits 90 or the secondary circuits 96; controlling the current of at least one inductive element connected directly or indirectly to the primary circuits 90 or the secondary circuits 96; controlling the converter so that it generates a certain harmonic content in the ac voltage of capacitive elements and or the ac current of the inductive elements connected directly or indirectly to the primary circuits 90 or the secondary circuits 96; and controlling the converter so that it appears with a certain impedance as seen from ac sources connected directly or indirectly to the primary circuits 90 or the secondary circuits 96. Methods for determining the application time of each voltage to fulfill these objectives are well known and have been extensively described in the literature. They will therefore not be treated here.

For a converter 11 including a multiple phase primary circuit 90, such as in FIG. 26, and a secondary circuit 96 with multiple inductive elements, such as in FIG. 43, the control objectives above are the same, but the control is complicated by there being multiple capacitive element voltages that are applied to multiple inductive elements. The interdependence between the capacitive elements' voltages and the inductive elements' currents results in extra complexity in both the control and the commutation of the converter.

One example commutation method is to apply the transformed voltage of each capacitive element to each inductive element for an appropriate time, similar to methods used for indirect matrix converters (sometimes referred to as dual-bridge matrix converters). An active clamp circuit, like that in FIG. 49, is required for this commutation method to be practical. For the bi-directional full-bridge circuit 71B in FIG. 26 the sequence of voltages applied to the primary winding 54 (with the assumed voltage conditions) is V₂−V₁, 0, V₃−V₁, V₁−V₂, 0, V₁−V₃, and repeat (or alternatively V₃−V₁, 0, V₂−V₁, V₁−V₃, 0, V₁−V₂, and repeat). To allow for these voltage sequences, the current in the secondary windings 56A and 56B in FIG. 43 must be in opposite directions for the first and last switch states of the secondary circuit 96 for each non-zero voltage in the sequence. When zero voltage is applied to the primary winding 54, the secondary circuit 96 must change from the last switch state to the first switch state. This reverses the direction of the secondary winding currents, Iₛ₁ and Iₛ₂, without a change in the polarity of the primary winding voltage, Vₜ, and thus results in a large quantity of energy absorbed by the clamp circuit 99 (or the secondary circuit 96 itself), and thus the requirement for an active clamp circuit. When utilized with the example circuits 77A and 88A in FIG. 43, the clamp circuit 99 in FIG. 49 operates by turning on the clamp circuit switch 18Z at zero current as the voltage across the primary winding 54 transitions to zero voltage or is zero voltage, which causes the discharge of the clamp capacitor 43 in FIG. 49. When the secondary circuit switches change state, the clamp capacitor 43 will change to charging, and the clamp circuit switch 18Z is turned off at zero voltage.

While the above example commutation method is in some ways simple to implement, it has: a large number of switch transitions between voltage polarity changes of the primary winding(s), requires the current in the secondary winding(s) to change direction between polarity changes of the primary winding(s) (thus eliminates the use of some secondary circuits 96), and requires an active clamp circuit in the secondary circuit 96. It is instead preferable that the commutation method: operates the primary circuit 90 as if there is only a single inductive element, operates the secondary circuit 96 as if there is a dc primary circuit, and does not require an active clamp circuit for the secondary circuit 96. This is possible if the duty cycles of the signals that control the switches in the converter 11 are calculated so that there is interdependence between the voltages applied to the inductive elements and the currents applied to the capacitive elements. An example of this type of commutation method is illustrated in FIG. 44 and FIGS. 45A-M′ (average power is transferring from the capacitive element 42B in this example). However, with this example commutation method the calculation of the duty cycles is more computationally intensive. The duty cycles can be directly calculated, but in many cases it is easier to derive the duty cycles by transforming duty cycles calculated for a virtual primary side dc voltage source. The best way to implement the transformation will depend on the primary circuit 90, the secondary circuit 96, and the application, and any such implementations are applicable to the invention.

An example implementation is given for the example circuit 71B in FIG. 26 and the example circuits 77A and 88A in FIG. 43. If only two voltage levels and no zero voltage sequence are applied to the inductive elements 46A, 46B, and 46C, four switch states are applied to the inductive elements 46A, 46B, and 46C. This results in three possible cases for transforming the duty cycles if the average power is transferring from the capacitive element 42B. For all cases:

$$\begin{matrix}{S}_{x , y , z} = ceil ( {d}_{xp , yp , zp} ) \frac{1 + sgn ( {I}_{x , y , z} )}{2} + ceil ( {d}_{xn , yn , zn} ) \frac{1 - sgn ( {I}_{x , y , z} )}{2} ; & ( 1 ) \\ {d}_{xo , yo , zo} = {d}_{xp , yp , zp} + {d}_{xn , yn , zn} ; & ( 2 )\end{matrix}$$

where d_{xp,yp,zp} are the original duty cycles before the transformation for which positive voltage is applied to the current sources, d_{xn,yn,zn} are the original duty cycles before the transformation for which negative voltage is applied to the current sources, sgn is an operator that gives one if the quantity inside the parenthesis is positive and negative one if the quantity is negative (zero is considered to be one or negative one for these calculations), and ceil is an operator that rounds the quantity inside the parenthesis up to the nearest integer. Since only two of the possible three voltage levels are applied to each inductive element 46A, 46B, and 46C, one of the original duty cycles, d_{xp,yp,zp} or d_{xn,yn,zn} for each multilevel phase leg will be zero.

In case I:

$$\begin{matrix}{d}_{12} = \frac{2 {I}_{v 2}}{{n}_{t} ( {S}_{x} \vert {I}_{x} \vert + {S}_{y} \vert {I}_{y} \vert + {S}_{z} \vert {I}_{z} \vert )} ; & ( 3 ) \\ {d}_{13} = 1 - {d}_{12} ; & ( 4 ) \\ {d}_{x , y , z} = \frac{{V}_{i} {d}_{xo , yo , zo}}{( {V}_{1} - {V}_{3} )} + {S}_{x , y , z} ( 1 - \frac{( {V}_{1} - {V}_{2} )}{( {V}_{1} - {V}_{3} )} ) {d}_{12} ; & ( 5 )\end{matrix}$$

d_{x+,y+,z+}=d_{x,y,z}ceil(d_{xp,yp,zp}) (6);

d_{x-,y-,z-}=d_{x,y,z}ceil(d_{xn,yn,zn}) (7);

where d₁₂ is the duty cycle for which |V₁−V₂| is applied to the primary winding 54, d₁₃ is the duty cycle for which |V₁−V₃| is applied to the primary winding 54, Iᵥ₂ is the desired current loading of the capacitive element 42B, nₜ is the sum of both secondary windings' turns ratios (i.e. nₜ₁=nₜ₂=nₜ/2), d_{x+,y+,z+} are the duty cycles for which positive voltage is applied to the inductive elements 46A, 46B, and 46C, d_{x-,y-,z-} are the duty cycles for which negative voltage is applied to the inductive elements 46A, 46B, and 46C, and Vᵢ is a virtual primary side dc voltage source used to derive the original duty cycles, d_{xp,yp,zp} and d_{xn,yn,zn}. It may be necessary to vary the value of the virtual primary side dc voltage source, Vᵢ, depending on the desired power factor of the capacitive elements 42A, 42B, and 42C. To verify case I is the correct case the following expression should be true:

$${I}_{v 3} = \frac{{n}_{t}}{2} [ \begin{matrix}( 2 {S}_{x} - 1 ) \vert {I}_{x} \vert {d}_{x} + ( 2 {S}_{y} - 1 ) \vert {I}_{y} \vert {d}_{y} + \\ ( 2 {S}_{z} - 1 ) \vert {I}_{z} \vert {d}_{z} - {d}_{12} ( {S}_{x} \vert {I}_{x} \vert + {S}_{y} \vert {I}_{y} \vert + {S}_{z} \vert {I}_{z} \vert )\end{matrix} ] ; \qquad ( 8 )$$

where Iᵥ₃ is the desired current loading of the capacitive element 42C. FIG. 44 and FIGS. 45A-M′ illustrate the waveforms and the commutation circuit diagrams of an example of case I.

In case II the duty cycle d₁₃ is calculated using equation (4), and the duty cycles of two of the multilevel phase legs in circuit 88A are derived from equations (5), (6), and (7) while the duty cycle for the multilevel phase leg in circuit 88A with the minimum e calculated from:

e_{x,y,z}=S_{x,y,z}d_{xo,yo,zo}+(1−S_{x,y,z})(1−d_{xo,yo,zo}) (9);

is calculated differently. If the minimum e is e_{z} (multilevel phase leg 34Y), the duty cycles are:

$$\begin{matrix}{d}_{12} = \frac{\frac{2 ( {V}_{1} - {V}_{2} ) {I}_{v 2}}{{n}_{t}} - ( 2 {S}_{z} - 1 ) {V}_{i} \vert {I}_{z} \vert {d}_{z o} + ( {S}_{z} - 1 ) ( {V}_{1} - {V}_{3} ) \vert {I}_{z} \vert}{( {V}_{1} - {V}_{2} ) ( {S}_{x} \vert {I}_{x} \vert + {S}_{y} \vert {I}_{y} \vert ) + ( {S}_{z} - 1 ) ( {V}_{1} - {V}_{3} ) \vert {I}_{z} \vert} ; & ( 10 ) \\ {d}_{z} = \frac{{V}_{i} {d}_{zo}}{( {V}_{1} - {V}_{2} )} + ( 1 - {S}_{z} ) ( 1 - \frac{( {V}_{1} - {V}_{3} )}{( {V}_{1} - {V}_{2} )} ) ( 1 - {d}_{12} ) . & ( 11 )\end{matrix}$$

The duty cycles d_{z+} and d_{z-} are then derived using equations (6) and (7). To verify case II is the correct case the following expression should be true (assuming e_{z}<e_{x,y}):

$${I}_{v 3} = \frac{{n}_{t}}{2} [ \begin{matrix}( 2 {S}_{x} - 1 ) \vert {I}_{x} \vert {d}_{x} + ( 2 {S}_{y} - 1 ) \vert {I}_{y} \vert {d}_{y} - \\ {d}_{12} ( {S}_{x} \vert {I}_{x} \vert + {S}_{y} \vert {I}_{y} \vert ) + ( {S}_{z} - 1 ) \vert {I}_{z} \vert ( 1 - {d}_{12} )\end{matrix} ] . \qquad ( 12 )$$

In case III d₁₃ is calculated using equation (4), and the duty cycle of one of the multilevel phase legs in circuit 88A is derived from equations (5), (6), and (7) while the duty cycles of the two phase legs in circuit 88A with the minimum values of e from equation (9) use equations (6), (7), and (11). If the minimum values of e are e_{y} and e_{z} (multilevel phase legs 34X and 34Y), the d₁₂ duty cycle is:

$${d}_{12} = \frac{\begin{matrix}\frac{2 ( {V}_{1} - {V}_{2} ) {I}_{v 2}}{{n}_{t} ( {V}_{1} - {V}_{3} )} - \frac{{V}_{i} ( \begin{matrix}( 2 {S}_{y} - 1 ) \vert {I}_{y} \vert {d}_{yo} + \\ ( 2 {S}_{z} - 1 ) \vert {I}_{z} \vert {d}_{zo}\end{matrix} )}{( {V}_{1} - {V}_{3} )} + \\ ( {S}_{y} - 1 ) \vert {I}_{y} \vert + ( {S}_{z} - 1 ) \vert {I}_{z} \vert\end{matrix}}{\frac{( {V}_{1} - {V}_{2} ) {S}_{x} \vert {I}_{x} \vert}{( {V}_{1} - {V}_{3} )} + ( {S}_{y} - 1 ) \vert {I}_{y} \vert + ( {S}_{z} - 1 ) \vert {I}_{z} \vert} . \qquad ( 13 )$$

To verify case III is the correct case the following expression should be true (assuming e_{y,z}<eₓ):

$${I}_{v 3} = \frac{{n}_{t}}{2} [ \begin{matrix}( 2 {S}_{x} - 1 ) \vert {I}_{x} \vert {d}_{x} - {d}_{12} {S}_{x} \vert {I}_{x} \vert + \\ ( ( {S}_{y} - 1 ) \vert {I}_{y} \vert + ( {S}_{z} - 1 ) \vert {I}_{z} \vert ) ( 1 - {d}_{12} )\end{matrix} ] . \qquad ( 14 )$$

If the average power is transferring to the capacitive element 42B, the three cases are modified for negative power instead of positive power, however those skilled in the art will see that the equations will be of the same form with some of the signs changing. In addition, the order in which the voltage from the capacitive elements 42A, 42B, and 42C are applied to the primary winding is also reversed.

Without going into the details there are numerous other implementations to derive the duty cycles. The example implementation above maximizes the duty cycle d₁₃. The implementation could be modified to maximize d₁₂, but this results in more complex calculations, and causes the secondary winding currents, Iₛ₁ and Iₛ₂, to change directions between polarity changes (eliminates the use of some secondary circuits 96). It also causes the sequence of voltages applied to the primary winding 54 after a voltage polarity change to be |V₁−V₂|, |V₁−V₃|, and |V₁−V₂| (however this results in the same switching frequency for the bi-directional switches 4G-4G′ and 4H-4H′ since the current directions are different). If a zero voltage sequence can be applied to the inductive elements 46A, 46B, and 46C, an implementation can be utilized that only applies three switch states to the inductive elements 46A, 46B, and 46C. Another example commutation method and implementation is to apply zero voltage to the primary winding 54 between time periods C and D and also time periods C′ and D′ in FIG. 44 so that the average voltage applied to the primary winding is always equal to the virtual primary side dc voltage source, Vᵢ. Applying zero voltage to the primary winding 54 can also be implemented to eliminate a switch state applied to the inductive elements 46A, 46B, and 46C.

For other secondary circuits 96 with multiple inductive elements, other primary circuits 90 with multiple phases, multiple secondary circuits 96, and or an inductive storage circuit 98 included in the secondary circuit 96 even more implementations and calculation methods for correctly loading the capacitive elements and inductive elements will be apparent to those skilled in the art, and any such implementations and calculation methods are applicable to the invention.

Additional full-bridge circuits 87 or 87A can be connected to the positive line 65 and negative line 66 of the full-bridge circuit 77A in FIG. 37 or FIG. 38 to form a multiple phase ac secondary circuit 96. The commutation method for each of these additional full-bridge circuits 87 or 87A will typically independently operate the same as the full-bridge circuits 87 or 87A in FIG. 37 or FIG. 38 with the additional principles set forth herein for secondary circuits 96 with multiple inductive elements.

### Inductive Storage Circuits

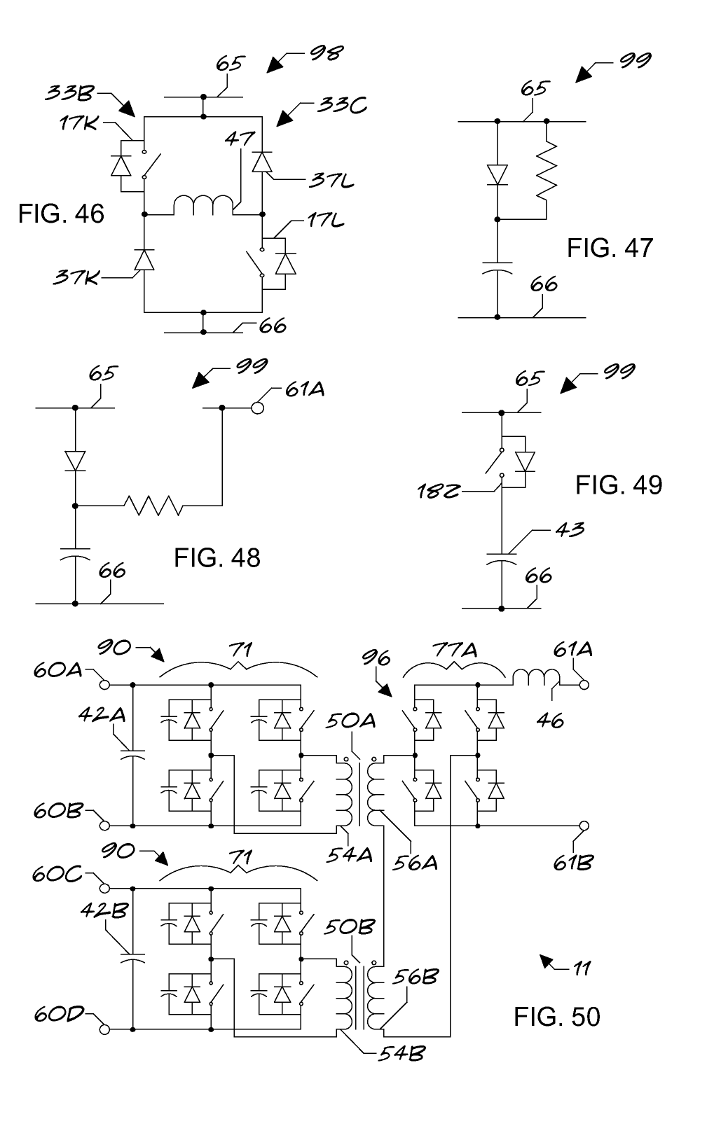

An inductive storage circuit 98 can also be included in the secondary circuits 96. FIG. 46 illustrates an example inductive storage circuit 98 comprising a storage inductor 47 (or other type of inductive element that is capable of at least moderate energy storage) connected between phase legs 33B and 33C (as another example multilevel phase legs could be utilized). This inductive storage circuit 98 is appropriate for secondary circuits 96 that include the positive line 65 and negative line 66. In FIG. 46 the phase legs 33B and 33C only utilize two switches. Using switches for all the blocking elements in phase legs 33B and 33C is another option that will reduce the conduction loss for some semiconductor technologies. The commutation method for the inductive storage circuit 98 in FIG. 46 is typically the same as the more advantageous commutation method for the full-bridge circuit 87 in FIG. 37 with the additional principles set forth herein for secondary circuits with multiple inductive elements. To discharge the storage inductor 47, switches 17K and 17L are initially off after the primary winding voltage(s) changes polarity and the inductor discharges through diodes 37K and 37L. After a controlled discharge time either switch 17K or 17L is turned on to make the current freewheel in only diode 37K or 37L until the next polarity change. To charge the storage inductor 47, only switch 17K or 17L is initially on after the primary winding voltage, Vₜ, changes polarity, and the current freewheels in only diode 37K or 37L. At a controlled charge time before the next polarity change, both switches 17K and 17L are put in the on state to charge the inductor until the next polarity change.

### Clamp Circuits for Secondary Circuits

A clamp circuit 99 can be included in any secondary circuit 96. The clamp circuit 99 can take many forms including both active and passive types. Similar to FIG. 48, clamp circuits 99 that recycle the absorbed energy through a connection (such as 61A) to the other side of an inductive element (such as 46) are also applicable. As simple examples any of the secondary circuits that include the positive line 65 and negative line 66, can utilize the simple dc clamp circuits in FIG. 47 (passive clamp circuit), FIG. 48 (passive clamp circuit for dc sources only), and FIG. 49 (active clamp circuit). Numerous clamp circuits, appropriate for circuits connected between a high-frequency link and an inductive element(s), have been extensively described in the literature, and any appropriate clamp circuit should be considered applicable to the invention.

### Example Embodiments of Integrated Multilevel Generation

All of the converters 11 described above generate the multiple voltage levels with multiple independently controlled secondary windings, multiple high-frequency links, or multiple primary side capacitive elements. It is also possible to integrate these three types of converters. FIG. 50 illustrates an example converter 11 that is a modified version of the primary circuit 90 in FIG. 12. Instead of both full-bridge circuits 71 being connected to one common source, each full-bridge circuit 71 is connected to an independent source. Since the converter 11 in FIG. 50 utilizes two high-frequency links 50A and 50B and two capacitive elements 42A and 42B, it is an example integration of the type of converters 11 in FIG. 2 and FIG. 3. The converter 11 in FIG. 50 is useful for applications where it is desired to utilize multiple isolated sources connected to primary circuits 90 (as opposed to secondary circuits 96 like in FIG. 130).

The converter 11 in FIG. 50 can be further modified to integrate all three types of converters 11 in FIG. 1, FIG. 2, and FIG. 3. FIG. 51 illustrates such an example embodiment that is a cascade converter 11 for dc to three phase ac. The example converter 11 in FIG. 51 utilizes multiple high-frequency links, multiple capacitive elements, and multiple independently controlled secondary windings interconnected by secondary circuits 96. The high-frequency links 50A, 50B, 50C, 50D, 50E, and 50F have isolated magnetic coupling. Not all of the secondary circuits 96 in FIG. 51 are directly connected to an inductive element. For instance the connection 101 in secondary circuit 96B is not directly connected to an inductive element, but it is indirectly connected to the inductive element 46A through either circuit 87 in secondary circuit 96A or through circuit 77A, circuit 87, and secondary winding 56 in secondary circuit 96A.

The cascade converter 11 in FIG. 51 is advantageous since it can be broken into smaller power electronic building blocks (PEBBs) that can be combined to form the converter. For instance the capacitive element 42A, primary circuit 90A, high-frequency link 50A, and secondary circuit 96A form a PEBB. For FIG. 51 the primary circuits 90 and secondary circuits 96 can be commutated the same as already described for the circuits in FIG. 4 and FIG. 37 respectively. Each PEBB can be commutated independently (i.e. as if it is a separate converter), or can be commutated with interdependence between the PEBBs, such as equally offsetting the switching periods of the PEBBs connected to a common inductive element (thus increasing the frequency of the voltage waveform across the common inductive element). The capacitive elements 42A, 42B, 42C, 42D, 42E, and 42F can be connected to different sources, in series to a common source, in parallel to a common source, or some combination of these. A major advantage of the cascade converter is that the same PEBBs can be utilized for various applications (dc to dc, dc to ac), various number of voltage levels (i.e. non-multilevel or greater than three levels), and various power ratings. Any primary circuit 90 and secondary circuit 96 embodiments of the invention can also be utilized in a cascade converter.

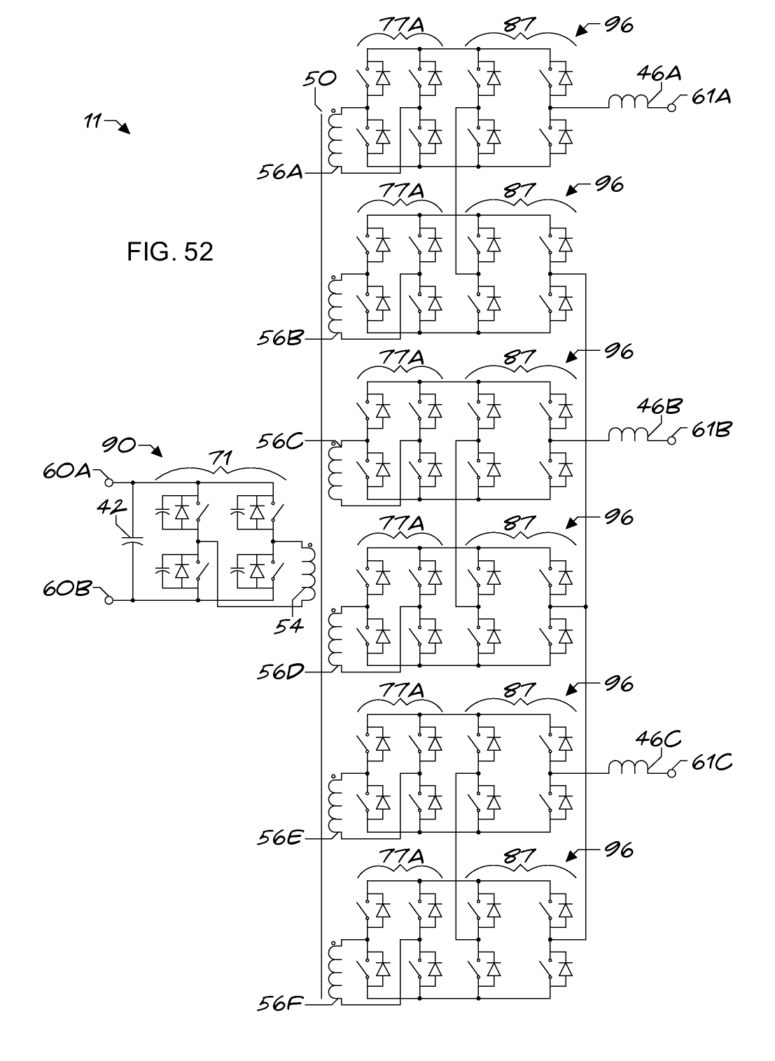

Another example cascade converter 11 is illustrated in FIG. 52 with a single primary circuit 90 and high-frequency link 50. The primary circuit 90 in FIG. 52 is commutated to apply an approximately equal duty cycle bi-polar voltage square wave across the primary winding 54 (i.e. like in FIG. 7 through FIG. 11), and the secondary circuits 96 can be commutated with one of the example commutation methods for FIG. 37 that controls the current applied to the secondary winding (56 followed by a suffix). The cascade converter 11 in FIG. 52 has many of the same advantages as the cascade converter 11 in FIG. 51, but it has less components when PEBBs are not necessary.

### Example Embodiments of Increasing the Number of Levels

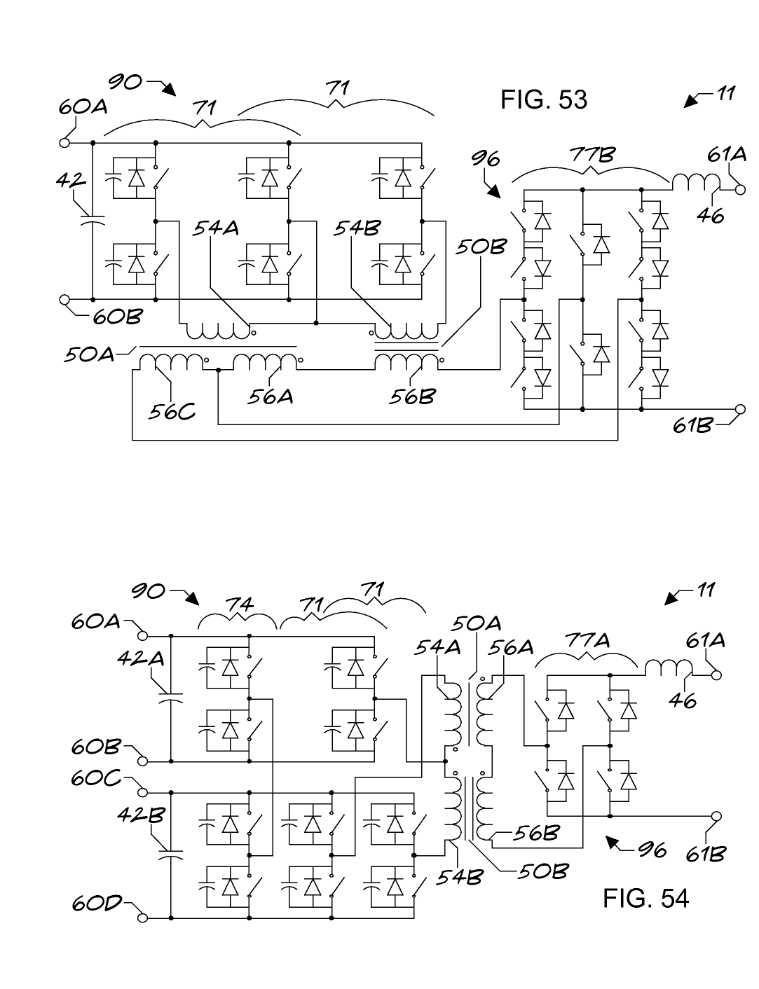

All of the converters 11 described above are three level converters. To increase the number of levels extra secondary windings (56 followed by a suffix), high-frequency links (50 followed by a suffix), or capacitive elements (42 followed by a suffix) are added to the converter 11. One possible way to increase the number of levels is to combine dissimilar means of generating the voltage levels. To combine the types of converters 11 in FIG. 1 and FIG. 3, a primary circuit 90 for FIG. 3 can be combined with a secondary circuit 96 for FIG. 1. To combine the types of converters 11 in FIG. 1 and FIG. 2, a primary circuit 90 for FIG. 2 can be combined with a secondary circuit 96 for FIG. 1, but with at least one of the high-frequency links 50A and 50B having two secondary windings. FIG. 53 illustrates an example for the primary circuit 90 in FIG. 12, and the secondary circuit 96 in FIG. 6. To combine the types of converters 11 in FIG. 2 and FIG. 3, one to all three of the phase legs in FIG. 12 can be changed to multilevel phase legs, or another phase leg and high-frequency link 50B can be added to the primary circuit 90 in FIG. 19 to form a second full-bridge circuit 71 (example illustrated in FIG. 54). Obviously numerous other combinations of the circuits described herein are also possible.

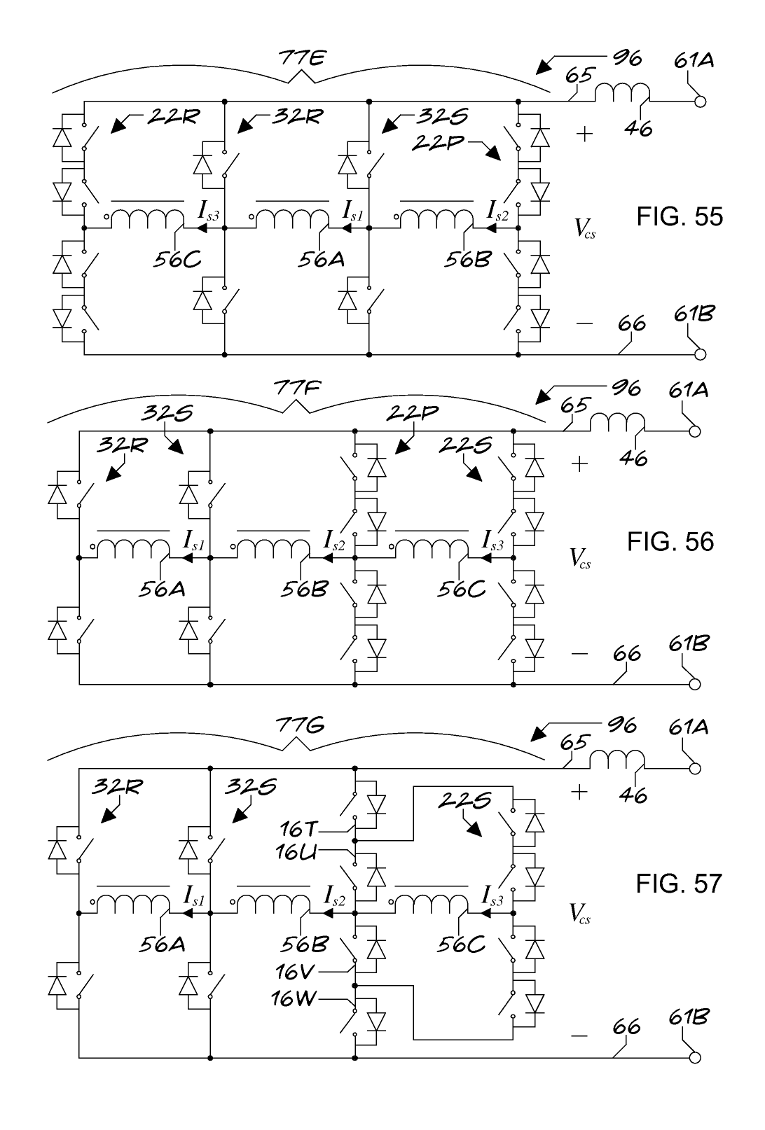

The number of levels in the converters 11 can also be increased without changing the means of generating the voltage levels. For the secondary circuits 96 in FIG. 6 and FIG. 27 the number of levels can be increased by adding extra secondary windings that are connected to additional bi-directional phase legs. FIG. 55 and FIG. 56 illustrate examples of adding an extra secondary winding 56C to the mixed leg circuit 77C in FIG. 27. The mixed leg circuit 77E in FIG. 55 adds the secondary winding 56C between the phase leg 32R and a bi-directional phase leg 22R. The mixed leg circuit 77F in FIG. 56 adds the secondary winding 56C between the bi-directional phase leg 22P and a bi-directional phase leg 22S. An alternative to the mixed leg circuit 77F is illustrated in FIG. 57. The mixed leg circuit 77G in FIG. 57 replaces the bi-directional phase leg 22P in FIG. 56 with the switches 16T, 16U, 16V, and 16W that are interconnected to the bi-directional phase leg 22S.

For the secondary circuits 96 in FIG. 32, FIG. 38, and FIG. 43 the number of levels can be increased in a similar manner to the methods described extensively in the literature for multilevel phase legs. The differences are that extra secondary windings are added, and twice as many diodes are required due to the changing polarity of the secondary windings. The exception to the extra diode requirement is for any set of diodes connected to the center of the series connected secondary windings (thus only applicable to even number of secondary windings). Since the voltage polarity changes are symmetric for the center connected set, only one pair of diodes is required (diodes 38Q and 38R in FIG. 32 as an example). The other sets of diodes are connected in a similar manner as in the literature, but with one pair of diodes connected to the secondary windings (as opposed to capacitive elements as in the literature) for positive primary winding voltage and the other pair of diodes connected to the secondary windings for negative primary winding voltage.

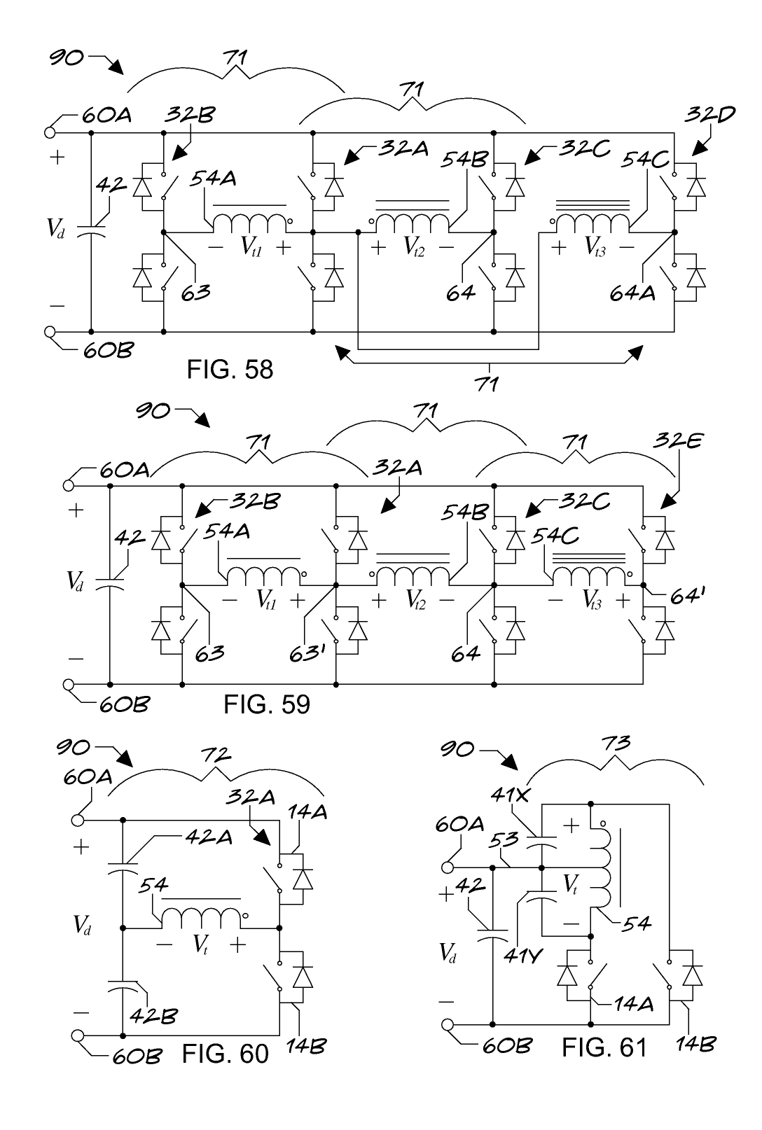

For the primary circuit 90 in FIG. 12 the number of levels can be increased by adding extra high-frequency links. The primary windings of the extra high-frequency links can be connected to independent full-bridge circuits, in parallel with the original full-bridge circuits 71 (FIG. 58), in series with the original full-bridge circuit 71 (FIG. 59), or any combination of these. The example primary circuit 90 in FIG. 58 adds the primary winding 54C between the phase leg 32A and the additional phase leg 32D. If low load inductors are utilized for the primary circuit 90 in FIG. 58, two inductors are connected between lines 63 and 64 and also between lines 63 and 64A. The example primary circuit 90 in FIG. 59 adds the primary winding 54C between the phase leg 32C and the additional phase leg 32E. If low load inductors are utilized for the primary circuit 90 in FIG. 59, two inductors are connected between lines 63 and 64 and also between lines 63′ and 64′.

For the primary circuit 90 in FIG. 19 the number of levels can be increased by adding additional independent sources, capacitive elements, and full-bridge circuits 74. If one extra independent source is added to the primary circuit 90 in FIG. 19, the primary circuit 90 includes two full-bridge circuits 74. One of the full-bridge circuits 74 is connected between the original capacitive element 42A and the capacitive element of the extra independent source, while the other the full-bridge circuit 74 is connected between the original capacitive element 42B and capacitive element of the extra independent source. If additional independent sources are not available the levels can be increased by the other methods described herein, such as changing one or more of the phase legs to a multilevel phase leg (also involves splitting the capacitive elements 42A and or 42B in FIG. 19).

For the primary circuit 90 in FIG. 40 the number of levels can be increased in the same manner as described extensively in the literature for multilevel phase legs. When the number of levels for the primary circuit 90 in FIG. 40 are increased (assuming snubber capacitance of the type illustrated in FIG. 40), the snubber capacitances 41G, 41H, 41I, and 41J illustrated in FIG. 40 are still included, but the snubber capacitances like 41K and 41M are placed at every other level (i.e. for four voltage levels, both snubber capacitances 41K and 41M are split into two snubber capacitances). A second snubber capacitance option is to connect a snubber capacitance between each multilevel phase leg's connection to a capacitive element (42 followed by a suffix) and the multilevel phase leg's connection to the primary winding 54. Both options result in the same number of snubber capacitances. The first option results in lower voltage ratings for the snubber capacitances, but it requires the multilevel phase legs to transition through each level (i.e. first option must transition from first level to second level to third level while the second option can transition directly from first level to third level). In practical implementation there is still an inherent capacitance across each switch that does not have a snubber capacitance connected directly across it, but this capacitance should be less than the snubber capacitance.

Converters with increased levels can be commutated with the same principles already described herein for the three level converters, but with an increased number of possible levels. In the example primary circuit 90 and secondary circuit 96 embodiments described below, the number of levels can be increased in similar ways to those described above, but in some cases an alternative method is explicitly stated. Any of the ways described herein for increasing the number of levels in the converter can also be combined. Those skilled in the art will also see numerous other ways to increase the number of levels for any embodiments of the invention, and all such ways are within the spirit of the invention.

### Additional Example Embodiments of Primary Circuits and Secondary Circuits

A half-bridge circuit 72 or push-pull circuit 73 can be utilized for the primary circuit 90 in some embodiments of the invention. If these primary circuits 90 are utilized with a secondary circuit 96 that does not allow for control of the duration current is applied to the secondary winding 56A (secondary circuit 96 in FIG. 27 as an example), then only two levels can be applied to the inductive element 46. In the half-bridge circuit 72 in FIG. 60 the primary winding 54 is connected between the phase leg 32A and two capacitive elements 42A and 42B. No snubber capacitances are shown in FIG. 60, but they can be included across each switch, across the primary winding, or across both the switches and the primary winding. The half-bridge circuit's switches 14A and 14B in FIG. 60 operate the same as the full-bridge circuit's switches 14A and 14B respectively in FIG. 4, but the voltages applied to the primary winding are V_{d}/2 and −V_{d}/2. In the push-pull circuit 73 in FIG. 61 the primary winding 54 is connected between two switches 14A and 14B, and a center-tap 53 of the primary winding 54 is connected to the capacitive element 42. Due to the center-tap 53 of the primary winding 54 in FIG. 61, two snubber capacitances 41X and 41Y are connected across the primary winding 54 (i.e. the center-tap 53 makes the primary winding 54 the equivalent of two primary windings). Alternatively, snubber capacitances can also be included across each switch or across both the switches and the primary winding. The push-pull circuit's switches 14A and 14B in FIG. 61 operate the same as the full-bridge circuit's switches 14A and 14B respectively in FIG. 4, but V_{d} and −V_{d} are only applied to half the primary winding 54.

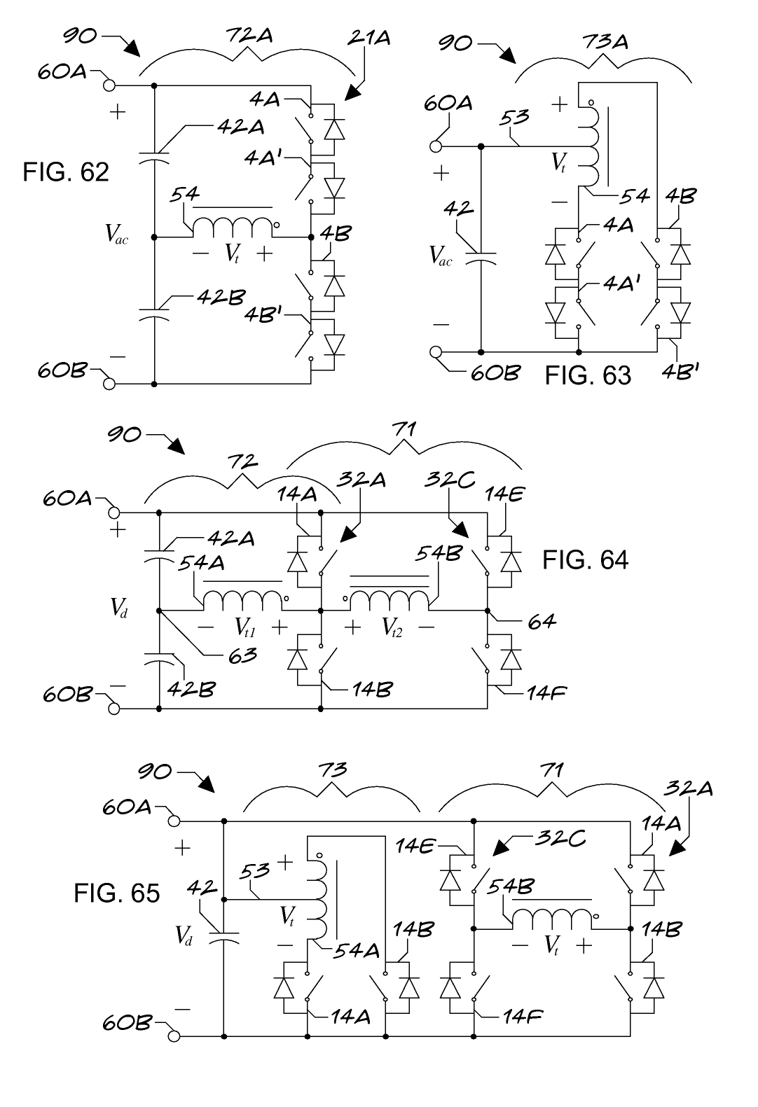

By replacing the primary circuit's switches with bi-directional switches, one phase ac versions of the half-bridge circuit and push-pull circuit are possible. For the bi-directional half-bridge circuit 72A in FIG. 62 the primary winding 54 is connected between the switch matrix 21A and two capacitive elements 42A and 42B. The bi-directional half-bridge circuit's switches 4A, 4A′, 4B, and 4B′ operate the same as the bi-directional full-bridge circuit's switches 4A, 4A′, 4B, and 4B′ respectively in FIG. 25, but the voltages applied to the primary winding are V_{ac}/2 and −V_{ac}/2. For the bi-directional push-pull circuit 73A in FIG. 63 the primary winding 54 is connected between two bi-directional switches 4A-4A′ and 4B-4B′, and a center-tap 53 of the primary winding 54 is connected to the capacitive element 42. The push-pull circuit's switches 4A, 4A′, 4B, and 4B′ operate the same as the full-bridge circuit's switches 4A, 4A′, 4B, and 4B′ respectively in FIG. 4, but V_{ac} and −V_{ac} are only applied to half the primary winding 54. No snubber capacitances are shown in FIG. 62 and FIG. 63, but they can be included across each bi-directional switch, across the primary winding, or across both the bi-directional switches and the primary winding.

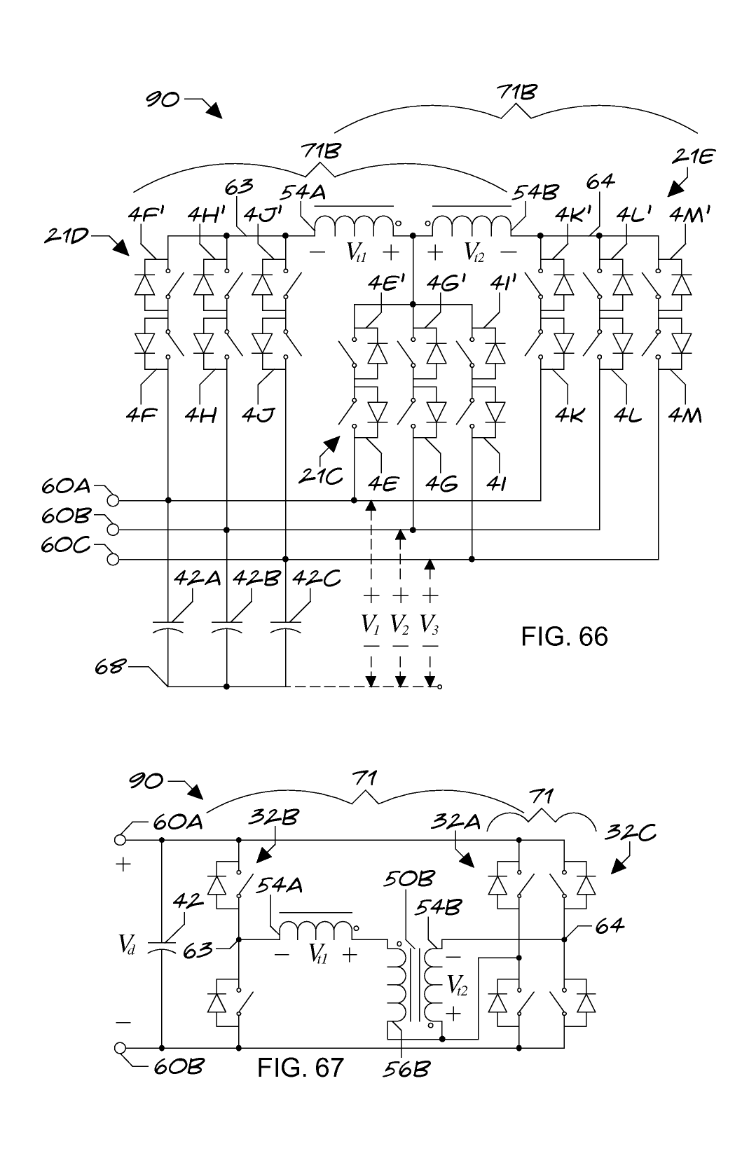

One of the full-bridge circuits 71 in FIG. 12 can also be replaced with a half-bridge circuit 72 or push-pull circuit 73. If such a replacement is made, and a secondary circuit 96 is utilized that does not allow for control of the duration current is applied to the secondary windings 56A and 56B (secondary circuit 96 in FIG. 13 as an example), then only two levels can be applied to the inductive element 46. The example primary circuit 90 in FIG. 64 utilizes both the half-bridge circuit 72 and the full-bridge circuit 71, but with a common phase leg 32A. The switches 14A, 14B, 14E, and 14F in FIG. 64 can operate the same as the switches 14A, 14B, 14E, and 14F respectively in FIG. 12, but the voltages applied to the primary winding 54A are V_{d}/2 and −V_{d}/2. The example primary circuit 90 in FIG. 65 utilizes both the push-pull circuit 73 and the full-bridge circuit 71. The switches 14A, 14B, 14E, and 14F in FIG. 65 operate the same as the switches 14A, 14B, 14E, and 14F respectively in FIG. 12, but V_{d} and −V_{d} are only applied to half the primary winding 54A. Similar to previous examples the primary circuit's switches can be swapped with bi-directional switches to create one phase ac primary circuits. The switch matrixes formed by these swaps can also be extended to multiple ac phases by adding extra bi-directional switches to each switch matrix. FIG. 66 illustrates an example of this with two bi-directional full-bridge circuits 71B, but with a common switch matrix 21C shared by both circuits 71B. The switch matrix 21E comprises bi-directional switches 4K-4K′, 4L-4L′, and 4M-4M′. The primary circuit 90 in FIG. 66 operates with similar principles as the primary circuits 90 in FIG. 12 and FIG. 26.

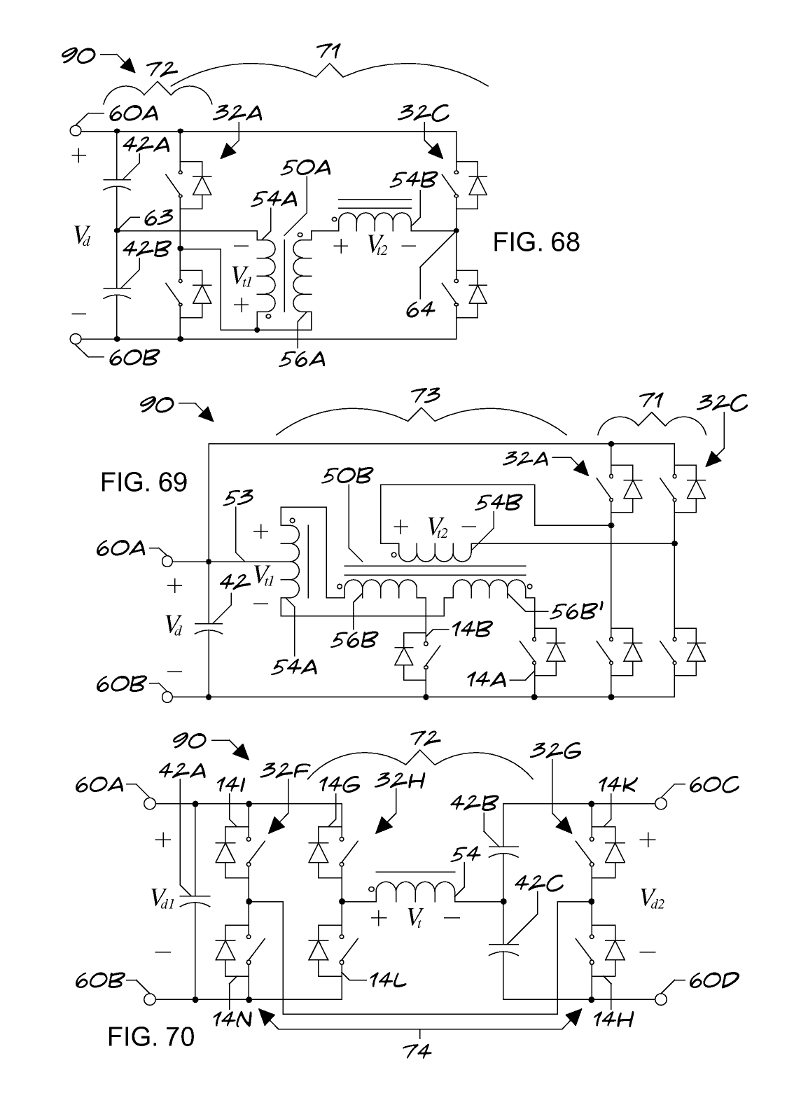

FIG. 67 through FIG. 69 illustrate examples of how the number of secondary windings connected to the secondary circuit 96 can be reduced for converters utilizing multiple high-frequency links. In FIG. 67 the secondary winding 56B of the high-frequency link 50B is connected in series with the primary winding 54A, so that only the secondary winding 56A is connected to the secondary circuit 96. In FIG. 68 the secondary winding 56A of the high-frequency link 50A is connected in series with the primary winding 54B, so that only the secondary winding 56B is connected to the secondary circuit 96. In FIG. 69 the secondary windings 56B and 56B′ of the high-frequency link 50B are connected in series with the primary winding 54A, so that only the secondary winding 56A is connected to the secondary circuit 96. Obviously, the secondary winding 56A or 56B that is connected in series with the primary winding 54A or 54B can be reversed for all three primary circuits in FIG. 67 through FIG. 69. For converters that utilize more levels additional secondary windings can also be connected in series with the primary windings.

For the converters in FIG. 64 through FIG. 69 low load inductors can be connected between the lines 63 and 64 similar to the primary circuit in FIG. 12. Also, while no snubber capacitances are shown in FIG. 64 through FIG. 69, they can be included across each switch, across the primary winding, or across both the switches and the primary winding.

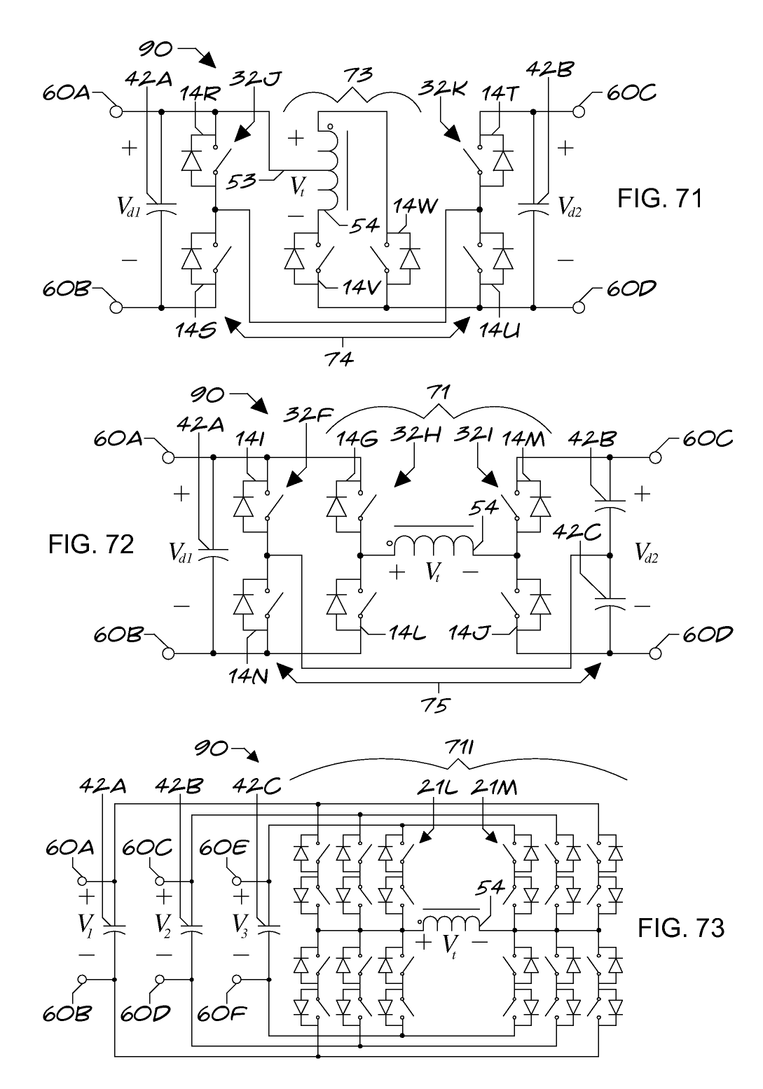

The full-bridge circuit 71 in FIG. 19 can also be replaced with a half-bridge circuit 72 or push-pull circuit 73 as illustrated in FIG. 70 and FIG. 71. The full-bridge circuit 74 can also be replaced with a half bridge circuit 75. FIG. 72 illustrates an example of this where the phase leg 32F of the half-bridge circuit 75 is connected directly to the capacitive elements 42B and 42C. With the half-bridge circuit 72, push-pull circuit 73, or half-bridge circuit 75, if a secondary circuit 96 is utilized that does not allow for control of the duration current is applied to the secondary winding 56 (secondary circuit 96 in FIG. 13 as an example), then only two levels can be applied to the inductive element 46. The switches 14G, 14H, 14I, 14J, 14K, 14L, 14M, and 14N in FIG. 70 and FIG. 72 can operate the same as the switches 14G, 14H, 14I, 14J, 14K, 14L, 14M, and 14N respectively in FIG. 19, but the voltages applied to the primary winding 54 are −V_{d1}−V_{d2}/2, −V_{d2}/2, V_{d2}/2, and V_{d1}+V_{d2}/2. The switches in FIG. 71 can operate with the following logical expressions using the commutation for the switches in FIG. 19 (with current freewheeling in switches 14H and 14J):
14R=14L & 14N; 14S=14I|14G; 14T=14K|14M;
14U=14H & 14J; 14V=14J & 14N; 14W=14H & 14L.
   No snubber capacitances are shown in FIG. 70 through FIG. 72, but they can be included across each switch, across the primary winding, or across both the switches and the primary winding. Similar to previous examples the primary circuit's switches in FIG. 19 and FIG. 70 through FIG. 72 can be swapped with bi-directional switches to create one phase ac primary circuits. However, it is also possible to only swap the switches connected to one of the sources with bi-directional switches. This allows for a primary circuit 90 that integrates a dc source(s) and an ac source(s).

While the phase legs in FIG. 19 and FIG. 70 through FIG. 72 can be changed to switch matrixes that can be extended to multiple ac phases, in many applications it is more appropriate to instead extend the switch matrixes. This is illustrated in FIG. 73 with the bi-directional full-bridge circuit 71I where extra bi-directional switches are added to switch matrixes 21A and 21B of the bi-directional full-bridge circuit 71A in FIG. 25 to form switch matrixes 21L and 21M. No snubber capacitances are shown in FIG. 73, but they can be included across each bi-directional switch, across the primary winding, or across both the bi-directional switches and the primary winding. Similarly, the bi-directional half-bridge circuit 72A in FIG. 62 and the bi-directional push-pull circuit 73A in FIG. 63 can also be extended in a similar manner.

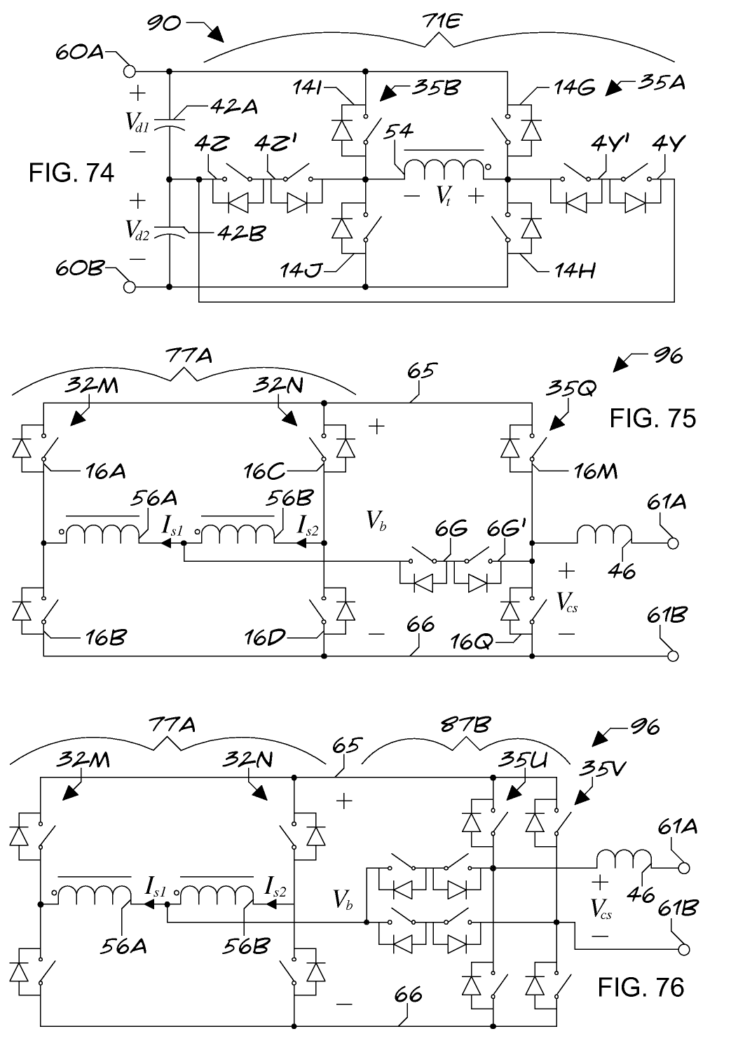

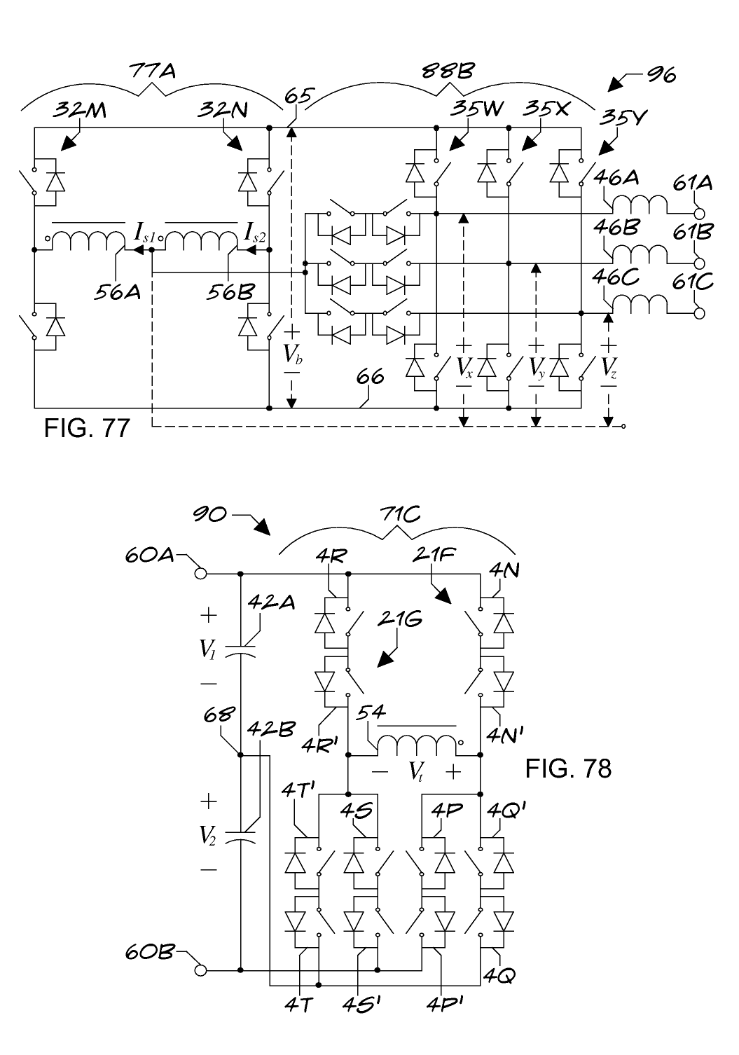

The multilevel phase legs in both the primary circuit 90 in FIG. 40 or FIG. 42A and the secondary circuits 96 in FIG. 32, FIG. 38, and FIG. 43 can be replaced with alternative multilevel phase legs. The alternative multilevel phase leg described herein comprises a phase leg with at least one bi-directional blocking element connected to the interconnection of the two blocking elements of the phase leg (switches 16G and 16H and bi-directional switch 4Y-4Y′ comprise alternative multilevel phase leg 35A as an example). The other end of the bi-directional blocking elements is connected to the interconnection of capacitive elements (42 followed by a suffix) for primary circuits 90 or secondary windings (56 followed by a suffix) for secondary circuits 96. The example primary circuit 90 in FIG. 74 illustrates an alternative multilevel full-bridge circuit 71E that has the primary winding 54 connected between two alternative multilevel phase legs 35A and 35B that are connected to the capacitive elements 42A and 42B. The switches 14G, 14H, 14I, 14J, 4Y, 4Y′, 4Z, and 4Z′ in FIG. 74 operate the same as the switches 14G, 14H, 14I, 14J, 14K, 14L, 14M, and 14N respectively in FIG. 40. No snubber capacitances are shown in FIG. 74, but they can be included across each switch and bi-directional switch, across the primary winding, or across both the switches, the bi-directional switches, and the primary winding. FIG. 75, FIG. 76, and FIG. 77 illustrate examples of replacing the multilevel phase legs of the secondary circuits 96 in FIG. 32, FIG. 38, and FIG. 43 with alternative multilevel phase legs. The switches 16M, 6G, 6G′, and 16Q in FIG. 75 can operate the same as the switches 16M, 16N, 16P, and 16Q respectively in FIG. 32. The operation of the alternative multilevel phase legs 35U, 35V, 35W, 35X, and 35Y in FIG. 76 and FIG. 77 can similarly be derived from the multilevel phase legs 34U, 34V, 34W, 34X, and 34Y. For the alternative multilevel phase leg the number of levels can be increased by adding extra bi-directional switches connected to additional capacitive elements or secondary windings.

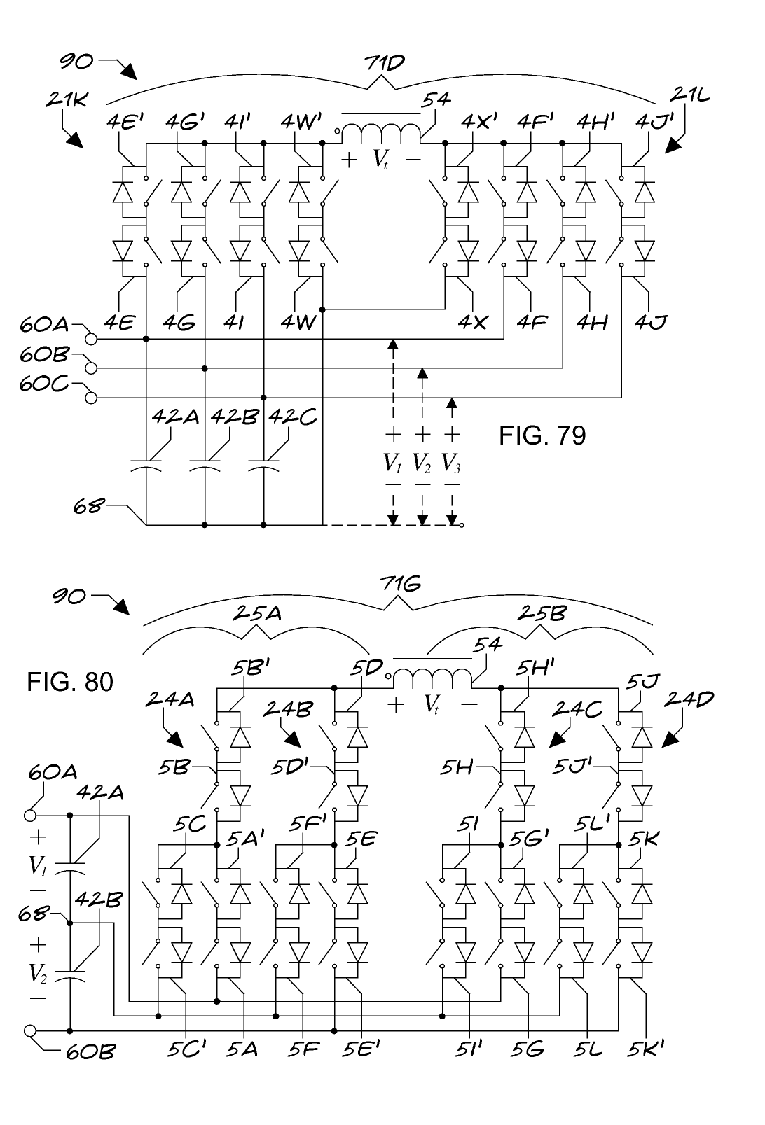

The bi-directional full-bridge circuit 71A in FIG. 25 can be changed to an ac one phase primary circuit 90 of the type in FIG. 3 by adding extra bi-directional switches to one or both of the switch matrixes 21A and 21B. This is illustrated in FIG. 78 with a bi-directional multilevel full-bridge circuit 71C. In the circuit 71C the primary winding 54 is connected between the switch matrixes 21F and 21G. A bi-directional switch in each switch matrix 21F and 21G is connected to each end of the capacitive elements 42A and 42B. Switch matrix 21F comprises bi-directional switches 4N-4N′, 4P-4P′, and 4Q-4Q′, and switch matrix 21G comprises bi-directional switches 4R-4R′, 4S-4S′, and 4T-4T′. A similar ac three phase example is illustrated in FIG. 79. In FIG. 79 the bi-directional switches 4W-4W′ and 4X-4X′ are added to switch matrixes 21C and 21D respectively to form switch matrixes 21K and 21L respectively. If V₁, V₂, and V₃ are never all equal, as in most ac applications, the bi-directional multilevel full-bridge circuit 71D is a multilevel circuit. If these voltages can be equal, the capacitive elements 42A, 42B, and 42C in FIG. 26 are split into two capacitive elements, and three bi-directional switches are added to each switch matrix 21C and 21D between each split in the capacitive elements and the primary winding 54. No snubber capacitances are shown in FIG. 78 and FIG. 79, but they can be included across each bi-directional switch, across the primary winding, or across both the bi-directional switches and the primary winding. For the switch matrixes the number of levels can be increased by adding extra bi-directional switches to each switch matrix. Each extra bi-directional switch is connected between the primary winding 54 and the interconnection of additional capacitive elements (i.e. further splitting the capacitive elements).

If V_{ac} is positive for the bi-directional multilevel full-bridge circuit 71C, the switches 4N, 4P, 4Q, 4Q′, 4R, 4S, 4T, and 4T′ in FIG. 78 can operate the same as switches 14G, 14H, 4Y, 4Y′, 14I, 14J, 4Z, and 4Z′ respectively in FIG. 74, and switches 4N′, 4P′, 4R′, and 4S′ in FIG. 78 are continuously on. If V_{ac} is negative, the functions of switches 4N′, 4P′, 4Q′, 4R′, 4S′, and 4T′ are swapped with switches 4R, 4S, 4T, 4N, 4P, and 4Q respectively in FIG. 78. The bi-directional multilevel full-bridge circuit 71D in FIG. 79 operates similar to the circuit 71B in FIG. 26, but if bi-directional switch 4M-4M′ or 4N-4N′ are on, the voltage across a single capacitive element can also be applied to the primary winding 54. For the circuits in FIG. 25, FIG. 26, and FIG. 78 through FIG. 81 the neutral of the ac sources can be connected to the connection 68. For the converters in FIG. 78 through FIG. 81 connecting the neutral to connection 68 allows the converter to compensate for large ac phase unbalance, or to allow for continued operation after the loss of a phase(s).

The bi-directional full-bridge circuit 71A in FIG. 25 can also be changed to an ac one phase primary circuit 90 of the type in FIG. 3 by replacing one or both of the switch matrixes 21A and 21B with a switch string matrix. This is illustrated in FIG. 80 with the switch string full-bridge circuit 71G. Each switch string matrix comprises at least two bi-directional switch strings (switch string matrix 25A comprises switch strings 24A and 24B as an example). Each switch string comprises two or more series connected bi-directional switches (bi-directional switches 5A-5A′ and 5B-5B′ in switch string 24A as an example) with at least one bi-directional switch (bi-directional switches 5C-5C′ in switch string 24A as an example) connected between each interconnection of these switches. For the circuit 71G in FIG. 80 the primary winding 54 is connected between the switch string matrixes 25A and 25B. The switch strings 24A and 24B are connected between the primary winding 54 and the non-common ends of the capacitive elements 42A and 42B (similar connections made for switch strings 24C and 24D). The switches 5C-5C′ and 5F-5F′ in both switch strings 24A and 24B are connected to the interconnection of the capacitive elements 42A and 42B (similar connections made for switch strings 24C and 24D). Two options can be utilized for increasing the number of levels for a switch string matrix. The first option is similar to the switch matrix in that additional switch strings can be added to each switch string matrix. Each additional switch string is connected between the primary winding 54 and the interconnection of additional capacitive elements (i.e. further splitting the capacitive elements). The second option is to increase the number of series connected switches in each switch string. In this second option the bi-directional switches connected between the added series switches are connected to the additional capacitive elements (i.e. from further splitting the capacitive elements).

If V_{ac} is positive for the circuit 71G, the switches 5A, 5B, 5D, 5E, 5G, 5H, 5J, and 5K in FIG. 80 can operate the same as switches 14G, 14K, 14L, 14H, 14I, 14M, 14N, and 14J respectively in FIG. 40, switches 5A′, 5B′, 5C′, 5D′, 5E′, 5F′, 5G′, 5H′, 5I′, 5J′, 5K′, and 5L′ in FIG. 80 are continuously on, and switches 5C, 5F, 5I, and 5L in FIG. 80 are continuously off. If V_{ac} is negative, the functions of switches 5A′, 5B′, 5C′, 5D′, 5E′, 5F′, 5G′, 5H′, 5I′, 5J′, 5K′, and 5L′ are swapped with switches 5G, 5H, 5C, 5J, 5K, 5F, 5A, 5B, 5I, 5D, 5E, and 5L respectively in FIG. 80.

An example of the switch string matrixes utilized for ac three phase is illustrated in FIG. 81. For the switch string full-bridge circuit 71H in FIG. 81 the primary winding 54 is connected between the switch string matrixes 25C and 25D. The switch string matrix 25C comprises switch strings 24E, 24G, and 24I, and switch string matrix 25D comprises switch strings 24F, 24H, and 24J. A bi-directional switch in each switch string is connected to the common connection of the capacitive elements 42A, 42B, and 42C. If V₁, V₂, and V₃ are never all equal as in most ac applications, circuit 71H is a multilevel circuit. If these voltages can be equal, the capacitive elements 42A, 42B, and 42C in FIG. 81 are split into two capacitive elements, and one of the options for increasing the number of levels for a switch string matrix is utilized. If the second option is utilized, it is necessary to include two bi-directional switches (as opposed to one) connected to the bi-directional switch added to each switch string. Two bi-directional switches are utilized since each one of the switches must be connected to a different split in the capacitive elements in the two phases the end of the switch string is not connected to. The primary circuit 90 in FIG. 81 can operate with similar principles to the primary circuits 90 in FIG. 26 and FIG. 80. No snubber capacitances are shown in FIG. 80 and FIG. 81, but they can be included across the primary winding, across the bi-directional switches in a manner described herein for multilevel phase legs, or a combination of both of these.

The mixed leg circuit 77D in FIG. 82 is an example alternative to the secondary circuit 96 in FIG. 20. The mixed leg circuit 77D comprises the secondary windings 56A and 56B of high-frequency links 50A and 50B respectively connected in series between a phase leg 32L and a bi-directional phase leg 22Q (illustrated with the bi-directional phase leg 22Q as the right leg in FIG. 82). Both the phase leg 32L and the bi-directional phase leg 22Q are connected to the inductive element 46. To describe an example commutation of series stack circuit 77B, three additional logic signals x, y, and d are utilized based on the commutation of the secondary circuit 96 in FIG. 21 through FIG. 24A-H′. The logic signal x is in the on state when the primary winding voltage(s) transitions from positive to negative voltage, and otherwise is in the off state. The logic signal y is in the on state when the primary winding voltage(s) transitions from negative to positive voltage, and otherwise is in the off state. The logic signal d is in the off state when power transfers from the secondary circuit (i.e. current in inductive element 46 is negative or towards the secondary circuit 96), and otherwise is in the on state. The switches and bi-directional switches in FIG. 82 can operate with the following logical expressions using the defined logic signals and the commutation for the switches in FIG. 20:
16R=16A|16H; 16S=16B|16H;
6H=˜y & (d & ˜x & ˜p|˜d & 16B); 6I=˜x & (d & ˜y & p|˜d & 16A);
6H′=d & ˜x & (p|y|16G)|˜d & ˜y & (p|x|16G);
6I′=d & ˜y & (˜p|x|16G)|˜d & ˜x & (˜p|y|16G).
   All of the switches in mixed leg circuit 77C operate at the same switching frequency as opposed to switches 16G and 16H in FIG. 20 that operate at twice the switching frequency of the other switches.

Connecting the mixed leg circuit 77C to a phase leg 32Q that is connected to the inductive element 46 is an example alternative to the secondary circuit 96 in FIG. 6. The switches and bi-directional switches in FIG. 83 can operate with the following logical expressions using the previously defined logic signal d and the commutation for the switches and bi-directional switches in FIG. 6:
6E=6C; 6E′=6C′; 6F=6D; 6F′=6D′;
16G=d & ((6A & 6A′)|(6B & 6B′))|˜d & (˜16E|˜16F);
16H=d & (˜6A|˜6A′) & (˜6B|˜6B′)|˜d & 16E & 16F; 16I=6A|(16F & 6B′);
16J=6B|(16E & 6A′); 16K=d & 16E & ˜16F|˜d & ˜6A′ & ˜6C′;
16L=d & 16F & ˜16E|˜d & ˜6B′ & ˜6D′.

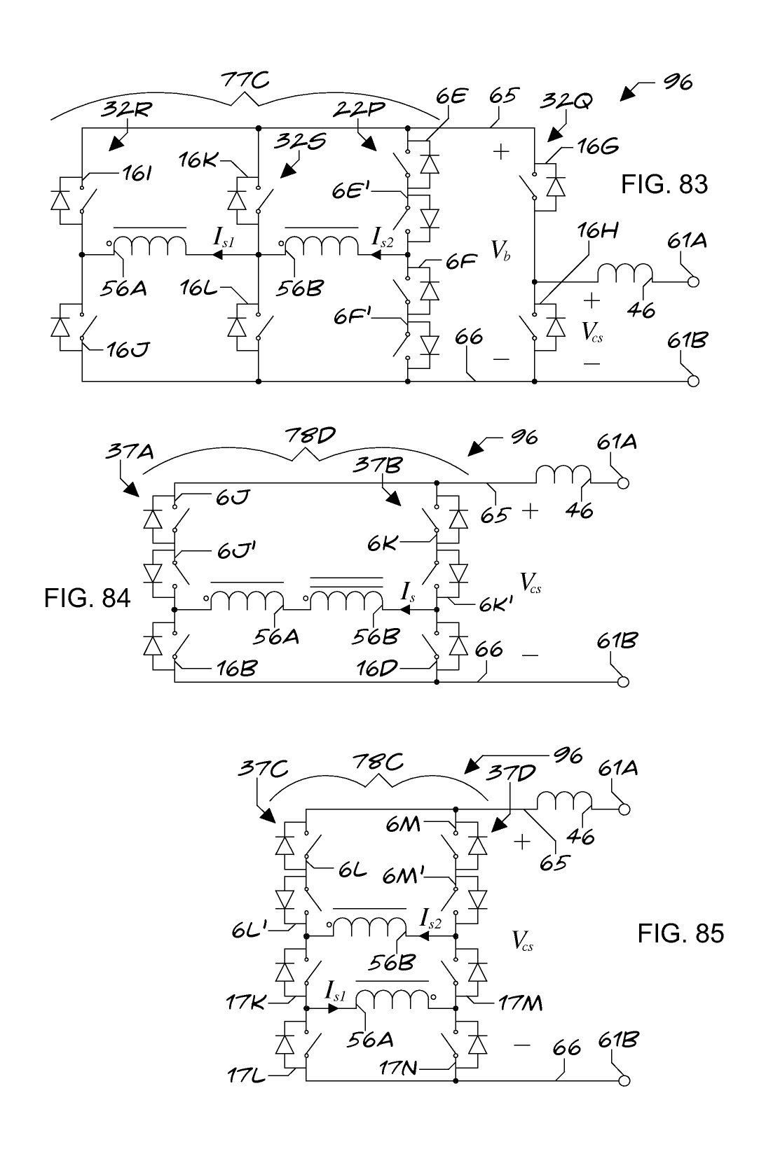

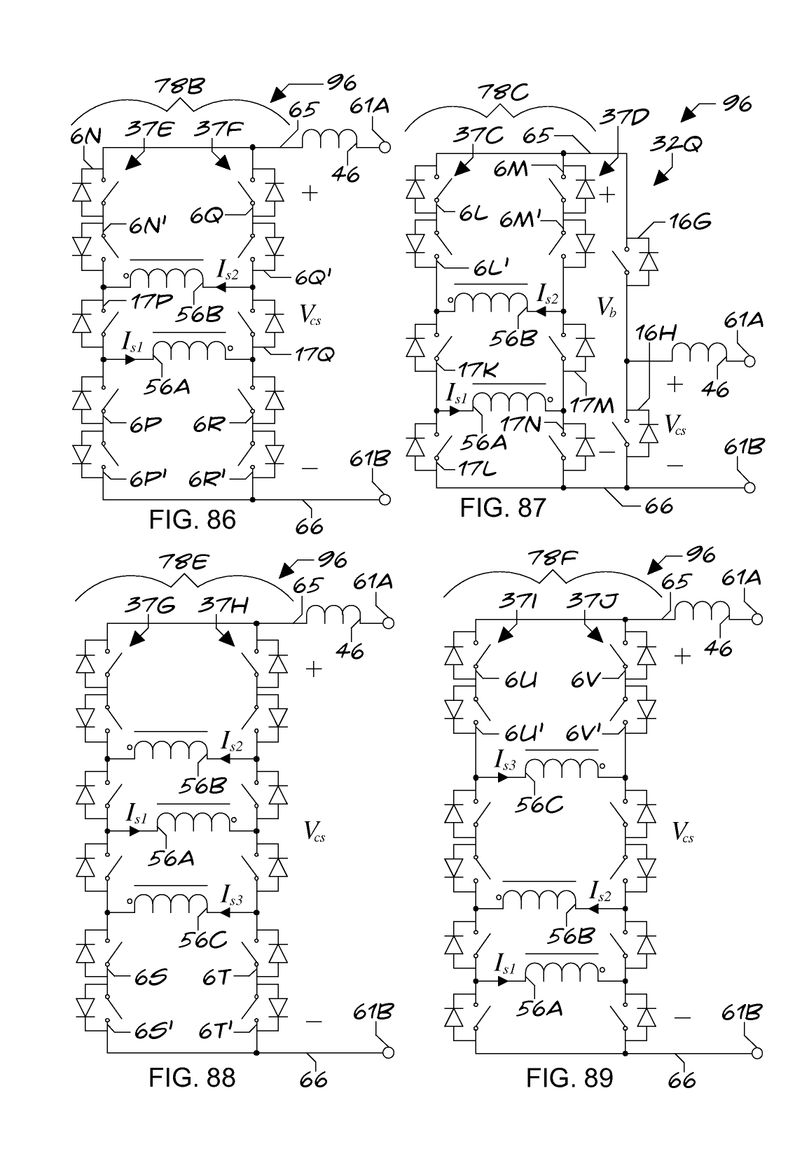

The mixed leg and full-bridge circuits (77 followed by a suffix) can be replaced with series stack circuits (78 followed by a suffix). The secondary circuits 96 in FIG. 84, FIG. 85, FIG. 86, and FIG. 87 are example series stack versions of the secondary circuits 96 in FIG. 82, FIG. 27, FIG. 6, and FIG. 83 respectively. The series stack circuit 78D in FIG. 84 comprises the secondary windings 56A and 56B of high-frequency links 50A and 50B respectively connected in series between two series stacks 37A and 37B that are connected to the inductive element 46. Each series stack comprises a series connection of a switch element and at least one bi-directional blocking element (series stack 37A in FIG. 84 comprises switch 16B and bi-directional switch 6J-6J′ as an example). Additionally, a second blocking element can be connected in series and adjacent to the switch in the series stack (series stack 37C in FIG. 85 comprises switches 17K and 17L and bi-directional switch 6L-6L′ as an example). The two series stacks in the series stack circuits (78 followed by a suffix) are typically identical. The series stack circuit 78C in FIG. 85 comprises the secondary windings 56A and 56B connected between two different levels of the series stacks 37C and 37D. The series stack circuit 78C is connected to the inductive element 46. The series stack circuit 78B in FIG. 86 comprises the secondary windings 56A and 56B connected between two different levels of the series stacks 37E and 37F. The series stack circuit 78B is connected to the inductive element 46. The secondary circuit 96 in FIG. 87 comprises the series stack circuit 78C connected to a phase leg 32Q that is connected to the inductive element 46. For the series stack circuits (78 followed by a suffix) the number of levels can be increased by adding extra secondary windings that are connected between additional bi-directional switches added to the top or bottom of the series stacks. FIG. 88 and FIG. 89 illustrate examples (series stack circuits 78E and 78F) of adding an extra secondary winding 56C to the circuit 78C in FIG. 85. In FIG. 88 the bi-directional switches 6S-6S′ and 6T-6T′ are added to the bottom of the series stacks 37G and 37H, while in FIG. 89 the bi-directional switches 6U-6U′ and 6V-6V′ are added to the top of the series stacks 37I and 37J. The main advantages of the series stack circuits are that the voltage rating of some of the blocking elements is less and loss in the blocking elements is more evenly distributed.

The switches and bi-directional switches in FIG. 84 can operate with the following logical expressions using the previously defined logic signals and the commutation for the switches and bi-directional switches in FIG. 20 and FIG. 82:
6J=d & ˜y & (p|x|16H)|˜d & ˜x & (p|y|16H); 6J′=6I′;
6K=d & ˜x & (˜p|y|16H)|˜d & ˜y & (˜p|x|16H); 6K′=6H′;
16B=16B; 16D=16D.
   The switches and bi-directional switches in FIG. 85 can operate with the following logical expressions using the commutation for the switches and bi-directional switches in FIG. 27:
6M=˜6F′; 6M′=6E′|˜16J; 6L=˜6E′; 6L′=6F′|˜16I;
17K=16J; 17L=16I; 17M=16I; 17N=16J.
   The switches and bi-directional switches in FIG. 86 can operate with the following logical expressions using the commutation for the switches and bi-directional switches in FIG. 6:
6N=˜6C′; 6N′=6B & ˜6B′|6D′|˜16F; 6P=˜6B′;
6P′=6B & ˜6B′|6A′|˜16F; 6Q=˜6D′; 6Q′=6A & ˜6A′|6C′|˜16E;
6R=˜6A′; 6R′=6A & ˜6A′|6B′|˜16E;
17P=16E & 6A′|6B; 17Q=16F & 6B′|6A.
   The switches and bi-directional switches in FIG. 87 can operate with the following logical expressions using the commutation for the switches and bi-directional switches in FIG. 83 and FIG. 86:
6L=6N; 6L′=6N′; 6M=6Q; 6M′=6Q′; 16G=16G;
16H=16H; 17K=16J; 17L=16I; 17M=16I; 17N=16J.

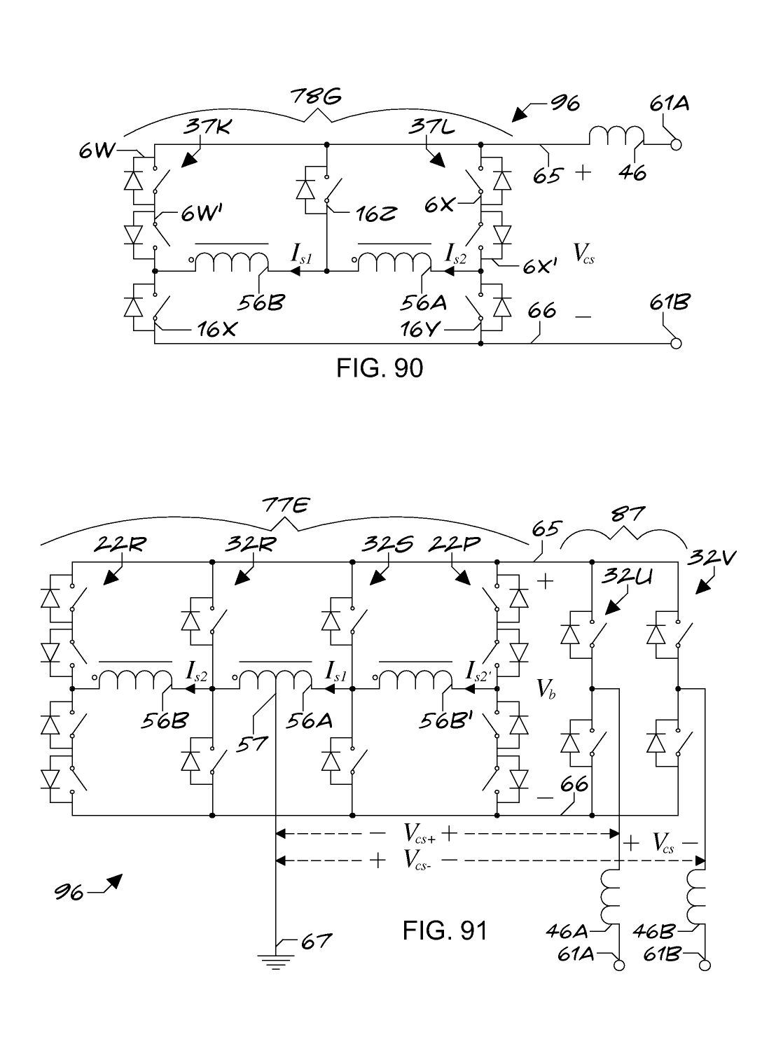

If a switch 16Z is added between the positive line 65 and the interconnection of secondary windings 54A and 54B of the secondary circuit 96 in FIG. 90, another series stack circuit is possible. The series stack circuit 78G operates similar to the secondary circuits 96 in FIG. 27 and FIG. 85, but the example commutation method alternates between the secondary windings 56A and 56B as the winding that has current applied to it for a longer duration. The switches and bi-directional switches in FIG. 90 can operate with the following logical expressions using the commutation for the switches and bi-directional switches in FIG. 27 and FIG. 86:
6W=6F|16I & 16K; 6W′=6F′; 6X=6E|16J & 16L; 6X′=6E′;
16X=16J & ˜16L; 16Y=16I & ˜16K; 16Z=16K|16L.
   If the series stacks 37K and 37L are rearranged (switch and bi-directional switch positions swapped), the switch 16Z is instead connected between the interconnection of the secondary windings 56A and 56B and the negative line 66.

For the example ac secondary circuits 96 in FIG. 37 through FIG. 39, and FIG. 43, the full-bridge circuit 77A can be replaced with mixed leg circuits (77 followed by a suffix) or series stack circuits (78 followed by a suffix). In some ac applications it is desired for there to be a converter connection to the center-tap 57 of the secondary windings (56 or 56 followed by a suffix). This connection is connected to a neutral or ground point. Connecting a neutral point 67 to the center-tap 56 of the secondary winding 56 is particularly useful if phase unbalance can occur in the inductive elements of a one or greater phase ac application. It is necessary to modify some of the example secondary circuits 96 to create a center-tap 53. For the full-bridge circuit 77A in FIG. 39 it is typical to use split secondary windings 56B and 56B′ (both having the same turns ratios) of the high-frequency link 50B. For the mixed leg circuit 77C in FIG. 27 it is typical to use split secondary windings 56B and 56B′ (both having the same turns ratios) and an additional bi-directional phase leg 22R as illustrated in FIG. 91. If no neutral connection is made to the converter, these modifications are not utilized (i.e. FIG. 39 uses only secondary winding 56B, and circuit 77E is swapped with circuit 77C). For one phase ac secondary circuits with a neutral point connection 67, like in FIG. 91, the secondary circuit 96 is typically treated as a two phase circuit and uses the example commutation methods described herein for the multiphase ac secondary circuits. An alternative option to deal with phase unbalance is to include an additional phase leg connected to the neutral point 67. Examples are illustrated in FIG. 92 and FIG. 93 with the extra phase legs 32T and 32Z added to the modified secondary circuits 96 from FIG. 91 and FIG. 39 respectively. An additional inductance (inductive element) can also be included between the switches and the neutral point 67. The commutation method for the additional phase legs (such as phase legs 32T and 32Z) follow the same principles already set forth herein.

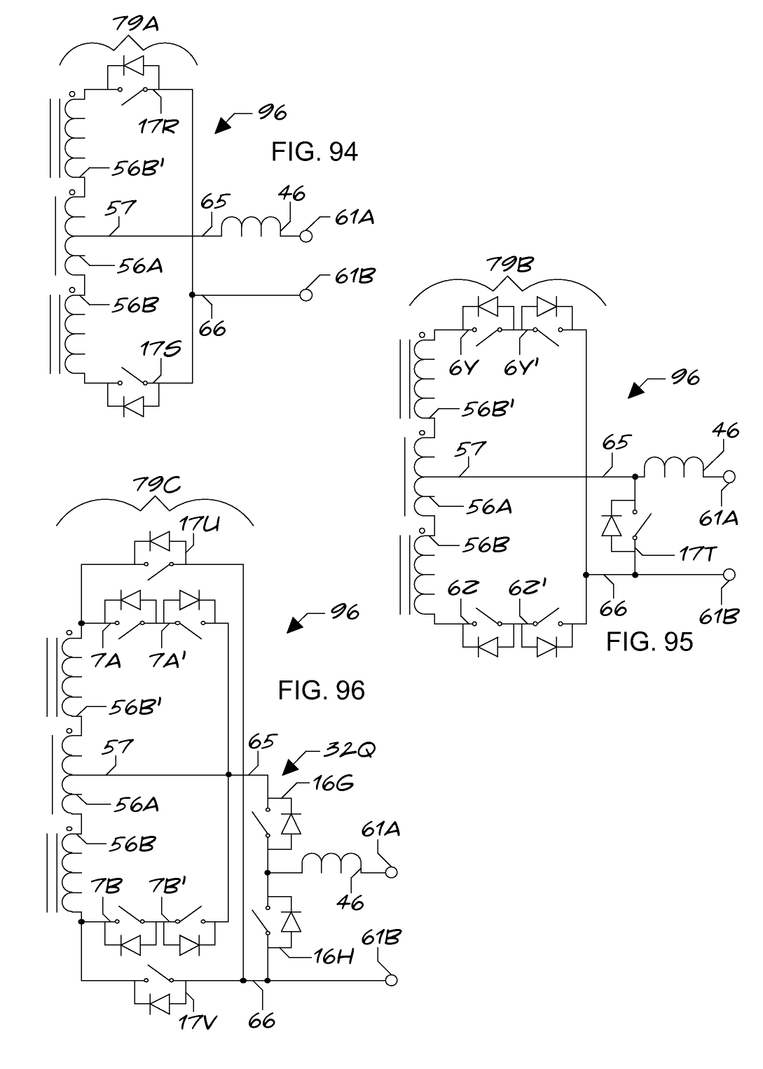

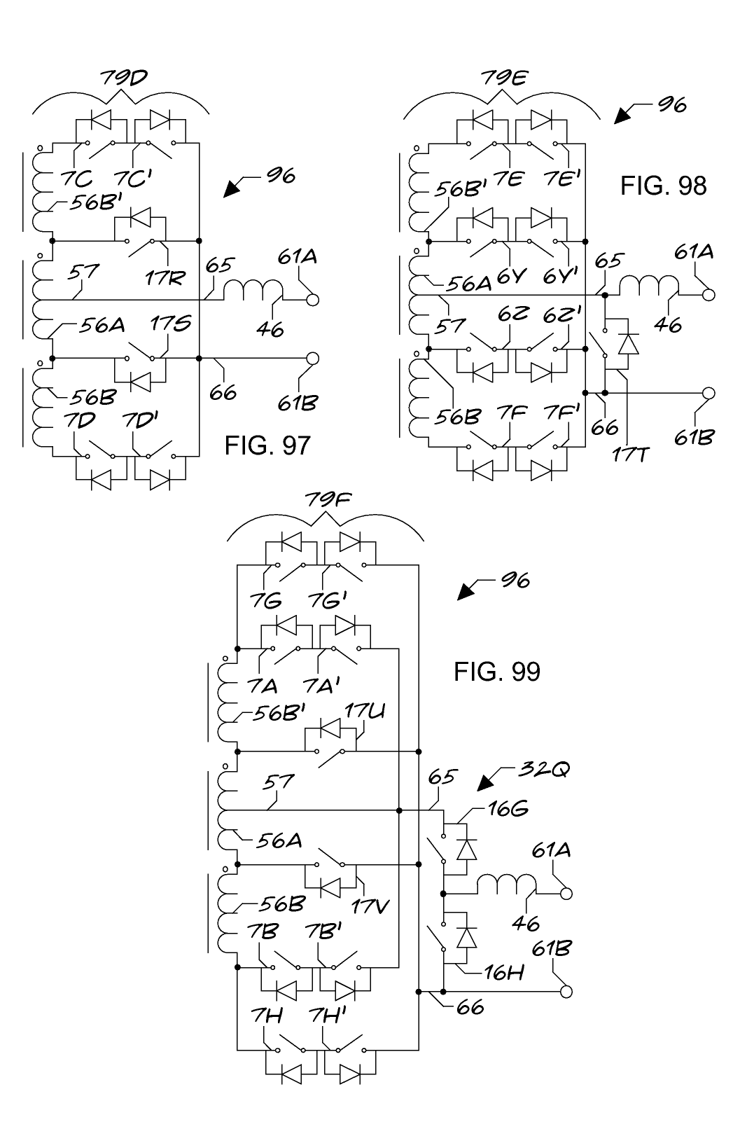

The secondary circuits 96 in FIG. 94 through FIG. 99 replace the mixed leg and full-bridge circuits (77 followed by a suffix) with center-tap type circuits (79 followed by a suffix) that all include connections to a center-tap 57 of the secondary windings (56 or 56 followed by a suffix). The center-tap circuit 79A in FIG. 94 comprises the secondary windings 56A, 56B, and 56B′ connected in series between two switches 17R and 17S. The center-tap circuit 79A in FIG. 94 is connected to the inductive element 46. The center-tap circuit 79B in FIG. 95 comprises the secondary windings 56A, 56B, and 56B′ connected in series between bi-directional switches 6Y-6Y′ and 6Z-6Z′. The center-tap circuit 79B in FIG. 95 is connected to the inductive element 46, and a switch 17T is connected between the positive line 65 and negative line 66 of the secondary circuit 96. The center-tap circuit 79C in FIG. 96 comprises the secondary winding 56A, 56B, and 56B′ connected in series between switches 17U and 17V and also bi-directional switches 7A-7A′ and 7B-7B′. Bi-directional switches 7A-7A′ and 7B-7B′ are also connected to the center-tap 57 of the secondary windings. The center-tap circuit 79C in FIG. 96 is connected to the phase leg 32Q that is connected to the inductive element 46. The center tap circuits 79A, 79B, and 79C in FIG. 94 through FIG. 96 are appropriate secondary circuits 96 for the example converters 11 in FIG. 2 and FIG. 3. The center-tap circuits 79D, 79E, and 79F in FIG. 97 through FIG. 99 illustrate how these secondary circuits 96 can be modified for the example converter 11 in FIG. 1 by adding a secondary winding and bi-directional switch to both sides of the center-tap circuits 79A, 79B, and 79C. Due to the changes from circuit 79C in FIG. 96 to circuit 79F in FIG. 99, the bi-directional switches 7A-7A′ and 7B-7B′ are connected to the ends of the string of secondary windings 56A, 56B, and 56B′. For the center-tap circuits (79 followed by a suffix) the number of levels is increased by adding even more pairs of secondary windings and bi-directional switches. If the blocking element orientations are reversed for the center tap circuits (79 followed by a suffix) in FIG. 94 through FIG. 99, the center-tap 57 can be utilized as the negative line 66.

In FIG. 94 switches 17R and 17S can operate the same as switches 16B and 16A respectively in FIG. 13. The switches and bi-directional switches in FIG. 95 and FIG. 96 can operate with the following logical expressions using the previously defined logic signals and the commutation for the switches and bi-directional switches in FIG. 20 and FIG. 82:
6Y=6H; 6Y′=6H′; 6Z=6I; 6Z′=6I′; 17T=16H|(16A & 16B);
7A=˜d & 16B & (p|x|16G); 7A′=d & 16A & (˜p|y|16H);
7B=d ˜& 16A & (˜p|y|16G); 7B′=d & 16B & (|p|x|16H);
16G=16G; 16H=16H; 17U=˜p & ˜y; 17V=p & ˜x.
   The switches and bi-directional switches in FIG. 97 can operate with the following logical expressions using the commutation for the switches and bi-directional switches in FIG. 27:
7C=6E; 7C′=6E′; 7D=6F; 7D′=6F′;
17R=16J & 6F′|16K; 17S=16I & 6E′|16L.
   The switches and bi-directional switches in FIG. 98 can operate with the following logical expressions using the commutation for the switches and bi-directional switches in FIG. 6:
7E=6C; 7E′=6C′; 7F=6D; 7F′ 6D′; 6Y=6C & ˜6C′;
6Y′ 6B′; 6Z=6D & ˜6D′; 6Z′ 6A′; 17T=16E & 16F.
   The switches and bi-directional switches in FIG. 99 can operate with the following logical expressions using the previously defined logic signal d and the commutation for the switches and bi-directional switches in FIG. 83:
7G=6E; 7G′=6E′; 7H=6F; 7H′=6F′; 7A=˜d & 6E & 6E′;
7A′=d & 16I & 6E′; 7B=˜d & 6F & 6F′; 7B′=d & 16J & 6F′;
16G=16G; 16H=16H; 17U=6E & 16K; 17V=6F & 16L.

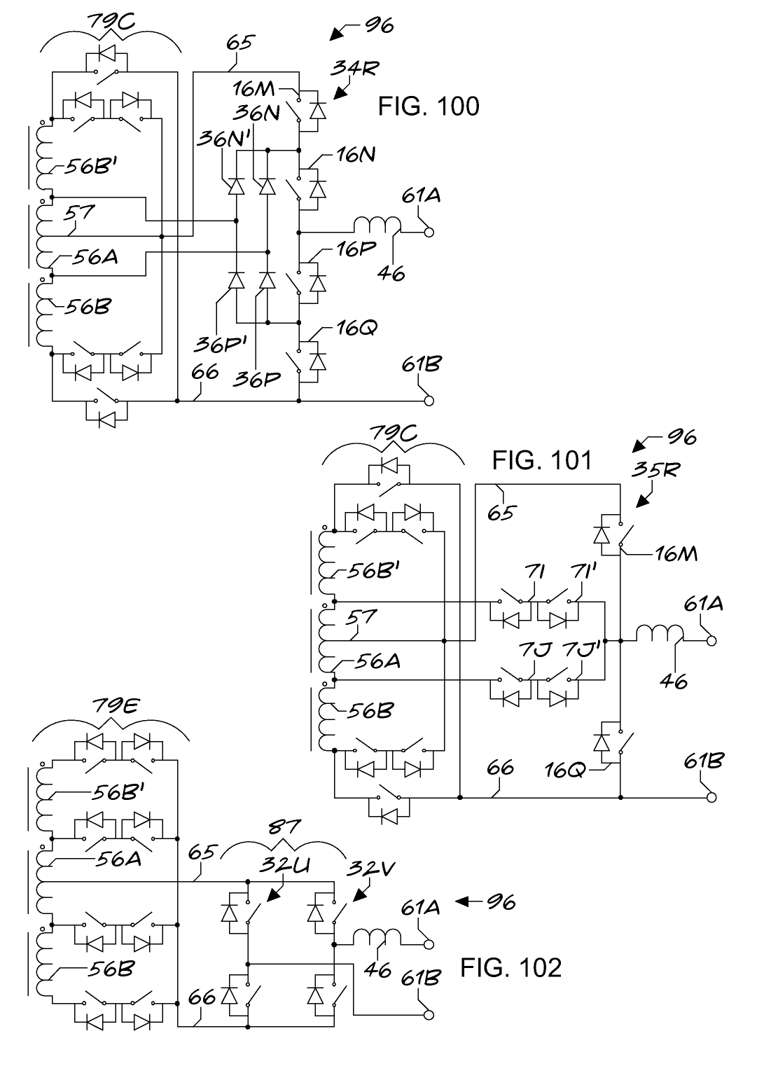

The multilevel phase legs and alternative multilevel phase legs can also be utilized with the center-tap type circuits (79 followed by a suffix) as illustrated with the example secondary circuits 96 in FIG. 100 and FIG. 101. In FIG. 100 the multilevel phase leg 34R utilizes both pairs of diodes (diodes 36N, 36N′, 36P, and 36P′ in FIG. 100) since there are always an odd number of secondary windings with the center-tap circuits (79 followed by a suffix). The commutation method for the multilevel phase leg 34R in FIG. 100 can be the same as for the multilevel phase leg 34Q in FIG. 32. For center-tap circuits (79 followed by a suffix) the alternative multilevel phase leg utilizes twice as many bi-directional switches connected to the secondary windings (bi-directional switches 7I-7I′ and 7J-7J′ in FIG. 101 as an example). The commutation method for the alternative multilevel phase leg 35R in FIG. 101 can be the same as for the alternative multilevel phase leg 35Q in FIG. 75, except that the bi-directional switch 7I-7I′ or 7J-7J′ that operates the same as 6G-6G′ in FIG. 75 is determined by the voltage polarity of the primary winding 54.

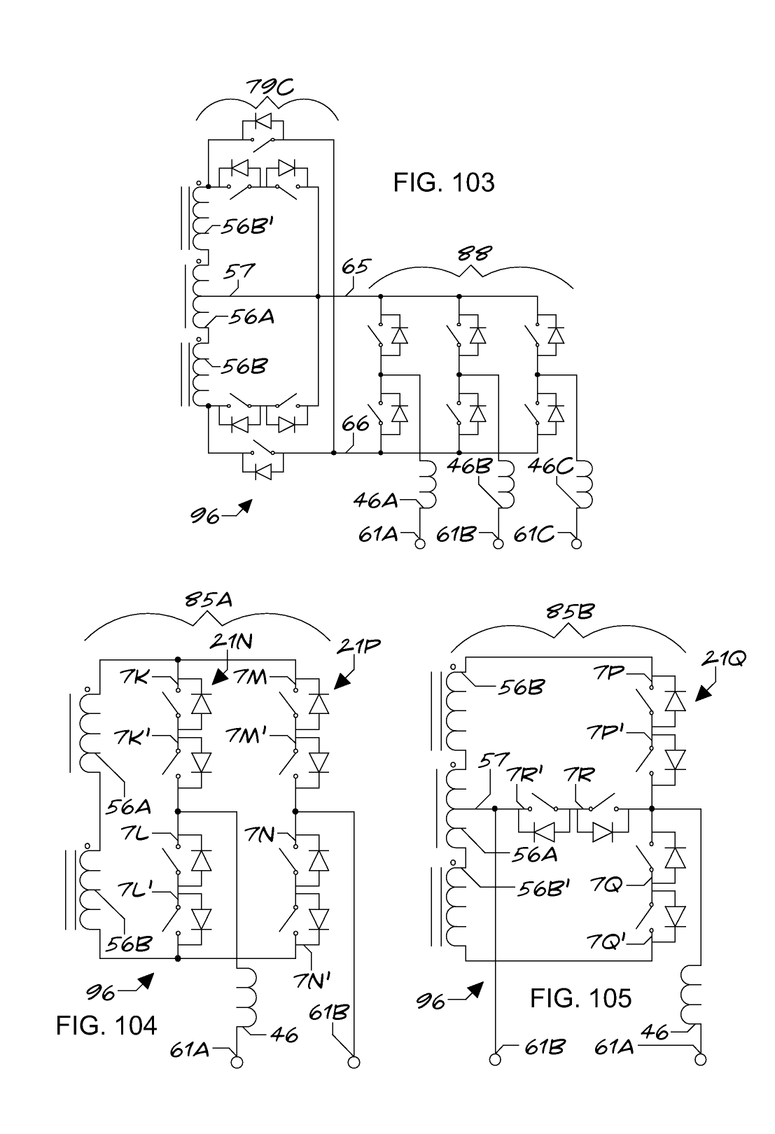

The center-tap circuits in FIG. 94 through FIG. 99 can also replace the full-bridge circuit 77A in one phase ac or multiple phase secondary circuits 96 as illustrated with two examples in FIG. 102 and FIG. 103. If the center-tap circuit 79B or 79E is utilized, the phase legs connected to the positive line 65 and negative line 66 (phase legs 32U and 32V in FIG. 102 as an example) operate slightly different since they also provide the short-circuit of the secondary windings (56 or 56 followed by a suffix), or a switch like 17T in FIG. 95 is included to short-circuit the secondary windings (56 or 56 followed by a suffix). Otherwise the ac portions of the circuits (87 and 88 or 87 and 88 followed by a suffix) can operate the same as already described herein.

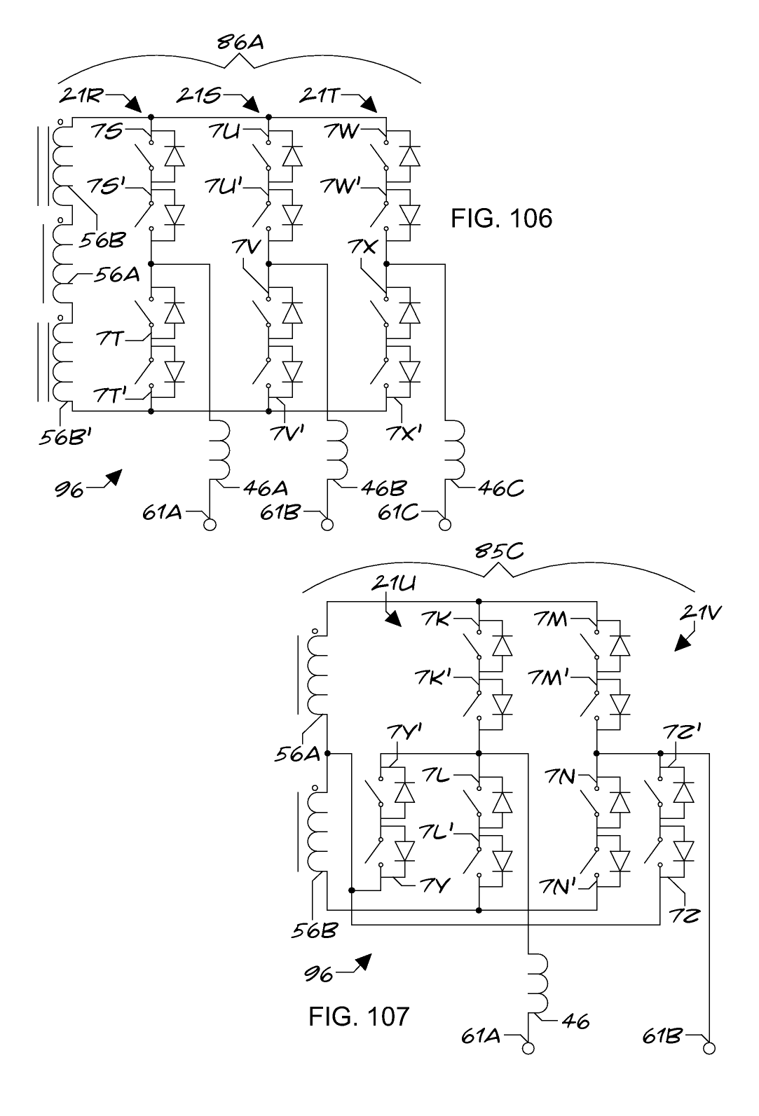

The secondary circuits 96 in FIG. 104, FIG. 105, and FIG. 106 are cycloconverter versions of the secondary circuits 96 in FIG. 37, a center-tap version of FIG. 37, and FIG. 39 respectively. In FIG. 104 the inductive element 46 is connected to a cycloconverter 85A comprising two switch matrixes 21N and 21P that are connected across the secondary windings 56A and 56B. In FIG. 105 the inductive element 46 is connected to a cycloconverter 85B comprising a switch matrix 21Q connected across the secondary windings 56A, 56B, and 56B′. The bi-directional switch 7R-7R′ of the switch matrix 21Q is connected to the center-tap 57 of the secondary windings 56A, 56B, and 56B′. In FIG. 106 the cycloconverter 86A comprises three switch matrixes 21R, 21S, and 21T connected across the secondary windings 56A, 56B, and 56B′. The switch matrixes 21R, 21S, and 21T are connected to the inductive elements 46A, 46B, and 46C. Additional switch matrixes can be added to the cycloconverters 85A, 85B, and 86A to increase the number of inductive elements connected to the secondary circuit 96.

All of the example commutation methods described for the secondary circuits 96 in FIG. 37 and FIG. 39 are also applicable to the example cycloconverters 85A, 85B, and 86A in FIG. 104, FIG. 105, and FIG. 106. The bi-directional switches in FIG. 104, FIG. 105, and FIG. 106 can operate with the following logical expressions using the previously defined logic signals and the commutation for the switches in FIG. 37 and FIG. 39:
7K=17A|16B; 7K′=17C|16A; 7L=17B|16B; 7L′=17D|16A;
7M=17C|16B; 7M′=17A|16A; 7N=17D|16B; 7N′=17B|16A;
7P=(17A & 17D)|˜p; 7P′=(17B & 17C)|p; 7R (17B|17C)|(16A & 16B);
7Q=(17B & 17C)|˜p; 7Q′=(17A & 17D)|p; 7R′ (17A|17D)|(16A & 16B);
7S=17E|16B; 7S′=17F|16A; 7T=17F|16B; 7T′=17E|16A;
7U=17G|16B; 7U′=17H|16A; 7V=17H|16B; 7V′=17G|16A;
7W=17I|16B; 7W′=17J|16A; 7X=17J|16B; 7X′=17I|16A.
   If the more advantageous commutation method for the example circuit 87 in FIG. 37 is not utilized for the cycloconverter 85B in FIG. 105, the bi-directional switch 7R-7R′ is not required.

The switch matrixes in the example cycloconverters 85A, 85B, and 86A can be alternatively commutated to decrease the loss during some of the zero current switch transitions. For circuits 87 and 88 in FIG. 37 and FIG. 39 there is flexibility in the phase leg switch transitions that occur between the polarity changes of the primary winding(s), but with this alternative commutation method both switches in a phase leg would be on for an overlap time. The overlap time will typically be long enough that it allows the secondary winding current, Iₛ, to adjust to the value of current for the new switch state. This overlap time causes the alternative commutation to be more complex to implement. To describe the alternative commutation three additional logic signals i, a, and b are utilized. A logic signal i is utilized for each switch matrix, and is in the on state when the current in the inductive element connected to the switch matrix is positive (i.e. away from the switch matrix), and otherwise is in the off state. When the primary winding(s) voltage(s) is positive, the logic signal a is in the on state from the short-circuit of the secondary winding until the secondary winding current, Iₛ, adjusts to the value of current for the new switch state. When the primary winding(s) voltage(s) is negative, the logic signal b is in the on state from the short-circuit of the secondary winding until the secondary winding current, Iₛ, adjusts to the value of current for the new switch state. With the defined logic signals and the example commutation of the switches in FIG. 39 utilizing an overlap time, the alternative commutation is described for the switch matrix 21R in FIG. 106 with the logical expressions:
7S=i & (p & 17E|˜p & 17F)|˜i & (a|p & ˜17F|˜p & ˜17E);
7S′=i & (b|p & ˜17F|˜p & ˜17E)|˜i & (p & 17E|˜p & 17F);
7T=i & (a|p & ˜17E|˜p & ˜17F)|˜i & (p & 17F|˜p & 17E);
7T′=i & (p & 17F|˜p & 17E)|˜i & (b|p & ˜17E|˜p & ˜17F);
   The terms in the logical expressions that include ˜17E and ˜17F are optional (these terms reduce the conduction loss with some semiconductor technologies). The logical expression for each of the switch matrixes in cycloconverters 85A, 85B, and 86A will be of a similar form.

The cycloconverter circuits 85A, 85B, and 86A are appropriate for converters utilizing multiple high-frequency links and or multiple primary side capacitive elements. The example cycloconverter circuits 85A, 85B, and 86A can be changed to a converter utilizing multiple independently controlled secondary windings by adding an extra bi-directional switch to at least one of the switch matrixes. An example secondary circuit 96 is illustrated with the cycloconverter circuit 85C in FIG. 107. In the circuit 85C bi-directional switches 7Y-7Y′ and 7Z-7Z′ are added to switch matrixes 21N and 21P respectively in FIG. 104 to form the switch matrixes 21U and 21V. For the switch matrixes the number of levels can be increased by adding extra bi-directional switches to each switch matrix. Each extra bi-directional switch is connected between the inductive element 46 and the interconnection of additional secondary windings. The commutation methods for the multilevel switch matrixes 21U and 21V are analogous to a mix of those for the switch matrixes in FIG. 104 and the secondary circuit 96 in FIG. 76.

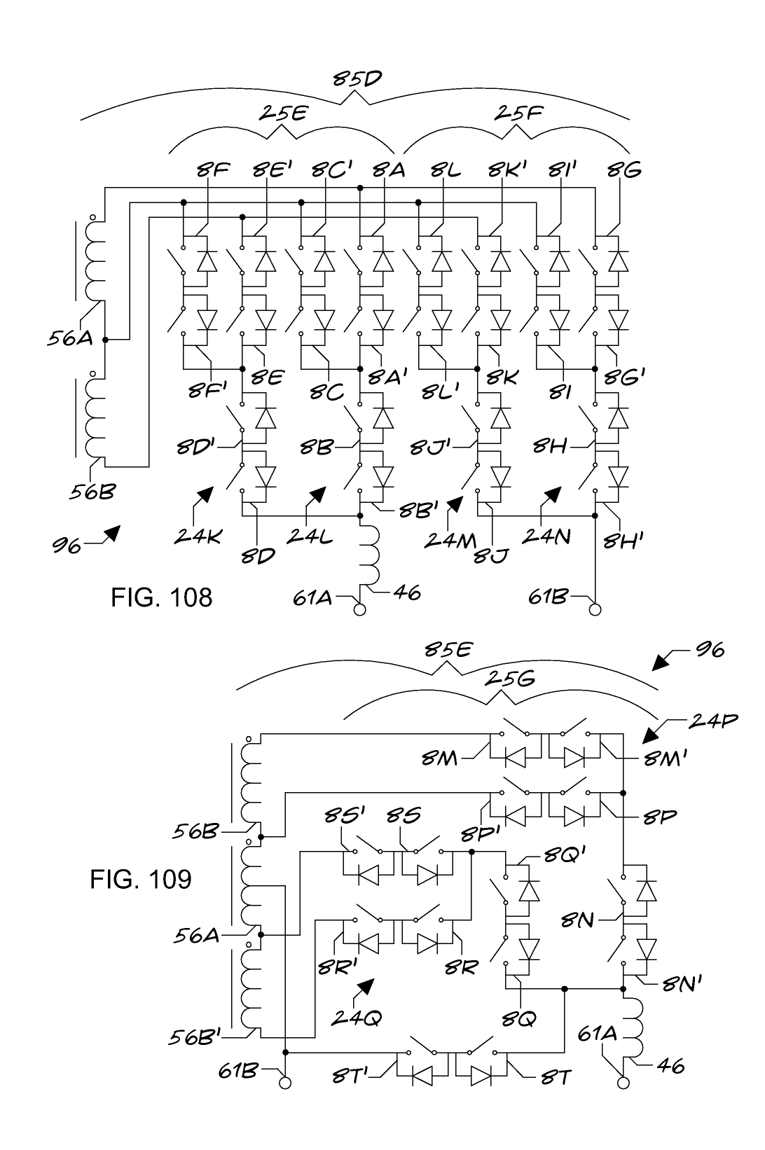

The example cycloconverter circuits 85A, 85B, and 86A can also be changed to a converter utilizing multiple independently controlled secondary windings by changing at least one of the switch matrixes to a switch string matrix. An example of this is illustrated with the switch string cycloconverters 85D and 85E in FIG. 108 and FIG. 109. For the switch string cycloconverter 85D in FIG. 108 the switch string matrix 25E is connected to the inductive element 46, and switch string matrix 25F is connected to the inductive element's return connection 61B. The switch strings 24K and 24L are connected between the inductive element 46 and the non-common ends of the secondary windings 56A and 56B (similar connections made for switch strings 24M and 24N). The switches 8C-8C′ and 8F-8F′ in both switch strings 24K and 24L are connected to the interconnection of the secondary windings 56A and 56B (similar connections made for switch strings 24M and 24N). For the switch string cycloconverter 85E in FIG. 109 the switch string matrix 25G is connected to the inductive element 46. The switch strings 24P and 24Q are connected between the inductive element 46 and the non-common ends of the secondary windings 56B and 56B′. The bi-directional switches 8P-8P′ and 8S-8S′ in both switch strings 24P and 24Q are connected to the interconnections of the secondary windings 56A and 56B and secondary windings 56A and 56B′ respectively. A bi-directional switch 8P-8P′ is also connected between the inductive element 46 and the center-tap 57 of the secondary windings 56A, 56B, and 56B′. The same two options as for primary circuits 90 can be utilized for increasing the number of levels of the switch string matrixes, but additional secondary windings are added instead of capacitive elements. The commutation methods for the multilevel switch string matrixes 25E, 25F, and 25G are similar to a mix of those for the switch matrixes in FIG. 104 or FIG. 105 and the secondary circuit 96 in FIG. 38.

For the cycloconverter circuits a neutral connection 67 can also be connected to the center-tap of the secondary winding(s). Alternatively, an additional switch matrix or switch string matrix can also be included in the secondary circuit 96 that is connected to the neutral connection 67. A cycloconverter can also be utilized as inductive storage circuit by using a storage inductor as the inductive element 46. As an inductive storage circuit some of the bi-directional switches can be changed to bi-directional blocking elements.

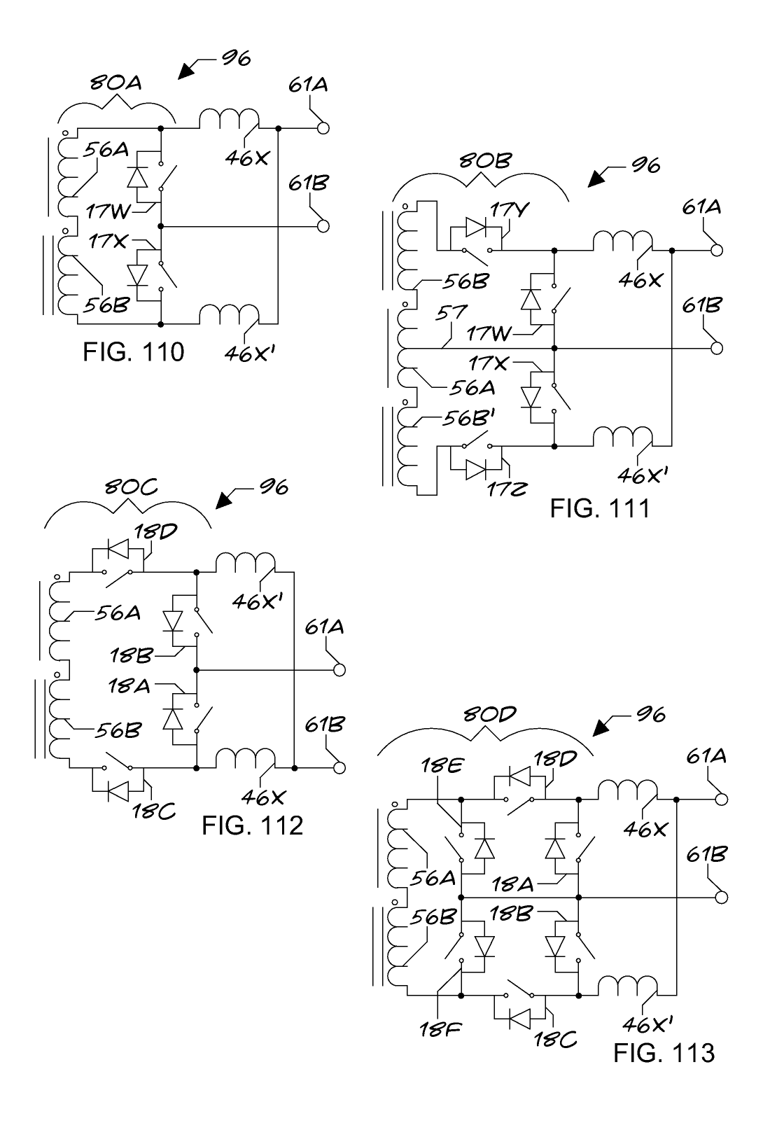

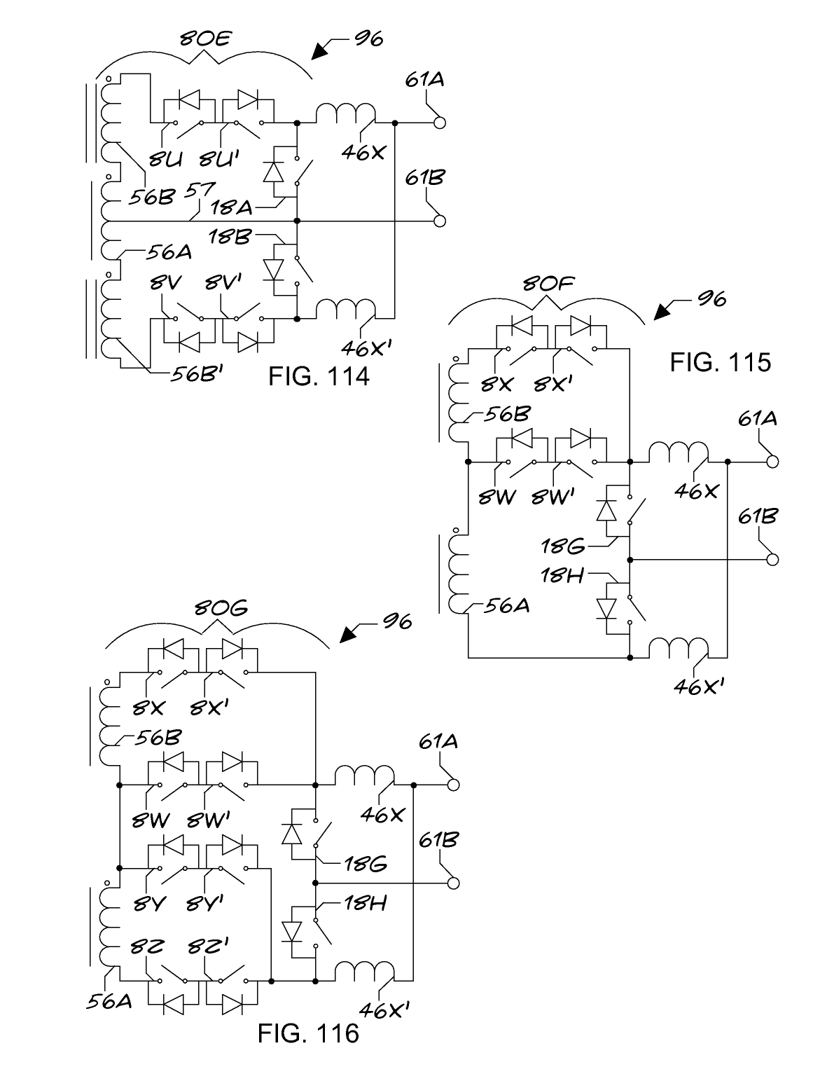

The secondary circuits 96 in FIG. 110 through FIG. 118 are current doubler circuits (80 followed by a suffix). For current doubler circuits (80 followed by a suffix) a split inductive element 46X and 46X′ is utilized. The current doubler circuits 80A, 80B, 80C, 80D, and 80E in FIG. 110 through FIG. 114 include switches 17W and 17X or switches 18A and 18B connected across the split inductive element 46X and 46X. The secondary windings 56A and 56B in the current doubler circuit 80A in FIG. 110 are directly connected across the split inductive element 46X and 46X′. The current doubler circuit 80B in FIG. 111 includes switches 17Y and 17Z connected between and to opposite ends of both the secondary windings 56A, 56B, and 56B′ and the split inductive element 46X and 46X′. The current doubler circuits 80C and 80D in FIG. 112 and FIG. 113 include switches 18C and 18D connected between and to opposite ends of both the secondary windings 56A and 56B and the split inductive element 46X and 46X′. The current doubler circuit 80D in FIG. 113 also includes two switches 18E and 18F connected across the secondary windings 56A and 56B. The current doubler circuit 80E in FIG. 54 includes two bi-directional switches 8U-8U′ and 8V-8V′ connected between and to opposite ends of both the secondary windings 56A, 56B, and 56B′ and the split inductive element 46X and 46X′. In FIG. 111 and FIG. 114 the center-tap 57 of the secondary windings 56A, 56B, and 56B′ is connected to switches 17W and 17X or switches 18A and 18B. The current doubler circuits 80A, 80B, 80C, 80D, and 80E in FIG. 110 through FIG. 114 are appropriate secondary circuits 96 for the example converters 11 in FIG. 2 and FIG. 3. The current doubler circuits 80F, 80G, 80H, and 80I in FIG. 115 through FIG. 118 illustrate how these secondary circuits 96 can be modified for the example converter 11 in FIG. 1 by adding one or a pair of extra secondary windings and bi-directional switches to the current doubler circuits 80C, 80C, 80E, and 80B respectively. For the circuits 80F and 80G the switches 18C and 18D in circuit 80C are combined to form the bi-directional switch 8W-8W′. For the current doubler circuits (80 followed by a suffix) the number of levels can be increased by adding even more secondary windings and bi-directional switches. The current doubler circuits (80 followed by a suffix) in FIG. 110 through FIG. 118 can be rearranged so that the connections and switch orientations are different, but the circuits will still function the same. There are other possible current doubler circuits with similar operation that will be obvious to those skilled in the art, but FIG. 110 through FIG. 118 give a good sampling of the more practical implementations.

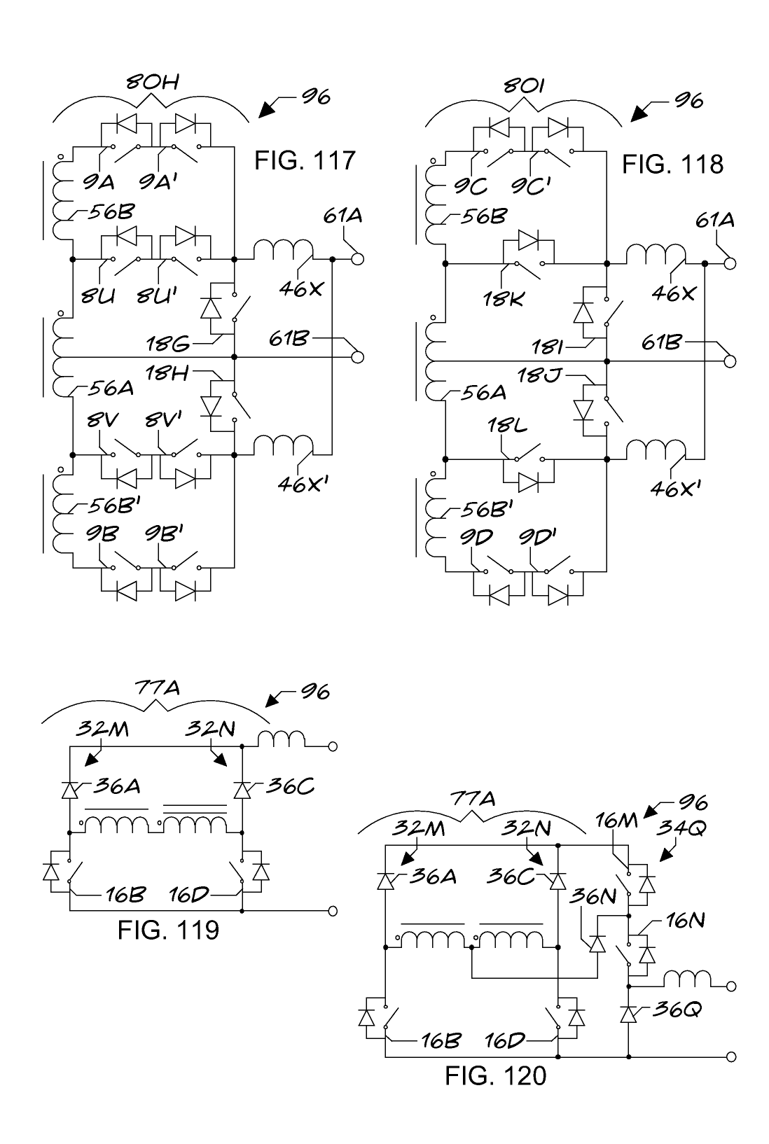

In FIG. 110 and FIG. 111 switches 17W, 17X, 17Y, and 17Z can operate the same as switches 16B, 16A, 16A, and 16B respectively in FIG. 13. The switches and bi-directional switches in FIG. 112, FIG. 113, and FIG. 114 can operate with the following logical expressions using the previously defined logic signals and the commutation for the switches and bi-directional switches in FIG. 20 and FIG. 82:
18A=16S; 18B=16R; 18C=16A|16G; 18D=16B|16G;
18E=˜p; 18F=p; 8U=6I′; 8U′=6I; 8V=6H′; 8V′=6H.
   The switches and bi-directional switches in FIG. 115 and FIG. 117 can operate with the following logical expressions using the commutation for the switches and bi-directional switches in FIG. 6:
8W=6C & ˜6C′|6A′; 8W′=6D & ˜6D′|6B′; 8X=6C|6D′;
8X′=6D|6C′; 18G=16E|6B; 18H=16F|6A;
8U=6A′; 8U′=6D & ˜6D′; 8V=6B′; 8V′=6C & ˜6C′;
9A=6D′; 9A′=6D; 9B=6C′; 9B′=6C.
   The circuit 80G in FIG. 116 is a symmetric version of the circuit 80F in FIG. 115. The bi-directional switches 8W-8W′ and 8X-8X′ in FIG. 116 therefore operate the same as in circuit 80F while the switches 8Y and 8Y′ in FIG. 116 are continuously off, and the switches 8Z and 8Z′ in FIG. 116 are continuously on. However, if the functions of secondary windings 56A and 56B are swapped, the functions of the bi-directional switches 8W-8W′ and 8X-8X′ and bi-directional switches 8Y-8Y′ and 8Z-8Z′ are also swapped. The switches and bi-directional switches in FIG. 118 can operate with the following logical expressions using the previously defined logic signal d and the commutation for the switches and bi-directional switches in FIG. 27:
9C=6F′; 9C′=6F; 9D=6E′; 9D′=6E;
18K=d & 16I & 6E′|16L; 18L=d & 16J & 6F′|16K; 18I=16J; 18J=16I.

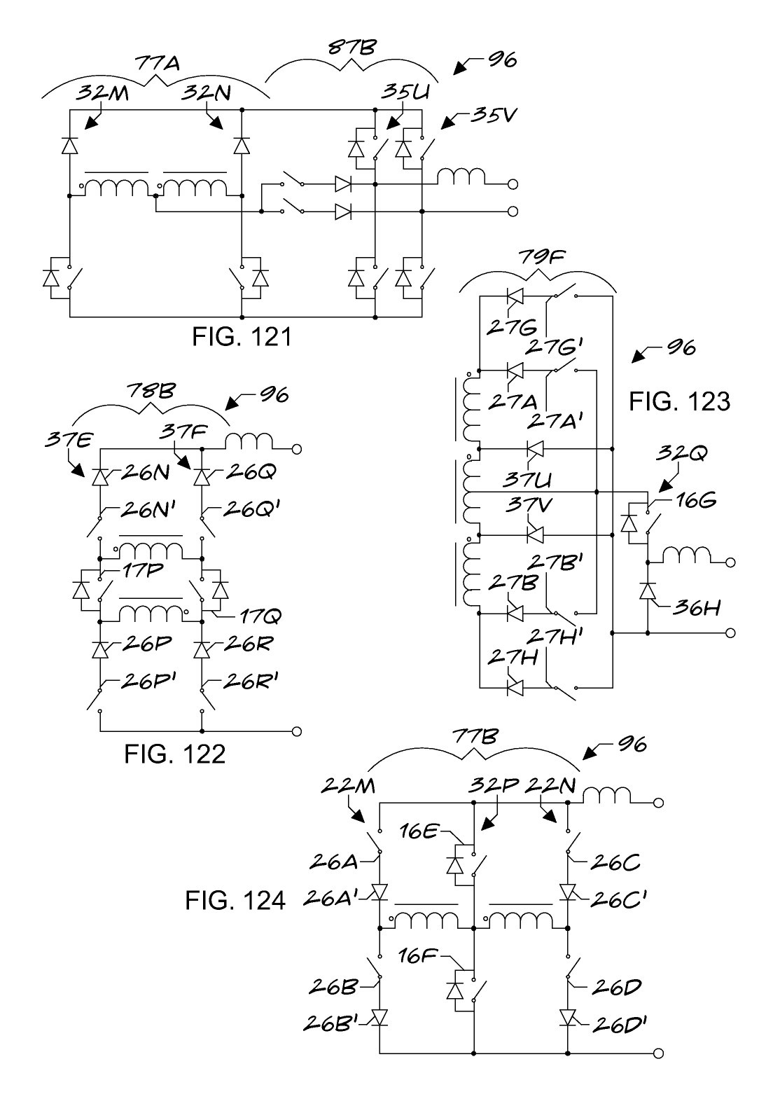

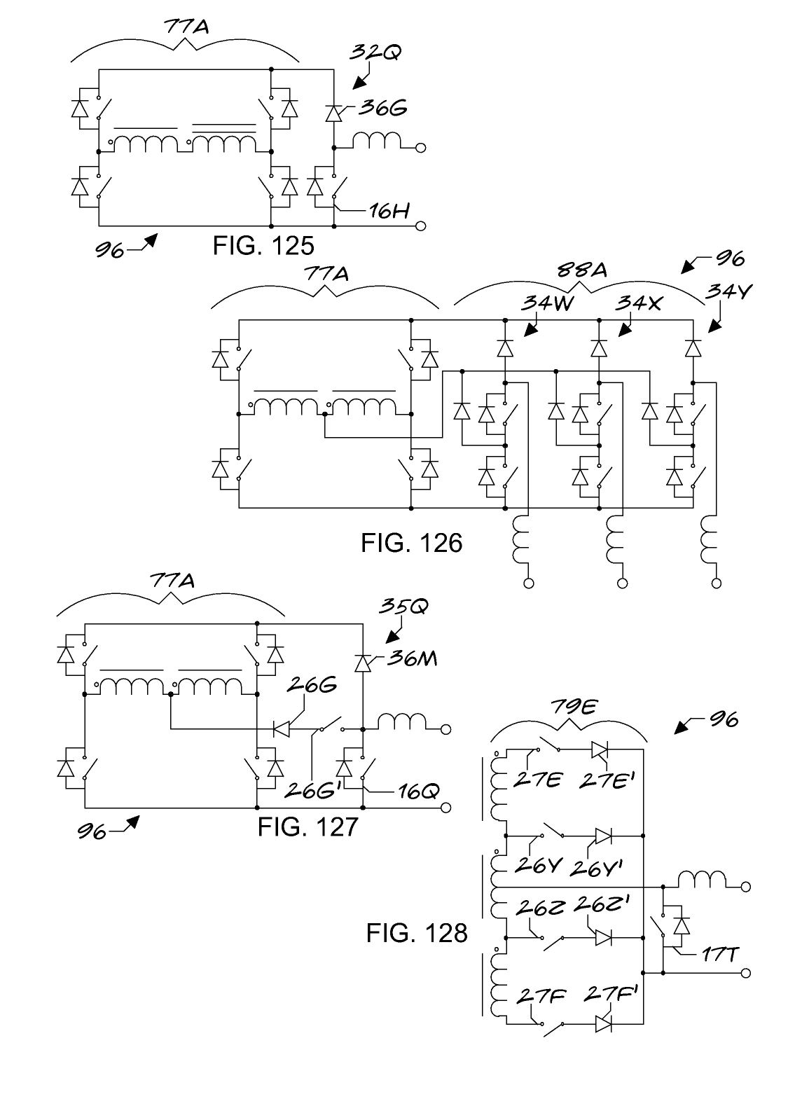

If power only transfers to the secondary circuit 96 or from the secondary circuit 96, any of the secondary circuit 96 embodiments described herein can be modified by replacing some of the switches (16, 17, and 18 each followed by a suffix) and bi-directional switches (6, 7, 8, and 9 each followed by a suffix) with diodes and bi-directional blocking elements respectively. As long as the secondary circuit 96 is still able to short-circuit the secondary windings (56 or 56 followed by a suffix), the example commutation methods are still valid. FIG. 119 through FIG. 123 are example modifications if power only transfers to the secondary circuit. FIG. 124 through FIG. 128 are example modifications if power only transfers from the secondary circuit. FIG. 119 through FIG. 128 are not the only possible embodiments for unidirectional power transfer, but are provided to illustrate some of the possibilities and any such changes should be considered applicable to the present invention.

### Example Embodiments of Multiple Ports

A multiple port converter is possible with multiple primary circuits 90 as illustrated with the example in FIG. 50, but in many applications it is preferable to create the multiple ports on the secondary side of the converter 11. Any secondary circuit 96 embodiments that control the duration current is applied to at least one secondary winding can be combined to form a multiple port converter. In some applications one secondary circuit 96 embodiment that does not control the duration current is applied to at least one secondary winding can also be included in the multiple port converter. The multiple port converter is possible (for the secondary side) by connecting multiple secondary circuits 96 to the same secondary windings, integrating multiple secondary circuits 96, utilizing a high-frequency link(s) with multiple secondary windings that are connected to multiple secondary circuits 96, or a combination of any of these. For these multiple port converters the commutation methods follow the principles already set forth herein.

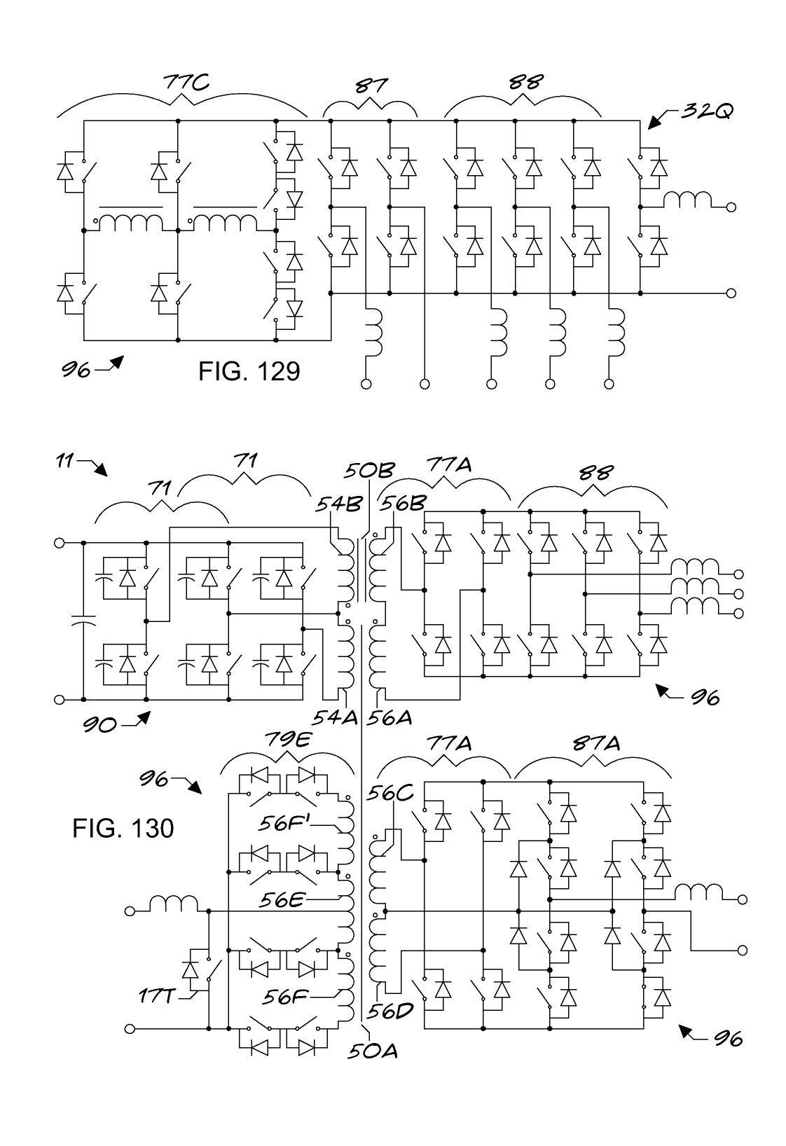

Many of the secondary circuits 96 can be integrated to share circuits and form multiple port converters. For instance the secondary circuits in FIG. 20, FIG. 32, FIG. 37, FIG. 38, FIG. 39, and FIG. 43 all have the full-bridge circuit 77A. FIG. 129 illustrates an example secondary circuit 96 where the mixed leg circuit 77C is shared and integrated with the phase leg 32Q, the one phase ac circuit 87, and the three phase ac circuit 88. Obviously numerous other secondary circuit integrations are also possible.

FIG. 130 illustrates an example converter 11 with multiple ports using multiple secondary windings 56A, 56C, 56D, 56E, 56F, and 56F′ of high-frequency link 50A, the two full-bridge circuits 71 in FIG. 12, and the secondary circuits 96 from FIG. 38, FIG. 39, and FIG. 98. Utilizing a high-frequency link(s) with multiple secondary windings that are connected to multiple secondary circuits 96 is desirable in some applications, since the secondary winding for each secondary circuit 96 can utilize a different turns ratio, and each secondary circuit 96 is isolated from the others. Obviously numerous other converter 11 combinations are also possible. The commutation methods for multiple secondary windings are only different in that it may be advantageous in many applications to utilize an interdependence between each secondary circuit's short-circuit time depending on the load conditions of all the secondary circuits 96.

Those having ordinary skill in the art will also appreciate that the present invention can also be utilized as a building block of a larger converter. One example is utilizing the present invention as a conversion stage in a converter that employs multiple conversion stages. A second example is to use multiple converters of the type in the present invention to generate the multiple isolated dc sources with capacitance (the capacitive element of each dc source is connected directly or indirectly to the primary circuit or secondary circuit of the present invention) for a conventional cascade multilevel converter, such as is extensively described in the literature (see for example U.S. Pat. No. 5,642,275).

Those having ordinary skill in the art will also appreciate that various controllers, drivers, dc blocking capacitors, sensors, and detectors will also be used with the invention. Estimated sensing or estimated detecting may also be used with the present invention. Those having ordinary skill in the art will also appreciate that the controlling, sensing, and or detecting can be implemented in hardware, software, firmware, a combination of any of these, or other similar methods.

Although specific embodiments have been illustrated and described herein, it will be appreciated by those of ordinary skill in the art that any arrangement that achieve the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

What is claimed is:

1. A power converter comprising:
at least one high-frequency link comprising a primary winding and at least one secondary winding;
at least one primary circuit connected to one or more of the primary windings of said at least one high-frequency links, the at least one primary circuit operable to apply a voltage of at least one capacitive element as bi-polar voltage pulses to said one or more primary windings; and
at least one secondary circuit connected to one or more of the secondary windings of said at least one high-frequency links, the at least one secondary circuit operable to apply a voltage across said one or more secondary windings to at least one inductive element;
the at least one secondary circuit further operable to short-circuit at least one of said one or more secondary windings under at least one load condition to increase the current in said at least one of said one or more secondary windings with respect to the positive voltage of said at least one of said one or more secondary windings prior to the voltage applied to one or more of the primary windings of said at least one high-frequency links changing polarity;
the power converter operable to apply at least two non-zero and non-concentric around zero voltage levels to said at least one inductive elements, said at least two non-zero and non-concentric around zero voltage levels are with respect to at least one return connection of said at least one inductive elements.

2. The power converter of claim 1, wherein one or more of the at least one primary circuits comprises at least one of a full-bridge circuit, a bi-directional full-bridge circuit, a multilevel full-bridge circuit, a switch string full-bridge circuit, an alternative multilevel full-bridge circuit, a bi-directional multilevel full-bridge circuit, a half-bridge circuit, a bi-directional half-bridge circuit, a push-pull circuit, and a bi-directional push-pull circuit.

3. The power converter of claim 1, wherein one or more of the at least one secondary circuits comprises at least one of a full-bridge circuit, a full-bridge circuit connected to at least one phase leg, a full-bridge circuit connected to at least one multilevel phase leg, a full-bridge circuit connected to at least one alternative multilevel phase leg, a mixed leg circuit, a mixed leg circuit connected to at least one phase leg, a series stack circuit, a series stack circuit connected to at least one phase leg, a center-tap circuit, a center-tap circuit connected to at least one phase leg, a cycloconverter, a switch string cycloconverter, and a current doubler circuit.

4. The power converter of claim 1, wherein one or more of the at least one secondary circuits comprises a clamp circuit operable to clamp one or more of said at least one inductive elements.

5. The power converter of claim 1, wherein one or more of the at least one secondary circuits comprises an inductive storage circuit.

6. The power converter of claim 1, wherein one or more of the at least one primary circuits comprises at least one snubber capacitance operable to control electrical transients in the primary winding.

7. The power converter of claim 1, wherein one or more of said at least one capacitive elements comprises a part of an electrical filter circuit connected to the at least one primary circuit.

8. The power converter of claim 1, wherein one or more of said at least one inductive elements comprises a part of an electrical filter circuit connected to the at least one secondary circuit.

9. A method of operating a power converter, comprising:
applying a voltage across at least one capacitive element as bi-polar voltage pulses to a primary winding of at least one high-frequency link via a primary circuit;
wherein each of at least one high-frequency links further comprises at least one secondary winding;
applying a voltage across one or more secondary windings of said at least one high-frequency links to at least one inductive element via a secondary circuit;
short-circuiting at least one of said one or more secondary windings via said secondary circuit under at least one load condition to increase the current in said at least one of said one or more secondary windings with respect to the positive voltage of said at least one of said one or more secondary windings prior to the voltage applied to one or more of the primary windings of said at least one high-frequency links changing polarity; and
applying at least two non-zero and non-concentric around zero voltage levels to said at least one inductive elements, said at least two non-zero and non-concentric around zero voltage levels are with respect to at least one return connection of said at least one inductive elements.

10. The method of operating a power converter of claim 9, wherein said primary circuit comprises at least one of a full-bridge circuit, a bi-directional full-bridge circuit, a multilevel full-bridge circuit, a switch string full-bridge circuit, an alternative multilevel full-bridge circuit, a bi-directional multilevel full-bridge circuit, a half-bridge circuit, a bi-directional half-bridge circuit, a push-pull circuit, and a bi-directional push-pull circuit.

11. The method of operating a power converter of claim 9, wherein said secondary circuit comprises at least one of a full-bridge circuit, a full-bridge circuit connected to at least one phase leg, a full-bridge circuit connected to at least one multilevel phase leg, a full-bridge circuit connected to at least one alternative multilevel phase leg, a mixed leg circuit, a mixed leg circuit connected to at least one phase leg, a series stack circuit, a series stack circuit connected to at least one phase leg, a center-tap circuit, a center-tap circuit connected to at least one phase leg, a cycloconverter, a switch string cycloconverter, and a current doubler circuit.

12. The method of operating a power converter of claim 9, wherein said secondary circuit comprises a clamp circuit operable to clamp one or more of said at least one inductive elements.

13. The method of operating a power converter of claim 9, wherein said secondary circuit comprises an inductive storage circuit.

14. The method of operating a power converter of claim 9, wherein said primary circuit comprises at least one snubber capacitance operable to control electrical transients in the primary winding of one or more of said at least one high-frequency links.

15. The method of operating a power converter of claim 9, wherein one or more of said at least one capacitive elements comprises a part of an electrical filter circuit connected to said primary circuit.

16. The method of operating a power converter of claim 9, wherein one or more of said at least one inductive elements comprises a part of an electrical filter circuit connected to said secondary circuit.

17. A power converter comprising:
at least one high-frequency link comprising a primary winding and at least one secondary winding;
at least one primary circuit connected to one or more of the primary windings of said at least one high-frequency links, the at least one primary circuit operable to apply a voltage of at least one capacitive element as bi-polar voltage pulses to said one or more primary windings;
one or more of the at least one primary circuits further operable with both positive and negative voltage across one or more of said at least one capacitive elements; and
at least one secondary circuit connected to one or more of the secondary windings of said at least one high-frequency links, the at least one secondary circuit operable to apply a voltage across said one or more secondary windings to at least one inductive element;
the power converter operable to apply at least two non-zero and non-concentric around zero voltage levels to said at least one inductive elements, said at least two non-zero and non-concentric around zero voltage levels are with respect to at least one return connection of said at least one inductive elements.

18. The power converter of claim 17, wherein one or more of the at least one primary circuits comprises at least one of a bi-directional full-bridge circuit, a switch string full-bridge circuit, a bi-directional multilevel full-bridge circuit, a bi-directional half-bridge circuit, and a bi-directional push-pull circuit.

19. The power converter of claim 17, wherein one or more of the at least one secondary circuits comprises at least one of a full-bridge circuit, a full-bridge circuit connected to at least one phase leg, a full-bridge circuit connected to at least one multilevel phase leg, a full-bridge circuit connected to at least one alternative multilevel phase leg, a mixed leg circuit, a mixed leg circuit connected to at least one phase leg, a series stack circuit, a series stack circuit connected to at least one phase leg, a center-tap circuit, a center-tap circuit connected to at least one phase leg, a cycloconverter, a switch string cycloconverters, and a current doubler circuit.

20. A power converter comprising:
at least one high-frequency link comprising a primary winding and at least one secondary winding;
at least one primary circuit connected to one or more of the primary windings of said at least one high-frequency links, the at least one primary circuit operable to apply a voltage of at least one capacitive element as bi-polar voltage pulses to said one or more primary windings; and
at least two secondary circuits, each of the at least two secondary circuits connected to one or more of the secondary windings of said at least one high-frequency links;
the at least two secondary circuits operable to apply a voltage across said one or more secondary windings to at least one inductive element;
two or more of the at least two secondary circuits are each connected to at least two different secondary windings of said at least one high-frequency links and operable to apply the voltage across said at least two different secondary windings to at least one inductive element.

21. The power converter of claim 21, wherein each of the at least one high-frequency links that is connected to the same secondary circuit of said at least two secondary circuits is connected to the same primary circuit of said at least one primary circuits.

22. A power converter comprising:
at least one high-frequency link comprising a primary winding and at least one secondary winding;
at least one primary circuit connected to one or more of the primary windings of said at least one high-frequency links, the at least one primary circuit operable to apply a voltage of at least one capacitive element as bi-polar voltage pulses to said one or more primary windings; and
at least one secondary circuit connected to two or more of the secondary windings of said at least one high-frequency links, the at least one secondary circuit operable to apply a voltage across said two or more secondary windings to at least one inductive element;
the at least one secondary circuit is capable of short-circuiting each of said two or more secondary windings;
the power converter operable to apply a voltage across at least two of said two or more of said secondary windings to said at least one inductive elements, and also a different non-zero voltage of at least one of said two or more of said secondary windings to said at least one inductive elements, said different non-zero voltage is with respect to at least one return connection of said at least one inductive elements.

23. The power converter of claim 22, wherein the at least one secondary circuit has at least two circuit nodes between which only voltages of a single polarity appear and also between which a conduction path exists that is capable of clamping one or more of said at least one inductive elements.

24. The power converter of claim 22, wherein one or more of the at least one primary circuits comprises at least one of a full-bridge circuit, a bi-directional full-bridge circuit, a multilevel full-bridge circuit, a switch string full-bridge circuit, an alternative multilevel full-bridge circuit, a bi-directional multilevel full-bridge circuit, a half-bridge circuit, a bi-directional half-bridge circuit, a push-pull circuit, and a bi-directional push-pull circuit.

25. The power converter of claim 22, wherein one or more of the at least one secondary circuits comprises at least one of a full-bridge circuit, a full-bridge circuit connected to at least one phase leg, a full-bridge circuit connected to at least one multilevel phase leg, a full-bridge circuit connected to at least one alternative multilevel phase leg, a mixed leg circuit, a mixed leg circuit connected to at least one phase leg, a series stack circuit, a series stack circuit connected to at least one phase leg, a center-tap circuit, a center-tap circuit connected to at least one phase leg, a cycloconverter, a switch string cycloconverter, and a current doubler circuit.
